(19) United States
(12) Patent Application Publication
(10) Pub. No.: US 2023/0345579 A1
(43) Pub. Date: Oct. 26, 2023

(54) SCG Suspension/Dormancy/Deactivation - Signaling, Configurations and Behavior

(71) Applicant: Telefonaktiebolaget LM Ericsson (publ), Stockholm (SE)

(72) Inventors: Oumer Teyeb, Montréal (CA); Icaro Leonardo Da Silva, Solna (SE); Lian Araujo, Stockholm (SE)

(21) Appl. No.: 18/017,738

(22) PCT Filed: Jul. 20, 2021
(86) PCT No.: PCT/SE2021/050741

§ 371 Date: Jan. 24, 2023

Related U.S. Application Data
(60) Provisional application No. 63/056,134, filed on Jul. 24, 2020.

(51) Int. Cl. H04W 76/34; H04W 76/19

(52) U.S. Cl. CPC H04W 76/34; H04W 76/19

(57) ABSTRACT

Embodiments described herein include a method, in a user equipment, UE, operating in dual connectivity, DC, with a master node, MN, and a secondary node, SN, for suspending a secondary cell group, SCG. The method comprises receiving, from a first radio network node, RNN, a command to suspend the SCG, and, in response to receiving the command, suspending the SCG. This first RNN may be the MN or the SN, in various embodiments. In some embodiments the method may further comprise receiving a command to resume operation with the SCG and, in response to the command to resume operation, resuming operation with the SCG.

### TECHNICAL FIELD

The present invention generally relates to wireless communication networks and particularly relates to techniques for suspending and resuming a secondary cell group (SCG) in dual connectivity (DC) scenarios.

### BACKGROUND

Wireless systems developed by members of the 3^{rd}-Generation Partnership Project (3GPP) include the fourth-generation wireless network widely known as LTE, which refers to the fourth-generation radio access technology formally called Evolved Universal Terrestrial Radio Access (E-UTRA), and the fifth-generation wireless network technology often referred to as “NR,” or “New Radio.” Corresponding to these radio access technologies are standards for core networks, the Evolved Packet Core (EPC), for fourth-generation networks, and the 5G Core (5GC), for fifth-generation networks. Notably, however, as discussed in further detail below, a NR radio access network (RAN) may be connected to an EPC, rather than a 5GC, in some deployments. This provides for a range of options for interaction and cooperation between various combinations of LTE and NR base stations and core networks.

One area where these options must be considered is the area of dual connectivity (DC) which allows for a user equipment (UE) to be simultaneously connected to two serving cells, or cell groups, where the different cells potentially operate using different radio access technologies and/or in different frequency bands. DC is generally used in NR (5G) and LTE systems to improve UE transmit and receive data rate. With DC, the UE typically operates initially within a serving cell group called a master cell group (MCG). The UE is then configured by the network with an additional cell group called a secondary cell group (SCG). Each cell group (CG) can have one or more serving cells. MCG and SCG can be operated from geographically noncollocated gNBs. MCG and SCG can be operated with corresponding serving cells belonging to different frequency ranges and/or corresponding serving cells in same and different frequency ranges. In an example, an MCG can have serving cells in Frequency Range 1 (FR1), which refers to frequencies below 6 GHz, and SCG can also have serving cells in FR1.

There are different ways to deploy a 5G network, with or without interworking with LTE (also referred to as E-UTRA) and evolved packet core (EPC). These options are depicted in FIG. 1. In principle, NR and LTE can be deployed without any interworking, that is, a gNB (3GPP terminology for an NR base station) in NR can be connected to a 5G core network (5GC) and an eNB (3GPP terminology for an LTE base station) can be connected to an EPC with no interconnection between the two. These are illustrated as Option 1 and Option 2 in FIG. 1, with the latter often being referred to as NR stand-alone (SA) operation. However, to facilitate a rapid deployment of NR technology, the first supported version of NR is so-called EN-DC (E-UTRAN-NR Dual Connectivity), illustrated by Option 3. In such a deployment, dual connectivity between NR and LTE is applied with LTE as the master and NR as the secondary node. The RAN node (gNB) supporting NR, may not have a control plane connection to core network (EPC); instead it relies on the LTE as master node (MeNB). This is also called “Nonstandalone NR.” Notice that in this case, the functionality of an NR cell is limited and would be used for connected mode UEs as a booster and/or diversity leg, but an RRC_IDLE UE cannot camp on these NR cells.

With the introduction and deployment of 5GC, other options may be also valid. As noted above, Option 2 supports stand-alone NR deployment where gNB is connected to 5GC. Similarly, LTE can also be connected to 5GC using option 5 (also known as eLTE, E-UTRA/5GC, or LTE/5GC); such a node can be referred to as an ng-eNB. In these cases, both NR and LTE are seen as part of the next-generation RAN (NG-RAN), and both the ng-eNB and the gNB can be referred to as NG-RAN nodes.

Option 4 and Option 7 as illustrated in FIG. 1 are other variants of dual connectivity between LTE and NR which will be standardized as part of NG-RAN connected to 5GC, denoted by MR-DC (Multi-Radio Dual Connectivity). Under the MR-DC umbrella are:
EN-DC (Option 3): LTE is the master node and NR is the secondary (EPC CN employed)
NE-DC (Option 4): NR is the master node and LTE is the secondary (5GCN employed)
NGEN-DC (Option 7): LTE is the master node and NR is the secondary (5GCN employed)
NR-DC (variant of Option 2): Dual connectivity where both the master and secondary are NR (5GCN employed). Even though NR-DC nomenclature is used, there are specific NR-DC cases that may be deployed, e.g.:
   o Rel-15 NR-DC, where the UE supports only FR1-FR2 NR-DC, meaning that MCG contains only bands in FR1, and the SCG only bands in Frequency Range 2 (FR2), i.e., bands between 24.25 GHz and 52.6 GHz.
   o intra FR NR-DC, where the UE supports only NR-DC within FR1-only or FR2-only, meaning that either both MCG and SCG contain only bands in FR1, or both MCG and SCG contain only bands in FR2.

Because different operators will take different migration paths for updating their wireless networks, it is possible to have deployments with multiple options in parallel in the same network. For example, there could be eNB base stations supporting Options 3, 5 and 7 in the same network as NR base stations supporting Options 2 and 4. In combination with dual connectivity solutions between LTE and NR, it is also possible to support CA (Carrier Aggregation) in each cell group (i.e., MCG and SCG) and dual connectivity between nodes on the same RAT (e.g., NR-NR DC). For the LTE cells, a consequence of these different deployments is the co-existence of LTE cells associated to eNBs connected to EPC, 5GC, or to both EPC/5GC.

From a UE point of view, there are three Data Radio Bearer (DRB) types in MR-DC: MCG, SCG and split DRB, characterized by which cell group that is used for transmission. These three DRB types are illustrated in FIG. 2. An MCG DRB uses only the MCG, an SCG DRB uses only the SCG, whereas a split DRB can use both MCG and SCG for data transmission. For RLC/MAC, the protocol version (E-UTRA or NR) is selected based on the RAT used by the cell group. NR PDCP is used for all DRB types, except in EN-DC it is also possible for network to configure E-UTRA PDCP for MCG DRB.

From a network point of view, each DRB may be terminated either by the MN or the SN. This applies to all three bearer types, so that from a network point of view, six different bearer configurations are possible, as shown in FIG. 3 and FIG. 4. For bearer types requiring data transmission over X2/Xn interface, a flow control protocol is used between MN and SN to avoid excessive buffering of data on RLC bearer level, which may lead to excessive reordering at the receiving PDCP entity. The RLC bearer contains the RLC/MAC configuration for each logical channel towards the UE.

For DL transmission on split DRBs, the network decides per PDCP PDU whether to transmit via MCG or SCG. For UL transmission on split DRBs, the UE is configured with a buffer threshold. When data in buffer for the corresponding DRB is below the threshold, Buffer Status Reports (BSR) are sent only on the preferred path. The preferred path can be either MCG or SCG, and is configured by the network per DRB. When data in the buffer is above the buffer threshold, the UE reports the total BSR to both MCG and SCG. It is then up to the network scheduler using scheduling grants in MCG and SCG to control the uplink data flow.

A UE in MR-DC has a single control plane connection to the core network and a single RRC state, controlled by the MN. Each of the MN and SN has its own RRC entity for creating RRC messages or Information Elements (IE) for configuring the UE, as seen in FIG. 5, which shows the control plane architectures for EN-DC and for MR-DC with 5GC. Since the SN is responsible for its own resources, it provides the UE with the Secondary Cell Group (SCG) configuration in an RRC message and also the radio bearer configuration in an IE, for all bearers that are terminated in the SN. The MN in turn creates the Master Cell Group (MCG) configuration and the radio bearer configuration for all bearers terminated in the MN. The cell group configuration includes the configuration of L1 (physical layer), MAC and RLC. The radio bearer configuration includes the configuration of PDCP (and SDAP in case of 5GC).

The MN always sends the initial SN RRC configuration via an MCG signaling radio bearer (SRB), referred to as SRB1, but subsequent RRC configurations created by the SN can be sent to the UE either via the MN using SRB1 or directly to the UE using SRB3 (if configured). FIG. 6 illustrates the different SRB types. For the SRB1 case, the MN receives from the SN an RRC message containing the SCG configuration and an IE containing the radio bearer configuration. The MN encapsulates these into the RRC message it creates itself, that may also include changes to the MCG configuration and radio bearer configuration of bearers terminated in the MN. Thereby, the MCG and SCG configurations may be sent to the UE in the same RRC message.

Split SRB1 is used to create diversity. From RRC point of view, it operates like a normal SRB1. However, on the PDCP level, the sender can decide to either choose one of the links for scheduling the RRC messages, or it can duplicate the message over both links. In the downlink, the path switching between the MCG or SCG legs or duplication on both is left to network implementation. On the other hand, for the UL, the network configures the UE to use the MCG, SCG or both legs. The terms “leg,” “path,” and “RLC bearer” are used interchangeably throughout this document.

For the SRB3 case, the SN creates the RRC message including the SCG configuration and radio bearer configuration for radio bearers terminated in the SN. SN may only use SRB3 for reconfigurations not requiring coordination with MN.

In LTE DC, split DRB operation in the UL is controlled by two parameters: ul-DataSplitDRB-ViaSCG and ul-DataSplitThreshold, which are configured for each DRB. The ul-DataSplitDRB-ViaSCG is a Boolean parameter, and if it set to TRUE, the SCG path is the preferred path for UL data transmission, while a value of FALSE indicates to the UE that it should send the data via the MCG path. The ul-DataSplitThreshold is a buffer size threshold and if the size of the data that is available to be sent at the UE’s UL buffer exceeds this value, the UE is allowed to push data to either the MCG or the SCG legs, whichever leg provides a grant to it.

The handling of the path selection at the UE is captured in the PDCP specifications (3GPP TS 36.323) as follows:

For split bearers, when indicating the data available for transmission to a MAC entity for BSR triggering and Buffer Size calculation, the UE shall:
if ul-DataSplitThreshold is configured and the data available for transmission is larger than or equal to ul-DataSplitThreshold:
   indicate the data available for transmission to both the MAC entity configured for SCG and the MAC entity configured for MCG;
else:
   if ul-DataSplitDRB-ViaSCG is set to TRUE by upper layer:
      indicate the data available for transmission to the MAC entity configured for SCG only;
      if ul-DataSplitThreshold is configured, indicate the data available for transmission as 0 to the MAC entity configured for MCG;
else:
   indicate the data available for transmission to the MAC entity configured for MCG only;
      if ul-DataSplitThreshold is configured, indicate the data available for transmission as 0 to the MAC entity configured for SCG.

Following are descriptions of various procedures relevant to the present disclosure, taken from Release 16 of the 3GPP specifications, more specifically from 3GPP TS 37.340.

An SN Addition procedure is initiated by the MN and is used to establish a UE context at the SN in order to provide radio resources from the SN to the UE. For bearers requiring SCG radio resources, this procedure is used to add at least the initial SCG serving cell of the SCG. This procedure can also be used to configure an SN terminated MCG bearer (where no SCG configuration is needed). FIG. 7 illustrates an exemplary SN Addition procedure for MR-DC cases utilizing a 5GC. As shown in FIG. 7, the procedure involves a UE, a MN, an SN, a user plane function (UPF), and an access and mobility management function (AMF). The UPF and AMF are functions in the 5GC.

The SN Addition procedure shown in FIG. 7 is initiated by the MN and is used to establish a UE context at the SN to facilitate the SN providing radio resources to the UE. For bearers requiring SCG radio resources, this procedure can be used to add at least the initial SCG serving cell of the SCG. This procedure can also be used to configure an SN-terminated MCG bearer (where no SCG configuration is needed). The operations shown in FIG. 7 are labelled numerically, but this numbering is used only to facilitate clarity in the following description, and the order of the various operations can be rearranged in certain embodiments. Dashed lines indicate optional operations that may depend on one or more conditions.

In operation 1, the MN decides to request the target SN to allocate radio resources for one or more specific PDU Sessions/QoS Flows, indicating QoS Flows characteristics (QoS Flow Level QoS parameters, PDU session level transport network layer (TNL) address information, and PDU session level Network Slice info). For example, the TNL address information can include a GPRS Tunneling Protocol (GTP) Tunnel Endpoint Identifier (TEID) and a TNL Internet Protocol (IP) address, such as defined in 3GPP TS 38.423. This TNL address information generally identifies a “tunnel.” Accordingly, in the following description, the terms “tunnel information,” “tunnel identifier(s),” and “TNL address information” are used interchangeably.

In addition, for bearers requiring SCG radio resources, MN indicates the requested SCG configuration information, including the entire UE capabilities and the UE capability coordination result. In this case, the MN also provides the latest measurement results for the SN to use when choosing and configuring the SCG cell(s). The MN can also request the SN to allocate radio resources for split SRB operation. The MN can also provide the needed security information to the SN (e.g., even if no SN-terminated bearers are setup) to enable SRB3 to be setup based on SN decision. For bearer options that require Xn-U resources between the MN and the SN, MN can also provide Xn-U TNL address information, e.g., Xn-U DL TNL address information for SN-terminated bearers and Xn-U UL TNL address information for MN terminated bearers. The SN may reject the request.

In operation 2, if the RRM entity in the SN is able to admit the resource request, it allocates respective radio resources and, dependent on the bearer type options, respective transport network resources. For bearers requiring SCG radio resources the SN triggers UE Random Access so that synchronization of the SN radio resource configuration can be performed. The SN decides the PScell and other SCG SCells and provides the new SCG radio resource configuration to the MN in a SN RRC configuration message contained in the SN Addition Request Acknowledge message. In case of bearer options that require Xn-U resources between the MN and the SN, the SN provides Xn-U TNL address information for the respective E-RAB, Xn-U UL TNL address information for SN-terminated bearers, Xn-U DL TNL address information for MN terminated bearers. For SN-terminated bearers, the SN provides the NG-U DL TNL address information for the respective PDU Session and security algorithm. If SCG radio resources have been requested, the SCG radio resource configuration is provided.

In operation 3, the MN sends the MN RRC measurement configuration to the UE including the SN RRC configuration message, preferably without modifying it. In operation 4, the UE applies the new configuration and replies to MN with MN RRC reconfiguration complete message, including a SN RRC response message for SN, if needed. In case the UE is unable to comply with (part of) the configuration included in the MN RRC measurement configuration, it performs the reconfiguration failure procedure. In operation 5, the MN informs the SN that the UE has completed the reconfiguration procedure successfully via SN Reconfiguration Complete message, including the encoded SN RRC response message, if received from the UE.

In operation 6, if configured with bearers requiring SCG radio resources, the UE performs synchronization towards the PSCell configured by the SN. The order the UE sends the MN RRC reconfiguration complete message and performs the Random-Access procedure towards the SCG is not defined. The successful RA procedure towards the SCG is not required for a successful completion of the RRC Connection Reconfiguration procedure. In operation 7, in case of SN-terminated bearers using RLC AM, the MN sends SN Status Transfer to the SN.

In operation 8, in case of SN-terminated bearers using RLC AM, and dependent on the bearer characteristics of the respective QoS Flows, the MN may take actions to minimize service interruption due to activation of MR-DC (Data forwarding). In operations 9-12, for SN-terminated bearers, the update of the UP path towards the 5GC is performed via PDU Session Path Update procedure.

An SN Modification procedure may be initiated either by the MN or by the SN and can be used to modify, establish, or release bearer contexts; transfer bearer contexts to and from the SN; or to modify other properties of the UE context within the same SN. The procedure may also be used to transfer an NR RRC message from the SN to the UE via the MN, and the response from the UE via MN to the SN (e.g., when SRB3 is not used). In NGEN-DC and NR-DC, the RRC message is an NR message (i.e., RRCReconfiguration) whereas in NE-DC it is an E-UTRA message (i.e., RRCConnectionReconfiguration). Other possible include trigger PSCell changes (e.g., when a new security key is required or when the MN needs to perform PDCP data recovery). The MN cannot reject the request for release or PDU session/QoS flows. The SN can also use the procedure to request the MN to provide more DRB IDs to be used for SN terminated bearers that are no longer need. The SN modification procedure does not necessarily need to involve signalling towards the UE.

The MN uses the SN modification procedure to initiate configuration changes of the SCG within the same SN, including addition, modification or release of the user plane resource configuration. The MN uses this procedure to perform handover within the same MN while keeping the SN, when the SN needs to be involved (i.e., in NGEN-DC). The MN also uses the procedure to query the current SCG configuration, e.g., when delta configuration is applied in an MN initiated SN change. The MN also uses the procedure to provide the S-RLF related information to the SN or to provide additional available DRB IDs to be used for SN terminated bearers. The MN may not use the procedure to initiate the addition, modification or release of SCG SCells. The SN may reject the request, except if it concerns the release of the user plane resource configuration, or if it is used to perform handover within the same MN while keeping the SN.

FIG. 8 illustrates an exemplary MN-initiated SN Modification procedure with MN involvement, for MR-DC utilizing a 5GC. The procedure involves a UE, a MN, an SN, a UPF, and AMF. Each of these entities may be the same as the corresponding entity in FIG. 7. The operations shown in FIG. 8 are labelled numerically, but this numbering is used only to facilitate clarity in the following description, and the order of the various operations can be rearranged in certain embodiments. Dashed lines indicate optional operations that may depend on one or more conditions.

In operation 1, the MNB sends the SN Modification Request message, which can contain user plane resource configuration-related context, other UE context related information, PDU session level Network Slice info, and the requested SCG configuration information, including the UE capabilities coordination result to be used as basis for the reconfiguration by the SN. In case a change of security key is required, a new SN Security Key is included.

In operation 2, the SN responds with the SN Modification Request Acknowledge message, which may contain new SCG radio configuration information within an SN RRC reconfiguration message, and data forwarding address information (if applicable). For MN-terminated NR SCG bearers to be setup for which PDCP duplication with CA is configured, the MN allocates 2 separate Xn-U bearers. For SN-terminated NR MCG bearers to be setup for which PDCP duplication with CA is configured the SN allocates 2 separate Xn-U bearers.

In operation 2a, when applicable, the MN provides data forwarding address information to the SN. For SN terminated bearers using MCG resources, the MN provides Xn-U DL TNL address information in the Xn-U Address Indication message.

In operations 3 and 4, the MN initiates the RRC reconfiguration procedure, including an SN RRC reconfiguration message. The UE applies the new configuration, synchronizes to the MN (if instructed, in case of intra-MN handover) and replies with MN RRC reconfiguration complete message, including an SN RRC response message, if needed. In case the UE is unable to comply with (part of) the configuration included in the MN RRC reconfiguration message, it performs the reconfiguration failure procedure.

In operation 5, upon successful completion of the reconfiguration, the success of the procedure is indicated in the SN Reconfiguration Complete message.

In operation 6, if instructed, the UE performs synchronization towards the PSCell of the SN as described in SN addition procedure. Otherwise, the UE may perform UL transmission after having applied the new configuration.

In operation 7, if the PDCP termination point is changed for bearers using RLC AM, and when RRC full configuration is not used, the SN Status Transfer takes place between the MN and the SN. FIG. 8 depicts the case where a bearer context is transferred from the MN to the SN.

In operation 8, if applicable, data forwarding between MN and the SN takes place. FIG. 8 depicts the case where a user plane resource configuration related context is transferred from the MN to the SN.

In operation 9, the SN sends the Secondary RAT Data Usage Report message to the MN and includes the data volumes delivered to and received from the UE. Note that the order in which the SN sends the Secondary RAT Data Usage Report message and performs data forwarding with MN is not defined. The SN may send the report when the transmission of the related QoS flow is stopped.

In operation 10, if applicable, a PDU Session path update procedure is performed.

The SN may use the SN modification procedure to perform configuration changes of the SCG within the same SN, e.g., to trigger the modification/release of the user plane resource configuration and to trigger PSCell changes (e.g., when a new security key is required or when the MN needs to perform PDCP data recovery). The MN cannot reject the release request of PDU session/QoS flows. The SN also uses the procedure to request the MN to provide more DRB IDs to be used for SN terminated bearers or to return DRB IDs used for SN terminated bearers that are not needed any longer.

FIG. 9 illustrates an exemplary SN-initiated SN Modification procedure with MN involvement, for MR-DC utilizing a 5GC. The procedure involves a UE, a MN, an SN, a UPF, and AMF. Each of these entities may be the same as the corresponding entity in the previous figures. The operations shown in FIG. 9 are labelled numerically, but this numbering is used only to facilitate clarity in the following description, and the order of the various operations can be rearranged in certain embodiments. Dashed lines indicate optional operations that may depend on one or more conditions.

In operation 1, the SN sends the SN Modification Request message, which can contain user plane resource configuration-related context, other UE context related information, and the new radio resource configuration of the SCG. The SN can decide whether the change of security key is required. In case of change of security key, an included PDCP Change Indication can indicate that an SN security key update is required. In case the MN needs to perform PDCP data recovery, the PDCP Change Indication can indicate that PDCP data recovery is required.

In operations 2-3 (shown as a single block), an MN-initiated SN Modification procedure may be triggered by SN Modification Required message, e.g., when an SN security key change needs to be applied. For SN terminated NR MCG bearers to be setup for which PDCP duplication with CA is configured, the SN allocates two separate Xn-U bearers.

In operation 4, the MN initiates the RRC connection reconfiguration procedure towards the UE, including sending a SN RRC configuration message. The UE applies the received configuration and replies (operation 5) with MN RRC reconfiguration complete message, which includes a SN RRC response message, if needed. In case the UE is unable to comply with (all or part of) the configuration included in the MN RRC measurement configuration, it performs a reconfiguration failure procedure instead. In operation 6, upon successful completion of the reconfiguration, the MN indicates this success in an SN Modification Confirm message sent to the SN. This message can carry, e.g., a SN RRC reconfiguration complete message.

In operation 7, if instructed, the UE performs synchronization towards the PSCell of the SN as described in SN Addition procedure discussed above. Otherwise, the UE can perform UL transmission after having applied the new configuration. In operation 8, if a PDCP termination point is changed for bearers using RLC acknowledged mod (AM), and if RRC full configuration is not used, the MN sends the SN Status transfer message to the SN. In operation 9, if applicable, data forwarding between MN and the SN takes place, with FIG. 7 illustrating the case where a user plane resource configuration-related context is transferred from the SN to the MN. In operation 10, the SN sends a Secondary RAT Data Usage Report message to the MN and includes the data volumes delivered to and received from the UE.

In operation 11, a PDU Session Path Update procedure is performed between the MN and the 5GC. This operation corresponds to operations 9-12 shown in FIG. 14.

An SN-initiated SN modification procedure without MN involvement is used to modify the configuration within SN in case no coordination with MN is required, including the addition/modification/release of SCG SCell and PSCell change (e.g., when the security key does not need to be changed and the MN does not need to be involved in PDCP recovery). This procedure is not supported for NE-DC.

FIG. 10 shows an example signalling flow for SN initiated SN modification procedure without MN involvement. The SN can decide whether the Random Access procedure is required. In operation 1, the SN sends the SN RRC reconfiguration message to the UE through SRB3. In operation 2, the UE applies the new configuration and replies with the SN RRC reconfiguration complete message. In case the UE is unable to comply with (part of) the configuration included in the SN RRC reconfiguration message, it performs the reconfiguration failure procedure. In operation 3, if instructed, the UE performs synchronization towards the PSCell of the SN as described in the SN Addition procedure. Otherwise, the UE may perform uplink transmission after having applied the new configuration.

FIG. 11 illustrates transfer of an NR RRC message to/from the UE, when SRB3 is not used. This procedure is supported for all of the MR-DC options. The SN initiates the procedure when it needs to transfer an NR RRC message to the UE and SRB3 is not used.

In operation 1, the SN initiates the procedure by sending the SN Modification Required message, to the MN, including the SN RRC reconfiguration message. In operation 2, the MN forwards the SN RRC reconfiguration message to the UE, including it in the RRC reconfiguration message. In operation 3, the UE applies the new configuration and replies with the RRC reconfiguration complete message by including the SN RRC reconfiguration complete message. In operation 4, the MN forwards the SN RRC response message, if received from the UE, to the SN by including it in the SN Modification Confirm message. In operation 5, if instructed, the UE performs synchronization towards the PSCell of the SN as described in the SN Addition procedure. Otherwise, the UE may perform uplink transmission after having applied the new configuration.

An SN Release procedure may be initiated either by the MN or by the SN and is used to initiate the release of the UE context and relevant resources at the SN. The recipient node of this request can reject it, e.g., if an SN change procedure is triggered by the SN.

FIG. 12 shows an example signalling flow for the MN initiated SN Release procedure. In operation 1, the MN initiates the procedure by sending the SN Release Request message. In operation 2, the SN confirms SN Release by sending the SN Release Request Acknowledge message. If appropriate, the SN may reject SN Release, e.g., if the SN change procedure is triggered by the SN. In operation 21, when applicable, the MN provides forwarding address information to the SN. Note that the MN may send the Data Forwarding Address Indication message to provide forwarding address information before step 2.

In operations 3 and 4, if required, the MN indicates in the MN RRC reconfiguration message towards the UE that the UE shall release the entire SCG configuration. In case the UE is unable to comply with (part of) the configuration included in the MN RRC reconfiguration message, it performs the reconfiguration failure procedure. Note that if data forwarding is applied, timely coordination between steps 1 and 2 may minimize gaps in service provision. This is, however regarded to be an implementation matter.

In operation 5, if the PDCP termination point is changed to the MN for bearers using RLC AM, the SN sends the SN Status Transfer. In operation 6, data forwarding from the SN to the MN may start.

In operation 7, the SN sends the Secondary RAT Data Usage Report message to the MN and includes the data volumes delivered to and received from the UE. If data forwarding is applied, the order the SN sends the Secondary RAT Data Usage Report message and starts data forwarding with MN is not defined, i.e., step 7 can take place before step 6. The SN does not need to wait for the end of data forwarding to send the Secondary RAT Data Usage Report message.

In operation 8, if applicable, the PDU Session path update procedure is initiated. In operation 9, upon reception of the UE Context Release message, the SN releases radio and C-plane related resources associated to the UE context. Any ongoing data forwarding may continue.

FIG. 13 shows an example signalling flow for the SN-initiated SN Release procedure. In operation 1, the SN initiates the procedure by sending the SN Release Required message, which does not contain any inter-node message. In operation 2, if data forwarding is requested, the MN provides data forwarding addresses to the SN in the SN Release Confirm message. The SN may start data forwarding and stop providing user data to the UE as soon as it receives the SN Release Confirm message.

In operations 3 and 4, if required, the MN indicates in the MN RRC reconfiguration message towards the UE that the UE shall release the entire SCG configuration. In case the UE is unable to comply with (part of) the configuration included in the MN RRC reconfiguration message, it performs the reconfiguration failure procedure. Note again that if data forwarding is applied, timely coordination between steps 2 and 3 may minimize gaps in service provision. This is, however, regarded to be an implementation matter.

In operation 5, if the PDCP termination point is changed to the MN for bearers using RLC AM, the SN sends the SN Status Transfer. In operation 6, data forwarding from the SN to the MN may start.

In operation 7, the SN sends the Secondary RAT Data Usage Report message to the MN and includes the data volumes delivered to and received from the UE. Again, note that if data forwarding is applied, the order the SN sends the Secondary RAT Data Usage Report message and starts data forwarding with MN is not defined, i.e., step 7 can take place before step 6. The SN does not need to wait for the end of data forwarding to send the Secondary RAT Data Usage Report message.

In operation 8, if applicable, the PDU Session path update procedure is initiated. In operation 9, upon reception of the UE Context Release message, the SN releases radio and C-plane related resources associated to the UE context. Any ongoing data forwarding may continue.

The Activity Notification function is used to report user plane activity within SN resources or to report a RAN Paging Failure event to the SN. It can either report inactivity or resumption of activity after inactivity was reported. In MR-DC with 5GC the Activity Reporting is provided from the SN only. The MN may take further actions. RAN Paging Failure Reporting is provided from the MN only.

FIG. 14 illustrates the Activity Notification function. In operation 1, the SN notifies the MN about user data inactivity. In operation 2, the MN decides further actions that impact SN resources (e.g., send UE to RRC_INACTIVE, bearer reconfiguration). In the case shown, MN takes no action. In operation 3, the SN notifies the MN that the (UE or PDU Session or QoS flow) is no longer inactive.

The Activity Notification function may be used to enable MR-DC with 5GC with RRC_INACTIVE operation. The MN node may decide, after inactivity is reported from the SN and also MN resources show no activity, to send the UE to RRC_INACTIVE. Resumption to RRC_CONNECTED may take place after activity is reported from the SN for SN terminated bearers.

FIG. 15 shows how the Activity Notification function interacts with NG-RAN functions for RRC_INACTIVE and SN Modification procedures in order to keep the higher layer MR-DC NG-RAN resources established for UEs in RRC_INACTIVE, including NG and Xn interface C-plane, U-plane and bearer contexts established while lower layer MCG and SCG resources are released. NG-RAN memorizes the cell group configuration for MCG in order to apply delta signalling at resume, as specified in TS 38.331. After the UE has transited successfully back to RRC_CONNECTED, lower layer SCG resources are established afterwards by means of RRC Connection Reconfiguration.

In operation 1, the SN notifies the MN about user data inactivity for SN terminated bearers. In operation 2, the MN decides to send the UE to RRC_INACTIVE. In operations 3 and 4, the The MN triggers the MN initiated SN Modification procedure, requesting the SN to release lower layers.

In operation 5, the UE is sent to RRC_INACTIVE. In operations 6-8, after a period of inactivity, upon activity notification from the SN, the UE returns to RRC_CONNECTED. In operation 8bis, the MN decides whether to reactivate the SN terminated bearers. If the MN decides not to reactivate the SN terminated bearers (e.g., due to UE mobility), it initiates the MN initiated SN release procedure and the procedure ends.

In operations 9 and 10, the MN triggers the MN initiated SN Modification procedure to reestablish lower layers. The SN provides configuration data within an SN RRC configuration message. In operations 11-14, the RRCConnectionReconfiguration procedure commences.

Another scenario is MR-DC with 5GC with RRC INACTIVE, where the SCG configuration is suspended in the SN. The Activity Notification function may be used to enable MR-DC with 5GC with RRC_INACTIVE operation. The MN node may decide, after inactivity is reported from the SN and also MN resources show no activity, to send the UE to RRC_INACTIVE, while keeping the SCG configuration. Resumption to RRC_CONNECTED may take place after activity is reported from the SN for SN terminated bearers.

FIG. 16 shows how Activity Notification function interacts with NG-RAN functions for RRC_INACTIVE and SN Modification procedures in order to keep the full MR-DC NG-RAN resources established for UEs in RRC_INACTIVE. When the UE transits successfully back to RRC_CONNECTED, lower layer MCG and SCG configurations are restored or reconfigured by means of RRC (Connection) Resume.

In operation 1, the SN notifies the MN about user data inactivity for SN terminated bearers. In operation 2, the MN decides to send the UE to RRC_INACTIVE. In operations 3 and 4, the MN triggers the MN initiated SN Modification procedure, requesting the SN to suspend lower layers.

In operation 5, the UE is sent to RRC_INACTIVE. In operations 6-8, after a period of inactivity, upon activity notification from the SN, the MN decides to return the UE to RRC_CONNECTED. In operation 8bis, the MN decides whether to reactivate the SN terminated bearers. If the MN decides not to reactivate the SN terminated bearers (e.g., due to UE mobility), it initiates the MN initiated SN release procedure, rather than the MN-initiated SN modification procedure in steps 9/10.

In operations 9 and 10, the MN triggers the MN initiated SN Modification procedure to resume the SCG lower layers. If the SCG configuration needs to be updated, the SN provides the configuration data within an SN RRC configuration message. In operations 11 and 12, the RRC (Connection) Resume procedure commences, where the UE is instructed to resume both the MCG and the SCG. If the SCG configuration is to be updated, the new configuration is provided in the RRC(Connection)Resume message.

In operation 13, the MN informs the SN that the UE has completed the reconfiguration procedure successfully, via the SN Reconfiguration Complete message, including the SN RRC response message, if received from the UE. In operation 14, if instructed, the UE performs synchronization towards the PSCell of the SN.

LTE carriers can be only up to 20 MHz wide (and UE can be configured to utilize up to 640 MHz by utilizing 32 such carries together with carrier aggregation). In NR, on the other hand, the maximum carrier bandwidth is 100 MHz in frequency range 1 (FR1: 450 MHz to 6 GHz), and 400 MHz in frequency range 2 (FR2: 24.25 GHz to 52.6 GHz). With carrier aggregation, a UE can be configured to use up to 800 MHz.

Configuring the UE with a wider bandwidth will enable higher data rates, but it has the downside on UE power consumption. Just continuously scanning a full FR2 carrier of 400 MHz is very expensive. Thus, the concept of bandwidth parts (BWPs) was introduced in NR rel-15. BWPs allow the flexibility of subdividing a carrier into multiple parts, where each part is configured differently. For example, one BWP may have reduced energy requirements, while another may support different functions or services, and yet another may provide coexistence with other systems. Thus, for a certain carrier, the UE may be configured with multiple BWPs, where only one of them active at a time, where switching from one BWP to another is triggered depending on the need (e.g., a narrower BWP for power saving, a wider BW to get more throughput when a higher data rate bearer is activated, a BWP employing smaller slot numerology for services that require very low latency, etc). BWPs do not necessarily have to be contiguous, and one BWP could actually be completely within another BWP. FIG. 17 illustrates examples of BWPs.

For each serving cell of the UE (regardless of them being a PCell/PSCell or an SCell the belongs to the MCG or SCG), up to four UL/DL BWPs can be configured. One DL BWP serves as the default DL BPW. Only one UL and one DL BWP are active at one time, meaning the UE cannot transmit PUSCH/PUCCH in the UL outside the UL BWP and cannot receive PDSCH/PDCCH outside the active DL BWP.

The switching between BWPs is performed via RRC signaling or even faster via DCI signaling at the physical layer. Implicit switching is also supported via a BWP inactivity timer (i.e., when the configured timer expires without any UP or CP activity from/to the UE on the concerned carrier, the UE switches to using the default BWP).

Each BWP has its own specific configuration including numerology, frequency location, bandwidth size and control resource set (CORSET). The CORSET provides the required information for the UE to monitor the PDCCH. Each CORESET is allocated with time and frequency resources with a periodicity of a slot. An example configuration is shown in FIG. 18.

Though carrier aggregation enables the usage of wider bandwidths, thereby leading to higher aggregate throughput for the UE, it comes at the expense of UE power consumption. Even if the UE is not being scheduled on a certain carrier, maintaining that carrier (e.g., scanning the PDCCH for incoming scheduling, etc.) consumes power. Thus, SCells can be set to be in deactivated state when they are not being utilized.

When an SCell is deactivated, the UE does not need to receive the corresponding PDCCH or PDSCH, cannot transmit in the corresponding uplink, nor is it required to perform CQI/CSI measurements. Conversely, when an SCell is active, the UE shall receive PDSCH and PDCCH (if the UE is configured to monitor PDCCH from this SCell) and is expected to be able to perform CQI measurements. To enable faster CQI reporting, a temporary CQI reporting period (called short CQI period) can be supported during SCell activation period. The activation/deactivation can be performed via RRC signaling (during SCell addition/Handover/Connection Resume), or a MAC CE. Implicit transition from activated to deactivate state is also possible via a configuration of inactivity timers.

Note that in this document the terms Channel State Information (CSI) and Channel Quality Indication (CQI) are used interchangeably. However, strictly speaking, CSI is a collective name of several different type of UE reports that includes the CQI, precoding matrix indicator (PMI), precoding type indicator (PTI) and rank indication (RI).

Secondary cells (SCells) can be individually activated or deactivated, as needed. An example procedure is shown in FIG. 19. The activation/deactivation mechanism is based on the combination of a MAC control element and deactivation timers. The MAC control element carries a bitmap for the activation and deactivation of SCells: a bit set to 1 denotes activation of the corresponding SCell, while a bit set to 0 denotes deactivation. With the bitmap, SCells can be activated and deactivated individually, and a single activation/deactivation command can activate/deactivate a subset of the SCells. One deactivation timer is maintained per SCell but one common value is configured per UE by RRC.

In LTE, to enable faster transition to activated state, a dormant state for SCells (i.e., not PCell or PSCell) is supported. When an SCell is in dormant state, like in the deactivate state, the UE does not need to monitor the corresponding PDCCH or PDSCH and cannot transmit in the corresponding uplink. However, differently from deactivated state, the UE is required to perform and report CQI measurements. A PUCCH SCell (SCell configured with PUCCH) cannot be in dormant state. FIG. 20 is an illustration of dormant state SCells in LTE, where the lower part of the figure shows the transition between activated and dormant states.

In NR, dormancy-like behaviour for SCells is realized using the concept of dormant BWPs. One dormant BWP, which is one of the dedicated BWPs configured by the network via RRC signaling, can be configured for an SCell. If the active BWP of the activated SCell is a dormant BWP, the UE stops monitoring PDCCH on the SCell but continues performing CSI measurements, AGC and beam management, if configured. A DCI is used to control entering/leaving the dormant BWP for one or more SCell(s) or one or more SCell group(s), and it is sent to the special cell (sPCell) of the cell group that the SCell belongs to (i.e., PCell in case the SCell belongs to the MCG and PSCell if the SCell belongs to the SCG). The sPCell (i.e., PCell or PSCell) and PUCCH SCell cannot be configured with a dormant BWP. FIG. 21 illustrates dormancy-like behavior for SCells in NR.

A select number of information element (IE) descriptions for IEs related to BWPs, dormant BWPs, RLM, etc., are given below. These are taken from 3GPP TS 38.33v 16.0.0, with updates related to dormancy as made in endorsed CR R2-2006350.

### Begin IE Descriptions

### BWP

The IE BWP is used to configure generic parameters of a bandwidth part as defined in TS 38.211 [16], clause 4.5, and TS 38.213 [13], clause 12.

For each serving cell the network configures at least an initial downlink bandwidth part and one (if the serving cell is configured with an uplink) or two (if using supplementary uplink (SUL)) initial uplink bandwidth parts. Furthermore, the network may configure additional uplink and downlink bandwidth parts for a serving cell.

The uplink and downlink bandwidth part configurations are divided into common and dedicated parameters.

### BWP Information Element

-- ASN1START
-- TAG-BWP-START
BWP ::= SEQUENCE {
locationAndBandwidth INTEGER (0..37949),
subcarrierSpacing SubcarrierSpacing,
cyclicPrefix ENUMERATED { extended }
OPTIONAL -- Need R
}
-- TAG-BWP-STOP
-- ASN1STOP

### - BWP-Downlink

The IE BWP-Downlink is used to configure an additional downlink bandwidth part (not for the initial BWP).

### BWP-Downlink Information Element

-- ASN1START
-- TAG-BWP-DOWNLINK-START
BWP-Downlink ::= SEQUENCE {
bwp-Id BWP-Id,
bwp-Common BWP-DownlinkCommon
OPTIONAL, -- Cond SetupOtherBWP
bwp-Dedicated BWP-DownlinkDedicated
OPTIONAL, -- Cond SetupOtherBWP
...
}
-- TAG-BWP-DOWNLINK-STOP
-- ASN1STOP

BWP-Downlink field descriptions
bwp-ld
An identifier for this bandwidth part. Other parts of the RRC configuration use the BWP-ld to associate themselves with a particular bandwidth part.
The network configures the BWPs with consecutive IDs from 1. The Network does not include the value 0, since value 0 is reserved for the initial BWP.

| | |
|---|---|
| Conditional Presence | Explanation |
| SetupOtherBWP | The field is mandatory present upon configuration of a new DL BWP. The field is optionally present, Need M, otherwise. |

### BWP-DownlinkCommon

The IE BWP-DownlinkCommon is used to configure the common parameters of a downlink BWP. They are “cell specific” and the network ensures the necessary alignment with corresponding parameters of other UEs. The common parameters of the initial bandwidth part of the PCell are also provided via system information. For all other serving cells, the network provides the common parameters via dedicated signalling.

### BWP-DownlinkCommon Information Element

-- ASN1START
-- TAG-BWP-DOWNLINKCOMMON-START
BWP-DownlinkCommon ::= SEQUENCE {
genericParameters BWP, pdcch-ConfigCommon SetupRelease { PDCCH-ConfigCommon }
OPTIONAL, -- Need M
pdsch-ConfigCommon SetupRelease { PDSCH-ConfigCommon }
OPTIONAL, -- Need M
...
}
-- TAG-BWP-DOWNLINKCOMMON-STOP
-- ASN1STOP

BWP-DownlinkCommon field descriptions
pdcch-ConfigCommon
Cell specific parameters for the PDCCH of this BWP. This field is absent for a dormant BWP.
pdsch-ConfigCommon
Cell specific parameters for the PDSCH of this BWP.

### BWP-DownlinkDedicated

The IE BWP-DownlinkDedicated is used to configure the dedicated (UE specific) parameters of a downlink BWP.

### BWP-DownlinkDedicated Information Element

-- ASN1START
-- TAG-BWP-DOWNLINKDEDICATED-START
BWP-DownlinkDedicated ::= SEQUENCE {
pdcch-Config SetupRelease { PDCCH-Config }
OPTIONAL, -- Need M
pdsch-Config SetupRelease { PDSCH-Config }
OPTIONAL, -- Need M
sps-Config SetupRelease { SPS-Config }
OPTIONAL, -- Need M
radioLinkMonitoringConfig SetupRelease { RadioLinkMonitoringConfig }
OPTIONAL, -- Need M
...,
[[
sps-ConfigList-r16 SetupRelease { SPS-ConfigList-r16 }
OPTIONAL, -- Need M
beamFailureRecoverySCellConfig-r16 SetupRelease {BeamFailureRecoverySCellConfig-r16}
OPTIONAL -- Cond SCellOnly
] ]
}
-- TAG-BWP-DOWNLINKDEDICATED-STOP
-- ASN1STOP

BWP-DownlinkDedicated field descriptions
beamFailureRecoverySCellConfig
Configuration of candidate RS for beam failure recovery in SCells.
pdcch-Config
UE specific PDCCH configuration for one BWP.
pdsch-Config
UE specific PDSCH configuration for one BWP.
sps-Config
UE specific SPS (Semi-Persistent Scheduling) configuration for one BWP. Except for reconfiguration with sync, the NW does not reconfigure sps-Config when there is an active configured downlink assignment (see TS 38.321 [3]). However, the NW may release the sps-Config at any time.
sps-ConfigList
UE specific multiple SPS (Semi-Persistent Scheduling) configurations for one BWP. Except for reconfiguration with sync, the NW does not reconfigure a SPS configuration when it is active (see TS 38.321 [3]). However, the NW may release a SPS configuration at any time.
radioLinkMonitoringConfig
UE specific configuration of radio link monitoring for detecting cell- and beam radio link failure occasions. The maximum number of failure detection resources should be limited up to 8 for both cell and beam radio link failure detection. For SCells, only periodic 1-port CSI-RS can be configured in IE RadioLinkMonitoringConfig.

| | |
|---|---|
| Conditional Presence | Explanation |
| ScellOnly | The field is optionally present, Need M, in the BWP-DownlinkDedicated of an Scell. It is absent otherwise. |

### CellGroupConfig

The CellGroupConfig IE is used to configure a master cell group (MCG) or secondary cell group (SCG). A cell group comprises of one MAC entity, a set of logical channels with associated RLC entities and of a primary cell (SpCell) and one or more secondary cells (SCells).

### CellGroupConfig Information Element

-- ASN1START
-- TAG-CELLGROUPCONFIG-START
-- Configuration of one Cell-Group:
CellGroupConfig ::= SEQUENCE {
cellGroupId CellGroupId,
rlc-BearerToAddModList SEQUENCE (SIZE(1..maxLC-ID)) OF RLC-BearerConfig
OPTIONAL, -- Need N
rlc-BearerToReleaseList SEQUENCE (SIZE(1..maxLC-ID)) OF
LogicalChannelIdentity OPTIONAL, -- Need N
mac-CellGroupConfig MAC-CellGroupConfig
OPTIONAL, -- Need M
physicalCellGroupConfig PhysicalCellGroupConfig
OPTIONAL, -- Need M
spCellConfig SpCellConfig
OPTIONAL, -- Need M
sCellToAddModList SEQUENCE (SIZE (1..maxNrofSCells)) OF SCellConfig
OPTIONAL, -- Need N
sCellToReleaseList SEQUENCE (SIZE (1..maxNrofSCells)) OF SCellIndex
OPTIONAL, -- Need N
...,
[[
reportUplinkTxDirectCurrent ENUMERATED {true}
OPTIONAL -- Cond BWP-Reconfig
]],
[[
bap-Address-r16 BIT STRING (SIZE (10))
OPTIONAL, -- Need M
bh-RLC-ChannelToAddModList-r16 SEQUENCE (SIZE(1..maxLC-ID-Iab-r16)) OF BH-RLC-
ChannelConfig-r16 OPTIONAL, -- Need N
bh-RLC-ChannelToReleaseList-r16 SEQUENCE (SIZE(1..maxLC-ID-Iab-r16)) OF BH-
LogicalChannelIdentity-r16 OPTIONAL, -- Need N
dormancySCellGroups DormancySCellGroups
OPTIONAL, -- Need N
simultaneousTCI-UpdateList-r16 SEQUENCE (SIZE (1..maxNrofServingCellsTCI-r16)) OF
ServCellIndex OPTIONAL, -- Need R
simultaneousTCI-UpdateListSecond-r16 SEQUENCE (SIZE (1..maxNrofServingCellsTCI-r16)) OF
ServCellIndex OPTIONAL, -- Need R
simultaneousSpatial-UpdatedList-r16 SEQUENCE (SIZE (1..maxNrofServingCellsTCI-r16)) OF
ServCellIndex OPTIONAL, -- Need R
simultaneousSpatial-UpdatedListSecond-r16 SEQUENCE (SIZE (1..maxNrofServingCellsTCI-r16)) OF
ServCellIndex OPTIONAL -- Need R
]]
}
DormancySCellGroups::= SEQUENCE {
withinActiveTimeToAddModList SEQUENCE (SIZE (1..maxNrofDormancyGroups)) OF
DormancyGroup-r16 OPTIONAL, -- Need N
withinActiveTimeToReleaseList SEQUENCE (SIZE (1..maxNrofDormancyGroups)) OF
DormancyGroupID-r16 OPTIONAL, -- Need N
outsideActiveTimeToAddModList SEQUENCE (SIZE (1..maxNrofDormancyGroups)) OF
DormancyGroup-r16 OPTIONAL, -- Cond DormancyWUS
outsideActiveTimeToReleaseList SEQUENCE (SIZE (1..maxNrofDormancyGroups)) OF
DormancyGroupID-r16 OPTIONAL -- Need N
}
-- Serving cell specific MAC and PHY parameters for a SpCell:
SpCellConfig ::= SEQUENCE {
servCellIndex ServCellIndex
OPTIONAL, -- Cond SCG
reconfigurationWithSync ReconfigurationWithSync
OPTIONAL, -- Cond ReconfWithSync
rlf-TimersAndConstants SetupRelease { RLF-TimersAndConstants }
OPTIONAL, -- Need M
rlmInSyncOutOfSyncThreshold ENUMERATED {n1}
OPTIONAL, -- Need S
spCellConfigDedicated ServingCellConfig
OPTIONAL, -- Need M
...
}
ReconfigurationWithSync ::= SEQUENCE {
spCellConfigCommon ServingCellConfigCommon
OPTIONAL, -- Need M
newUE-Identity RNTI-Value,
t304 ENUMERATED {ms50, ms100, ms150, ms200, ms500, ms1000,
ms2000, ms10000},
rach-ConfigDedicated CHOICE {
uplink RACH-ConfigDedicated,
supplementaryUplink RACH-ConfigDedicated
}
OPTIONAL, -- Need N
...,
[[
smtc SSB-MTC
OPTIONAL -- Need S
]]
}
SCellConfig ::= SEQUENCE {
sCellIndex SCellIndex,
sCellConfigCommon ServingCellConfigCommon
OPTIONAL, -- Cond SCellAdd
sCellConfigDedicated ServingCellConfig
OPTIONAL, -- Cond SCellAddMod
...,
[[
smtc SSB-MTC
OPTIONAL -- Need S
]],
[[
sCellState-r16 ENUMERATED {activated}
OPTIONAL -- Need SCellAddSync
]]}
DormancyGroup-r16 ::= SEQUENCE {
dormancyGroupID-r16 DormancyGroupID-r16,
dormancySCellList-r16 SEQUENCE (SIZE (1..maxNrofSCells)) OF SCellIndex
}
DormancyGroupID-r16 ::= INTEGER (0..4)
-- TAG-CELLGROUPCONFIG-STOP
-- ASN1STOP

DormancyGroup field descriptions
dormancySCellList
List of SCells within the same SCell dormancy group.
dormancyGroupID
The field indicates an SCell group corresponding to the explicit information field in DCI, i.e., bitmap with 1 bit per DormancyGroup for indicating dormancy/non-dormancy of SCells, as specified in TS 38.213.

DormancySCellGroups field descriptions
outsideActiveTimeToAddModList
List of Dormancy outside active time SCell groups to be added or modified. The use of the Dormancy outside active time SCell groups is specified in TS 38.213 [13].
withinActiveTimeToAddModList
List of Dormancy within active time SCell groups SCell groups to be added or modified. The use of the Dormancy within active time SCell groups is specified in TS 38.213 [13].

### ServingCellConfig

The IE ServingCellConfig is used to configure (add or modify) the UE with a serving cell, which may be the sPCell or an SCell of an MCG or SCG. The parameters herein are mostly UE specific but partly also cell specific (e.g., in additionally configured bandwidth parts). Reconfiguration between a PUCCH and PUCCHless SCell is only supported using an SCell release and add.

### ServingCellConfig Information Element

-- ASN1START
-- TAG-SERVINGCELLCONFIG-START
ServingCellConfig ::= SEQUENCE {
tdd-UL-DL-ConfigurationDedicated TDD-UL-DL-ConfigDedicated
OPTIONAL, -- Cond TDD
initialDownlinkBWP BWP-DownlinkDedicated
OPTIONAL, -- Need M
downlinkBWP-ToReleaseList SEQUENCE (SIZE (1..maxNrofBWPs)) OF BWP-Id
OPTIONAL, -- Need N
downlinkBWP-ToAddModList SEQUENCE (SIZE (1..maxNrofBWPs)) OF BWP-Downlink
OPTIONAL, -- Need N
firstActiveDownlinkBWP-Id BWP-Id
OPTIONAL, -- Cond SyncAndCellAdd
bwp-InactivityTimer ENUMERATED {ms2, ms3, ms4, ms5, ms6, ms8, ms10, ms20,
ms30,
ms40,ms50, ms60, ms80,ms100, ms200,ms300,
ms500,
ms750, ms1280, ms1920, ms2560, spare10,
spare9, spare8,
spare7, spare6, spare5, spare4, spare3,
spare2, spare1 } OPTIONAL, --Need R
defaultDownlinkBWP-Id BWP-Id
OPTIONAL, -- Need S
uplinkConfig UplinkConfig
OPTIONAL, -- Need M
supplementaryUplink UplinkConfig
OPTIONAL, -- Need M
pdcch-ServingCellConfig SetupRelease { PDCCH-ServingCellConfig }
OPTIONAL, -- Need M
pdsch-ServingCellConfig SetupRelease { PDSCH-ServingCellConfig }
OPTIONAL, -- Need M
csi-MeasConfig SetupRelease { CSI-MeasConfig }
OPTIONAL, -- Need M
sCellDeactivationTimer ENUMERATED {ms20, ms40, ms80, ms160, ms200, ms240,
ms320, ms400, ms480, ms520, ms640, ms720,
ms840, ms1280, spare2,spare1} OPTIONAL,
-- Cond ServingCellWithoutPUCCH
crossCarrierSchedulingConfig CrossCarrierSchedulingConfig
OPTIONAL, -- Need M
tag-Id TAG-Id,
dummy ENUMERATED {enabled)
OPTIONAL, -- Need R
pathlossReferenceLinking ENUMERATED {spCell, sCell}
OPTIONAL, -- Cond SCellOnly
servingCellMO MeasObjectId
OPTIONAL, -- Cond MeasObject
...,
[[
lte-CRS-ToMatchAround SetupRelease { RateMatchPatternLTE-CRS }
OPTIONAL, -- Need M
rateMatchPatternToAddModList SEQUENCE (SIZE (1..maxNrofRateMatchPatterns)) OF
RateMatchPattern OPTIONAL, -- Need N
rateMatchPatternToReleaseList SEQUENCE (SIZE (1..maxNrofRateMatchPatterns)) OF
RateMatchPatternId OPTIONAL, -- Need N
downlinkChannelBW-PerSCS-List SEQUENCE (SIZE (1..maxSCSs)) OF SCS-SpecificCarrier
OPTIONAL -- Need S
]],
[[
supplementaryUplinkRelease ENUMERATED {true}
OPTIONAL, -- Need N
tdd-UL-DL-ConfigurationDedicated-iab-mt-v16xy TDD-UL-DL-ConfigDedicated-IAB-MT-v16xy
OPTIONAL, -- Need FFS
dormantBWP-Config-r16 SetupRelease { DormantBWP-Config-r16 }
OPTIONAL, -- Need M
ca-SlotOffset-r16 CHOICE {
refSCS15kHz INTEGER (-2..2),
refSCS30KHz INTEGER (-5..5),
refSCS60KHz INTEGER (-10..10),
refSCS120KHz INTEGER (-20..20)
} OPTIONAL,
-- Cond AsyncCA
channelAccessConfig-r16 ChannelAccessConfig-r16 OPTIONAL
-- Need M
]]
}
UplinkConfig ::= SEQUENCE {
initialUplinkBWP BWP-UplinkDedicated
OPTIONAL, -- Need M
uplinkBWP-ToReleaseList SEQUENCE (SIZE (1..maxNrofBWPs)) OF BWP-Id
OPTIONAL, -- Need N
uplinkBWP-ToAddModList SEQUENCE (SIZE (1..maxNrofBWPs)) OF BWP-Uplink
OPTIONAL, -- Need N
firstActiveUplinkBWP-Id BWP-Id
OPTIONAL, -- Cond SyncAndCellAdd
pusch-ServingCellConfig SetupRelease { PUSCH-ServingCellConfig }
OPTIONAL, -- Need M
carrierSwitching SetupRelease { SRS-CarrierSwitching }
OPTIONAL, -- Need M
...,
[[
powerBoostPi2BPSK BOOLEAN
OPTIONAL, -- Need M
uplinkChannelBW-PerSCS-List SEQUENCE (SIZE (1..maxSCSs)) OF SCS-SpecificCarrier
OPTIONAL -- Need S
]],
[[
bdFactorR-r16 ENUMERATED {n1}
OPTIONAL, -- Need R
lte-CRS-PatternList-r16 SetupRelease { LTE-CRS-PatternList-r16 }
OPTIONAL, -- Cond LTE-CRS
lte-CRS-PatternListSecond-r16 SetupRelease { LTE-CRS-PatternList-r16 }
OPTIONAL, -- Cond CORESETPool
enablePLRS-UpdateForPUSCH-SRS ENUMERATED {enabled)
OPTIONAL, -- Need R
enableDefaultBeamPL-ForPUSCH0 ENUMERATED {enabled)
OPTIONAL, -- Need R
enableDefaultBeamPL-ForPUCCH ENUMERATED {enabled)
OPTIONAL, -- Need R
enableDefaultBeamPL-ForSRS ENUMERATED {enabled)
OPTIONAL -- Need R
]]
}
ChannelAccessConfig-r16 ::= SEQUENCE {
maxEnergyDetectionThreshold-r16 INTEGER(-85..-52),
energyDetectionThresholdOffset-r16 INTEGER (-20..-13),
ul-toDL-COT-SharingED-Threshold-r16 INTEGER (-85..-52) OPTIONAL, -- Need R
absenceOfAnyOtherTechnology-r16 ENUMERATED {true} OPTIONAL -- Need R
}
DormancyGroupID-r16 ::= INTEGER (0..4)
DormantBWP-Config-r16::= SEQUENCE {
dormantBWP-Id-r16 BWP-Id
OPTIONAL, -- Need M
withinActiveTimeConfig-r16 SetupRelease { WithinActiveTimeConfig-r16 }
OPTIONAL, -- Need M
outsideActiveTimeConfig-r16 SetupRelease { OutsideActiveTimeConfig-r16 }
OPTIONAL -- Need M
}
WithinActiveTimeConfig-r16 ::= SEQUENCE {
firstWithinActiveTimeBWP-Id-r16 BWP-Id
OPTIONAL, -- Need M
dormancyGroupWithinActiveTime-r16 DormancyGroupID-r16
OPTIONAL -- Need R
}
OutsideActiveTimeConfig-r16 ::= SEQUENCE {
firstOutsideActiveTimeBWP-Id-r16 BWP-Id
OPTIONAL, -- Need M
dormancyGroupOutsideActiveTime-r16 DormancyGroupID-r16
OPTIONAL -- Need R
}
-- TAG-SERVINGCELLCONFIG-STOP
-- ASN1STOP

DormantBWP-Config field descriptions
dormancyGroupWithinActiveTime
This field contains the ID of an SCell group for Dormancy within active time, to which this SCell belongs. The use of the Dormancy within active time SCell groups is specified in TS 38.213 [13].
dormancyGroupOutsideActiveTime
This field contains the ID of an SCell group for Dormancy outside active time, to which this SCell belongs. The use of the Dormancy outside active time SCell groups is specified in TS 38.213 [13].
dormantBWP-Id
This field contains the ID of the downlink bandwidth part to be used as dormant BWP. If this field is configured, its value is different from defaultDownlinkBWP-Id, and at least one of the withinActiveTimeConfig and outsideActiveTimeConfigshould be configured.
firstOutsideActiveTimeBWP-Id
This field contains the ID of the downlink bandwidth part to be activated when receiving a DCI indication for SCell dormancy outside active time.
firstWithinActiveTimeBWP-Id
This field contains the ID of the downlink bandwidth part to be activated when receiving a DCI indication for SCell dormancy within active time.
outsideActiveTimeConfig
This field contains the configuration to be used for SCell dormancy outside active time, as specified in TS 38.213 [13]. The field can only be present when the cell group the SCell belongs to is configured with dcp-Config.
withinActiveTimeConfig
This field contains the configuration to be used for SCell dormancy within active time, as specified in TS 38.213 [13].

### End IE Descriptions

### SUMMARY

As discussed above, 3GPP has specified the concepts of dormant SCell (in LTE) and dormancy-like behavior of an SCell (for NR). However, only SCells can be put to put in dormant state (in LTE) or operate in dormancy-like behaviour (NR). Also, only SCells can be put into the deactivated state in both LTE and NR. Thus, if the UE is configured with MR-DC, it is not possible to fully benefit from the power saving options of dormant state or dormancy-like behavior as the PSCell cannot be configured with that feature. Instead, an existing solution could be releasing (for power savings) and adding (when traffic demands require) the SCG on a need basis. However, traffic is likely to be bursty, and adding and releasing the SCG involves a significant amount of RRC signaling and inter-node messaging between the MN and the SN, which causes considerable delay.

While there have been preliminary discussions regarding putting the PSCell into dormancy, or suspending it, the exact behavior of the UE upon suspension has not been defined. Embodiments of the techniques described herein address this problem.

In the detailed discussion below several mechanisms are described to enable power efficient utilization of dual connectivity, where the SCG/PSCell can be suspended when not needed and activated with minimum delay when the dual connectivity feature is needed again. Several mechanisms/alternatives for handling SCG suspension and resumption are proposed, mainly covering:
different conditions for triggering SCG suspension and resumption,
suspension that is triggered by the MN or the SN,
resumption that is triggered by the MN or the SN, and
configurations/behavior the UE has to apply on SCG suspension and resumption.

Example embodiments described herein include a method, for a user equipment (UE) operating in dual connectivity (DC) with a master node (MN) and a secondary node (SN), for suspending a secondary cell group (SCG). The method comprises receiving, from first radio network node (RNN), a command to suspend the SCG, and, in response to receiving the command, suspending the SCG. This first RNN may be the MN or the SN, in various embodiments. In some embodiments the method may further comprise receiving a command to resume operation with the SCG and, in response to the command to resume operation, resuming operation with the SCG.

Other example embodiments, include a method, for a first radio network node (RNN) serving a user equipment (UE) operating in dual connectivity (DC) with a master node (MN) and a secondary node (SN), for suspending the UE’s operation with a secondary cell group (SCG). This example method comprises determining that the SCG is to be suspended and sending, to the UE, a command to suspend the SCG. The first RNN may be the MN or the SN, in various embodiments. In some embodiments, determining that the SCG is to be suspended may comprise deciding to suspend the SCG in response to any one or more of the following triggering events or conditions: detecting uplink and/or downlink inactivity concerning the SCG; detecting an overload of the SN; detecting a low load of the MN; and detecting a low total uplink and/or downlink throughput for the DC. In some embodiments, this method may further comprise determining that the SCG is to be resumed and sending, to the UE, a command to resume the SCG.

Still another example is a method for a second radio network node (RNN) serving a user equipment (UE) operating in dual connectivity (DC) with a master node (MN) and a secondary node (SN), for suspending the UE’s operation with a secondary cell group (SCG). This method comprises determining that the SCG is to be suspended and sending, to a first RNN, a request to suspend the SCG.

Systems and apparatuses corresponding to these methods and variations thereof are described in detail below. These and other objects, features, and advantages of embodiments of the present disclosure will become apparent upon reading the following Detailed Description in view of the Drawings briefly described below.

### BRIEF DESCRIPTION OF THE DRAWINGS

FIG. 1 illustrates 3GPP scenarios for LTE and NR operation.

FIG. 2 illustrated radio bearer types in MR-DC.

FIG. 3 illustrates network side radio protocol termination options for MCG, SCG and split bearers in the MN and SN for MR-DC with EPC (EN-DC)

FIG. 4 illustrates network side radio protocol termination options for MCG, SCG and split bearers in the MN and SN for MR-DC with 5GC.

FIG. 5 illustrates the control plane architectures for EN-DC and for MR-DC with 5GC.

FIG. 6 illustrates network side protocol termination options for SRBs in MR-DC.

FIG. 7 illustrates an SN Addition procedure.

FIG. 8 illustrates an MN-initiated SN Modification procedure.

FIG. 9 illustrates an SN-initiated SN Modification procedure with MN involvement.

FIG. 10 illustrates an SN-initiated SN Modification procedure without MN involvement.

FIG. 11 illustrates transfer of an NR RRC message to/from a UE.

FIG. 12 illustrates an MN-initiated SN Release procedure.

FIG. 13 illustrates an SN-initiated SN Release procedure.

FIG. 14 illustrates the Activity Notification function.

FIG. 15 illustrates an example of how Activity Notification interacts with NG-RAN functions.

FIG. 16 illustrates another example of Activity Notification interaction with NG-RAN functions.

FIG. 17 and FIG. 18 illustrate bandwidth parts (BWPs).

FIG. 19 illustrates a transition between activated and inactive state for carrier aggregation.

FIG. 20 illustrates a transition between activated and dormant state for carrier aggregation.

FIG. 21 illustrates dormancy-like behavior for SCells in NR.

FIG. 22 and FIG. 23 each show high-level views of exemplary network architectures that support multi-RAT DC (MR-DC) using EPC and 5GC, respectively.

FIG. 24 shows MN-triggered SCG suspension, with SN involvement.

FIG. 25 shows MN-triggered SCG suspension, decided by MN.

FIG. 26, FIG. 27, FIG. 28, and FIG. 29 show examples of SN-triggered SCG suspension.

FIG. 30 shows an example of SN-triggered SCG suspension, with MN involvement and renegotiation.

FIG. 31 and FIG. 32 illustrate examples of SN-triggered SCG suspension without MN involvement.

FIG. 33 illustrates MN-triggered SCG resumption, with SN involvement.

FIG. 34 illustrates MN-triggered SCG resumption, without SN involvement.

FIG. 35 illustrates SN-triggered SCG resumption, with MN involvement, using RRC signaling.

FIG. 36 illustrates SN-triggered SCG resumption, with MN involvement and negotiation.

FIG. 37 illustrates an example of SN-triggered SCG resumption, without MN involvement.

FIG. 38 is a process flow diagram illustrating an example method carried out by a UE.

FIG. 39 is a process flow diagram illustrating an example method carried out by a radio network node (RNN).

FIG. 40 is a process flow diagram illustrating another example method carried out by a RNN.

FIG. 41 illustrates an exemplary embodiment of a wireless network.

FIG. 42 illustrates an exemplary embodiment of a UE.

FIG. 43 is a block diagram illustrating an exemplary virtualization environment usable for implementation of various embodiments of network nodes in a wireless network.

FIG. 44 and FIG. 45 are block diagrams of various communication systems and/or networks, according to various exemplary embodiments of the present disclosure.

FIG. 46, FIG. 47, FIG. 48, and FIG. 49 are flow diagrams of exemplary methods (e.g., procedures) for transmission and/or reception of user data, according to various exemplary embodiments of the present disclosure.

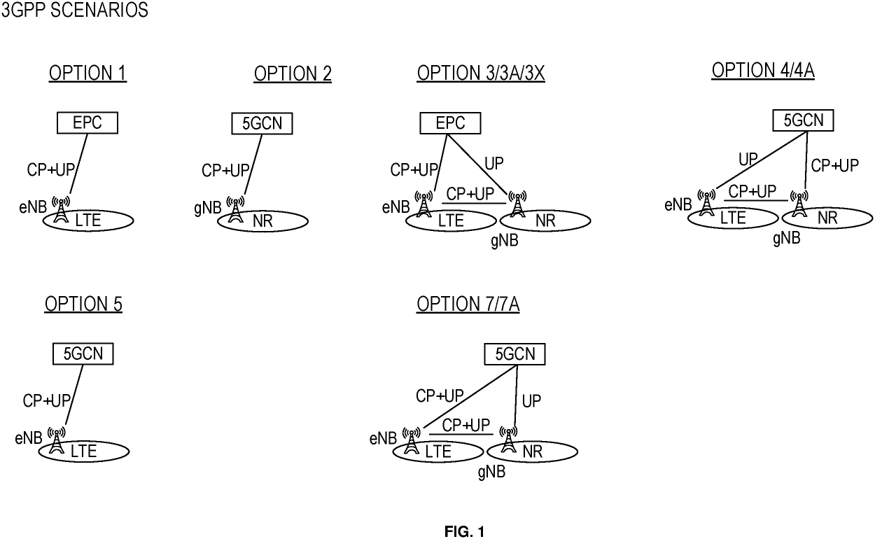

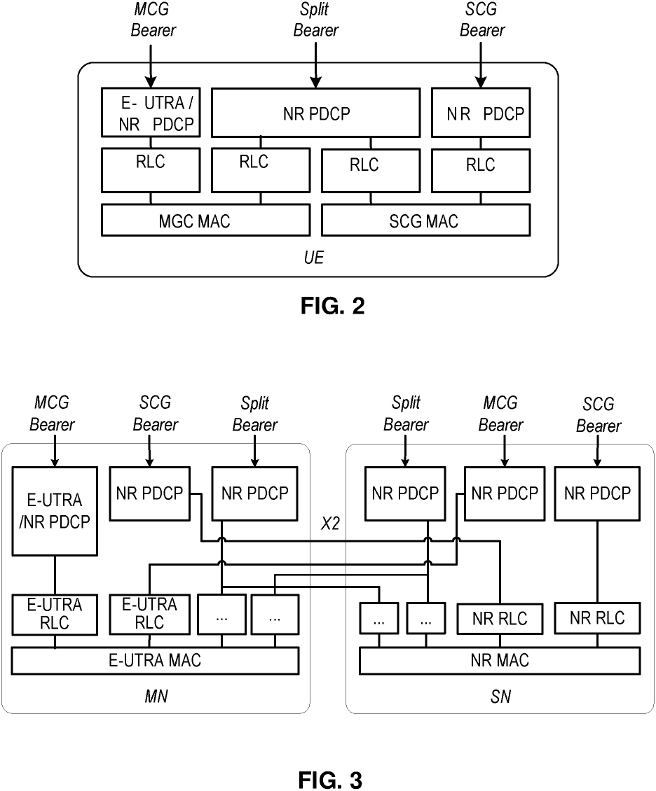

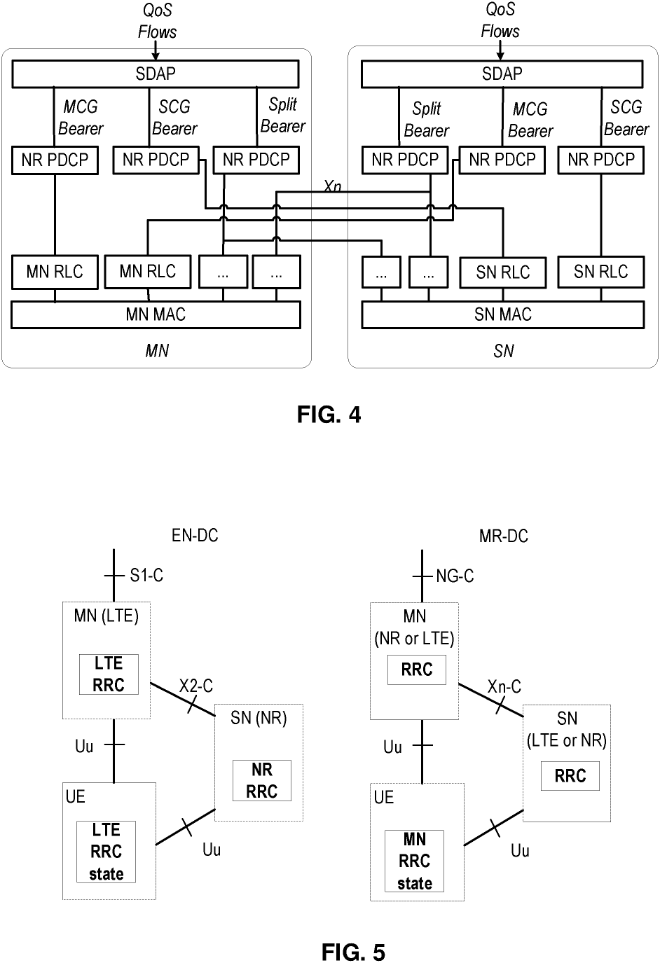

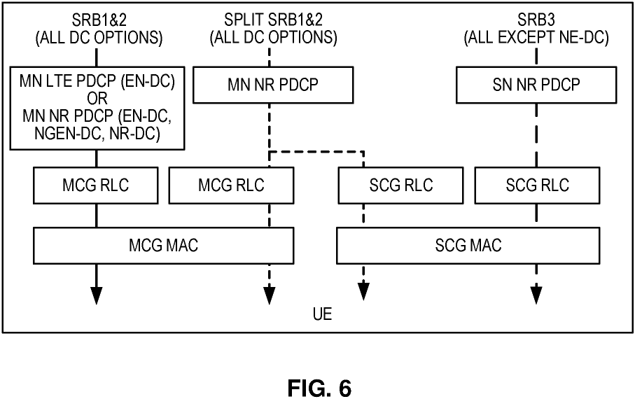

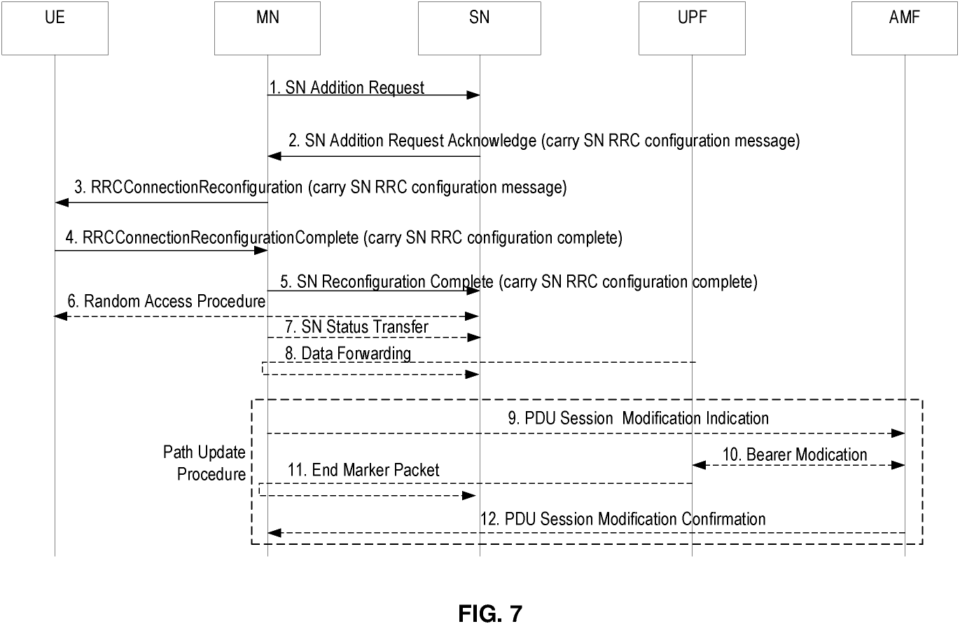

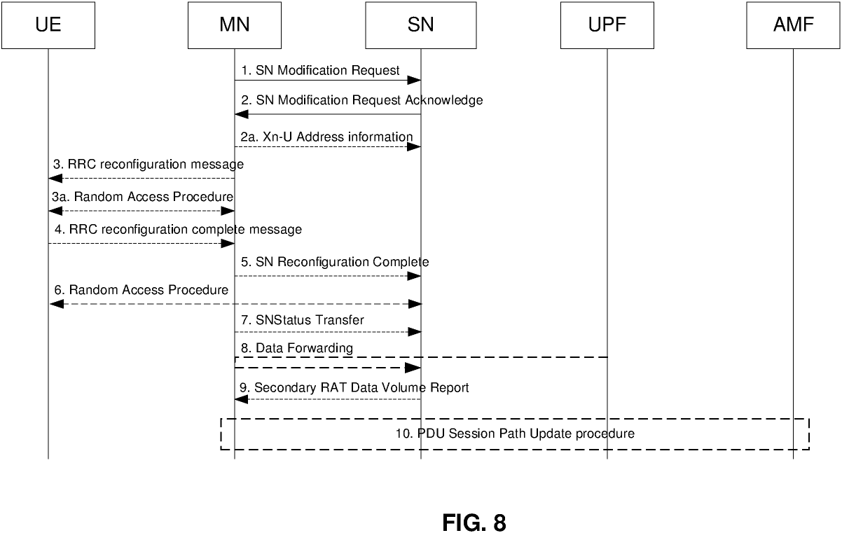

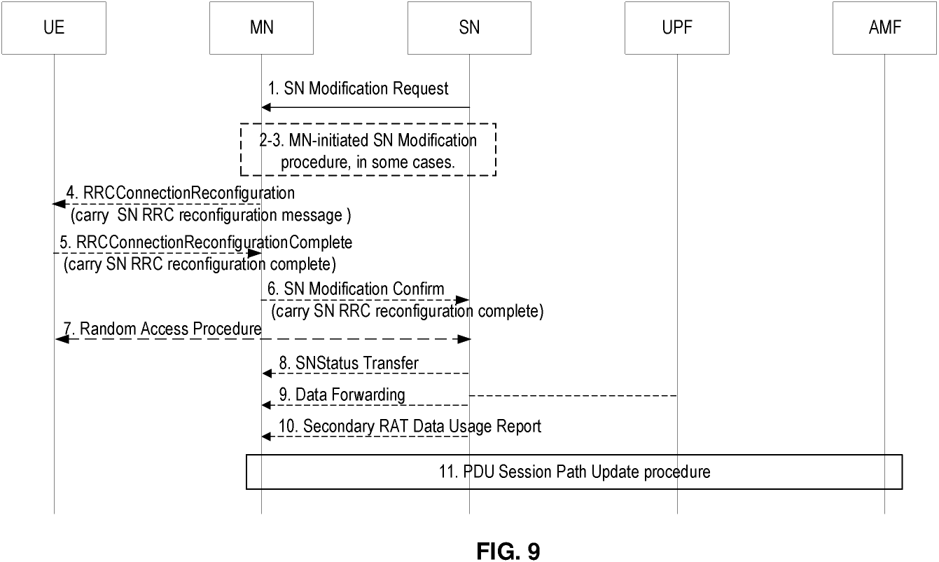

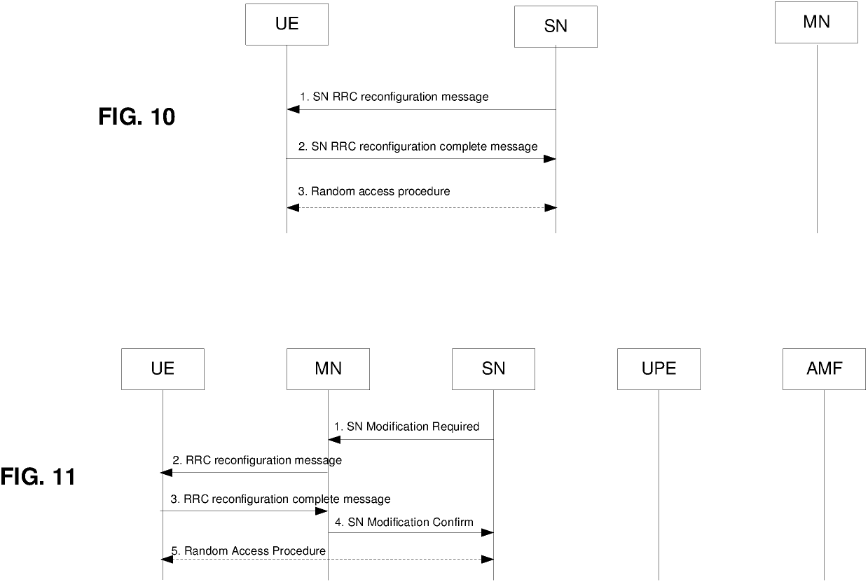

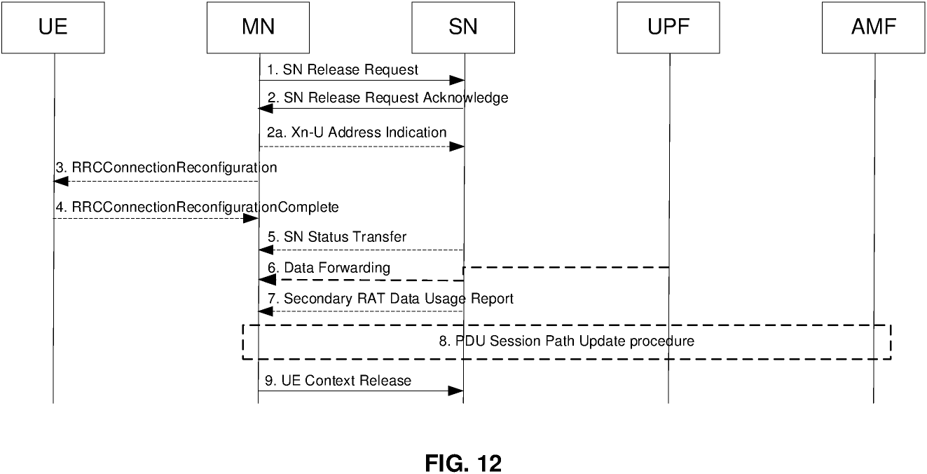

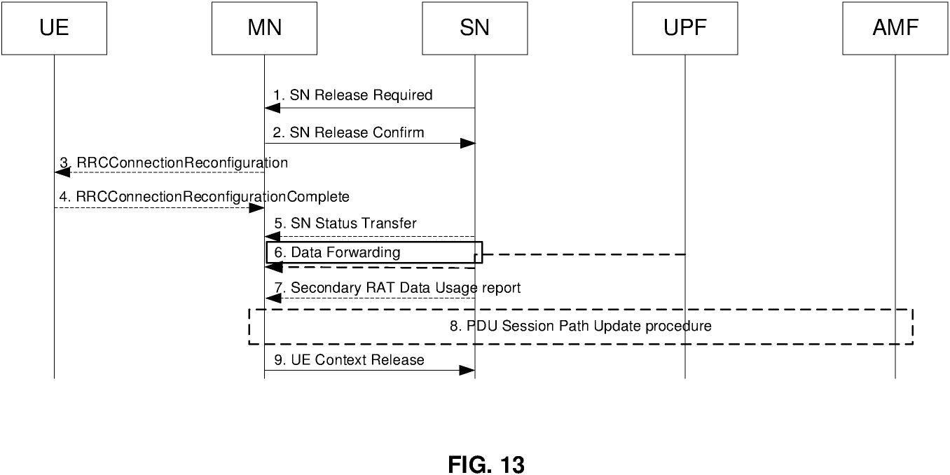

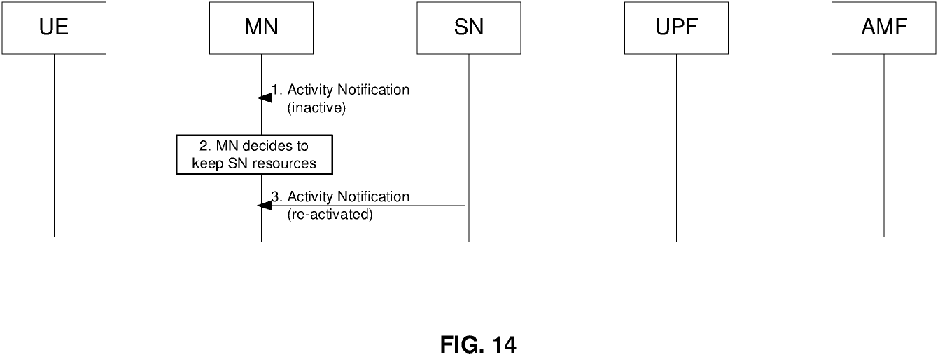

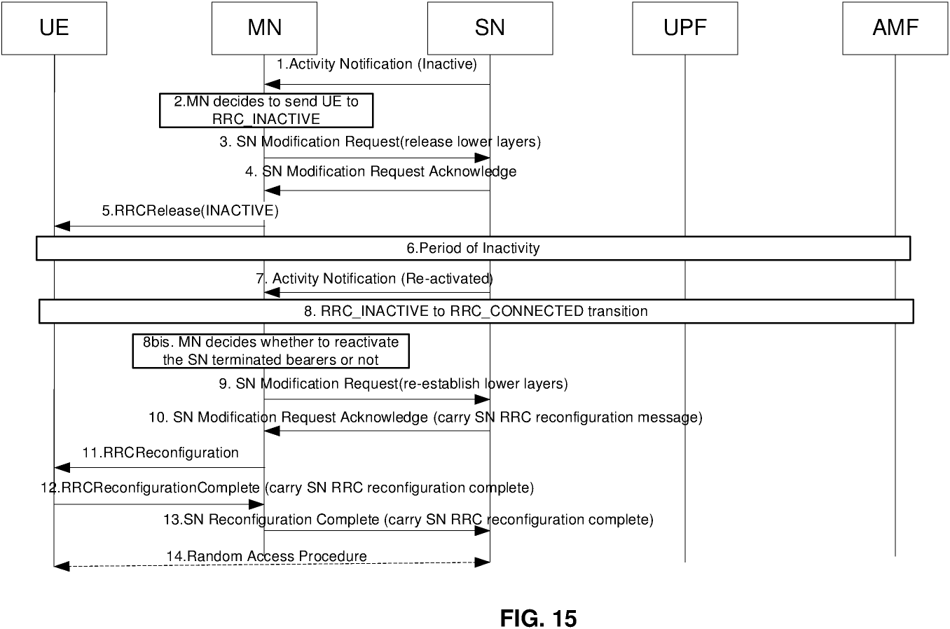

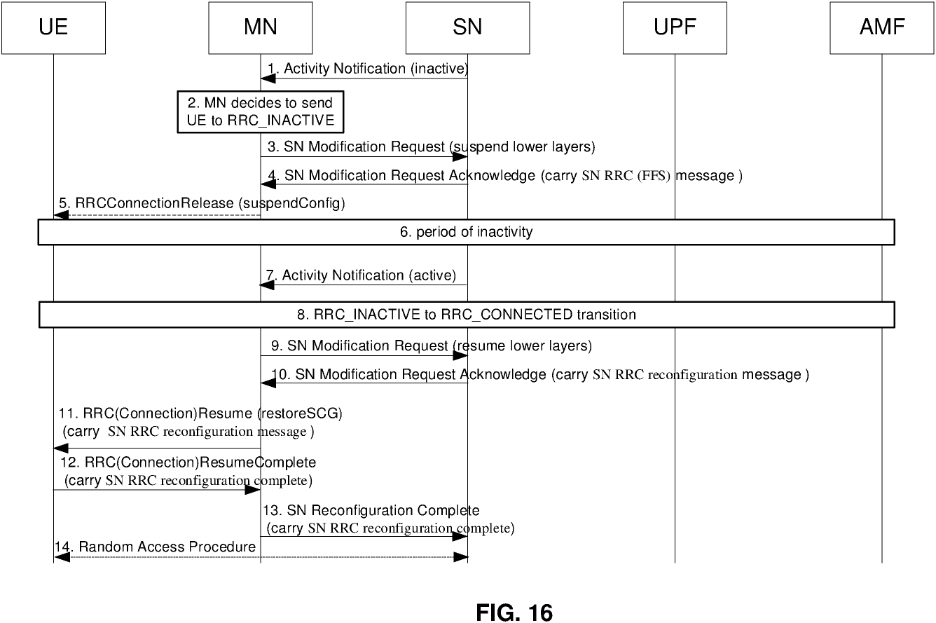

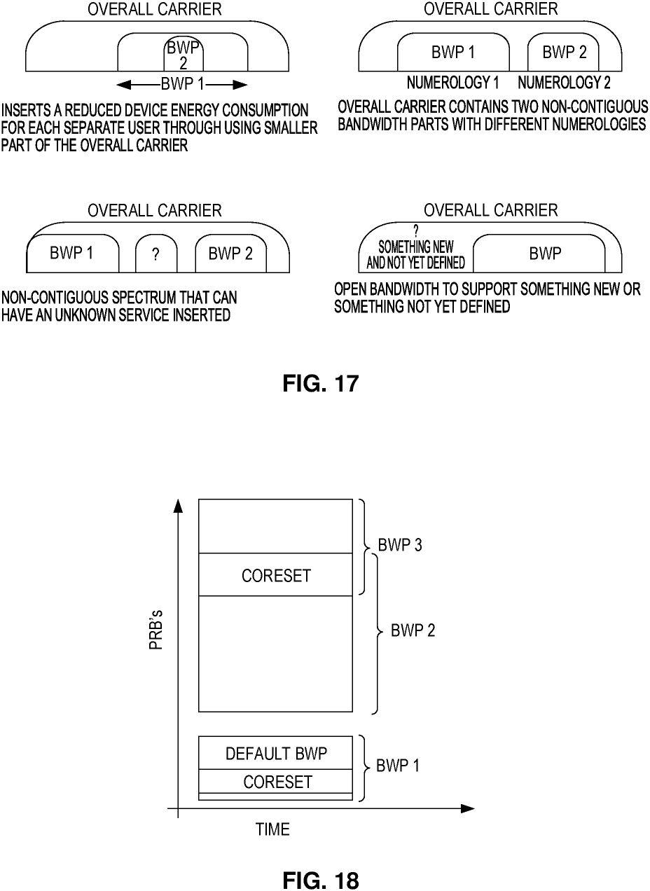

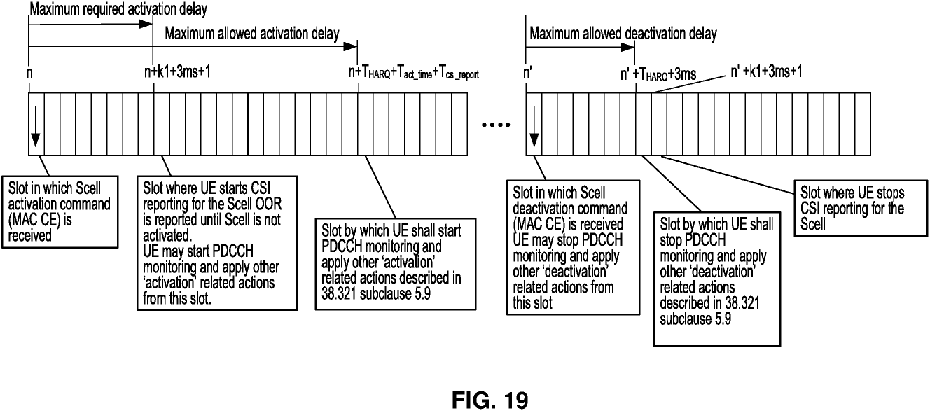

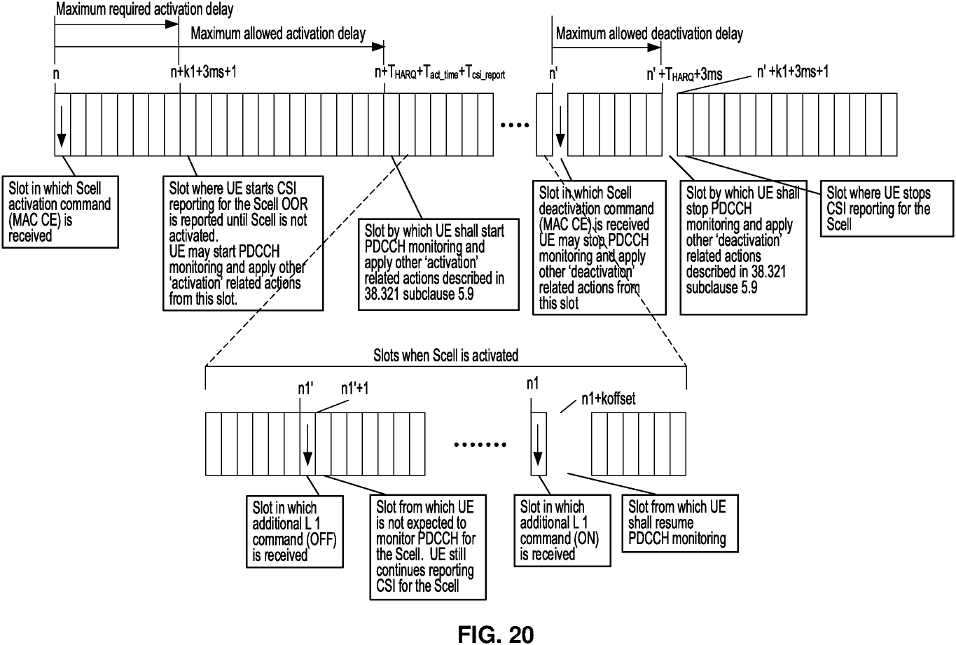

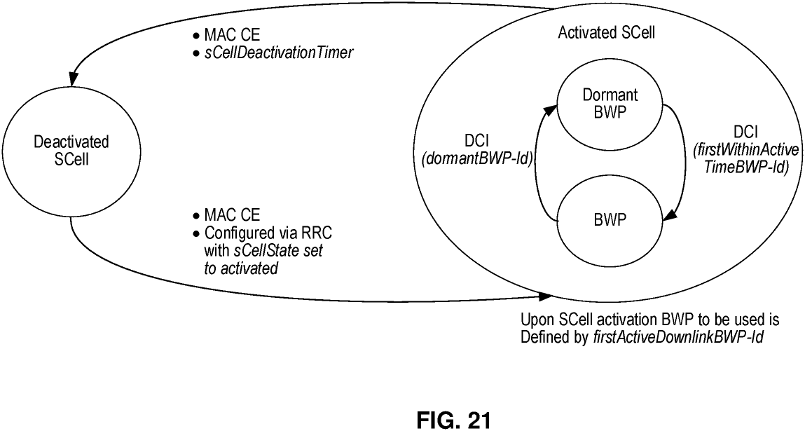

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Furthermore, the following terms are used throughout the description given below:
Radio Node: As used herein, a “radio node” can be either a “radio access node” or a “wireless device.”
Radio Access Node: As used herein, a “radio access node” (or equivalently “radio network node,” “radio access network node,” or “RAN node”) can be any node in a radio access network (RAN) of a cellular communications network that operates to wirelessly transmit and/or receive signals. Some examples of a radio access node include, but are not limited to, a base station (e.g., a New Radio (NR) base station (gNB/en-gNB) in a 3GPP Fifth Generation (5G) NR network or an enhanced or evolved Node B (eNB/ng-eNB) in a 3GPP LTE network), base station distributed components (e.g., CU and DU), base station control- and/or user-plane components (e.g., CU-CP, CU-UP), a high-power or macro base station, a low-power base station (e.g., micro, pico, femto, or home base station, or the like), an integrated access backhaul (IAB) node, a transmission point, a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a Packet Data Network Gateway (P-GW), an access and mobility management function (AMF), a session management function (AMF), a user plane function (UPF), a Service Capability Exposure Function (SCEF), or the like.
Wireless Device: As used herein, a “wireless device” (or “WD” for short) is any type of device that has access to (i.e., is served by) a cellular communications network by communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Some examples of a wireless device include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc. Unless otherwise noted, the term “wireless device” is used interchangeably herein with the term “user equipment” (or “UE” for short).
Network Node: As used herein, a “network node” is any node that is either part of the radio access network (e.g., a radio access node or equivalent name discussed above) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.

Note that the description herein focuses on a 3GPP cellular communications system and thus 3GPP terminology or terminology similar to 3GPP terminology is oftentimes used. However, the concepts disclosed herein are not limited to a 3GPP system. Furthermore, although the term “cell” is used herein, it should be understood that (particularly with respect to 5G NR) beams may be used instead of cells and, as such, concepts described herein apply equally to both cells and beams.

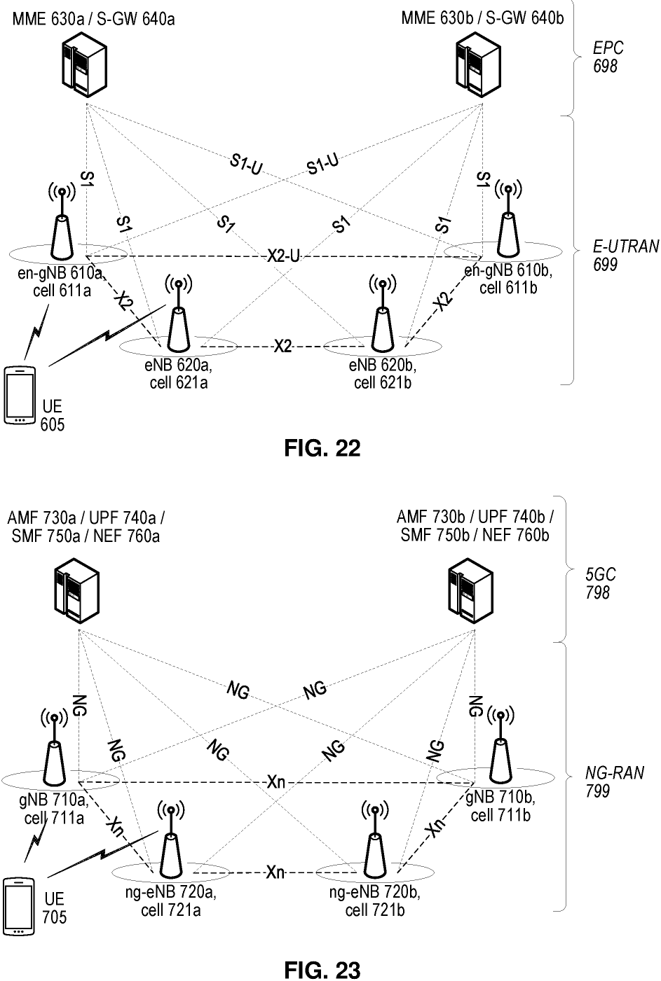

FIG. 22 shows a high-level view of an exemplary network architecture that supports EN-DC, including an E-UTRAN 699 and an EPC 698. As shown in the figure, E-UTRAN 699 can include en-gNBs 610 (e.g., 610a,b) and eNBs 620 (e.g., 620a,b) that are interconnected with each other via respective X2 (or X2-U) interfaces. The eNBs 620 connect to EPC 698 via an S1-U interface rather than to a 5GC via an X2 interface. The eNBs also connect to EPC 698 via an S1 interface. More specifically, en-gNBs 610 (e.g., 610a,b) and eNBs 620 (e.g., 620a,b) connect to MMEs (e.g., MMEs 630a,b) and S-GWs (e.g., S-GWs 640a,b) in EPC 698.

Each of the en-gNBs and eNBs can serve a geographic coverage area including one more cells, including cells 611a-b and 621a-b shown as exemplary in FIG. 22. Depending on the particular cell in which it is located, a UE 605 can communicate with the en-gNB or eNB serving that particular cell via the NR or LTE radio interface, respectively. In addition, UE 605 can be in EN-DC connectivity with a first cell served by an eNB and a second cell served by an en-gNB, such as cells 620a and 610a shown in FIG. 22.

FIG. 23 shows a high-level view of an exemplary network architecture that supports MR-DC configurations based on a 5GC. More specifically, FIG. 23 shows an NG-RAN 799 and a 5GC 798. NG-RAN 799 can include gNBs 710 (e.g., 710a,b) and ng-eNBs 720 (e.g., 720a,b) that are interconnected with each other via respective Xn interfaces. The gNBs and ng-eNBs are also connected via the NG interfaces to 5GC 798, more specifically to the AMF (Access and Mobility Management Function) 730 (e.g., AMFs 730a,b) via respective NG-C interfaces and to the UPF (User Plane Function) 740 (e.g., UPFs 740a,b) via respective NG-U interfaces. Moreover, the AMFs 730a,b can communicate with one or more session management functions (SMFs, e.g., SMFs 750a,b) and network exposure functions (NEFs, e.g., NEFs 760a,b).

Each of the gNBs 710 connect to 5GC 798 via an NG interface rather than to EPC via an S1 interface. Each of the gNBs and ng-eNBs can serve a geographic coverage area including one more cells, including cells 711a-b and 721a-b shown as exemplary in FIG. 23. The gNBs and ng-eNBs can also use various directional beams to provide coverage in the respective cells. Depending on the particular cell in which it is located, a UE 705 can communicate with the gNB or ng-eNB serving that particular cell via the NR or LTE radio interface, respectively. In addition, UE 705 can be in MR-DC connectivity with a first cell served by an ng-eNB and a second cell served by a gNB, such as cells 720a and 710a shown in FIG. 23.

The techniques described herein may be understood in the context of FIGS. 22 and 23 but are not necessarily limited to that context.

In dual connectivity, the UE can perform UL/DL transmissions/receptions towards a Master Node (MN) and/or Secondary Node (SN) (for data transmission/reception using the associated MCG and/or SCG radio links). In typical scenarios, the MCG can be considered to offer basic coverage and the SCG used to increase the data rate during data bursts. The UE needs to continuously monitor the PDCCH for uplink and downlink scheduling assignments at least on the PCell and the PSCell, and potentially all other SCells if cross carrier scheduling is not employed. Even if cross carrier scheduling is employed, the UE has to perform extra PDCCH monitoring on the PCell or the PSCell for the sake of the SCell, depending on whether the SCell belongs to the MCG or the SCG.

In order to improve network energy efficiency and UE battery life for UEs in MR-DC, a Rel-17 work item is planned to introduce efficient SCG/SCell activation/deactivation. This can be especially important for MR-DC configurations with NR SCG, as it has been evaluated in RP-190919 that in some cases NR UE power consumption is 3 to 4 times higher than LTE.

As discussed above, 3GPP has specified the concepts of dormant SCell (in LTE) and dormancy-like behavior of an SCell (for NR). However, only SCells can be put to put in dormant state (in LTE) or operate in dormancy-like behavior (NR). Also, only SCells can be put into the deactivated state in both LTE and NR. Thus, if the UE is configured with MR-DC, it is not possible to fully benefit from the power saving options of dormant state or dormancy-like behaviour as the PSCell cannot be configured with that feature. Instead, an existing solution could be releasing (for power savings) and adding (when traffic demands requires) the SCG on a need basis. However, traffic is likely to be bursty, and adding and releasing the SCG involves a significant amount of RRC signaling and inter-node messaging between the MN and the SN, which causes considerable delay.

In Rel-16, some discussions were made regarding putting also the PSCell in dormancy, or suspending it. Some preliminary agreements were made in RAN2-107bis, October 2019 (see chairman notes at R2-1914301):

R2 assumes the following (can be slightly modified due to progress on Scell dormancy):
The UE supports network-controlled suspension of the SCG in RRC_CONNECTED.
UE behaviour for a suspended SCG is FFS
The UE supports at most one SCG configuration, suspended or not suspended, in Rel16.
In RRC_CONNECTED upon addition of the SCG, the SCG can be either suspended or not suspended by configuration.

In RAN-2 108, further discussion was made to clarify the above “For Future Study” (FFS) item.

Some solutions have been proposed in Rel-16, but these have different problems. For example, R2-1908679 (Introducing suspension of SCG - Qualcomm) proposes that gNB can indicate UE to suspend SCG transmissions when no data traffic is expected to be sent in SCG so that UE keeps the SCG configuration but does not use it for power saving purpose. Therein, it is mentioned that signaling to suspend SCG could be based on DCI/MAC-CE/RRC signaling, but no details were provided regarding the configuration from the gNB to the UE. And, differently from the defined behavior for SCell(s), PSCell(s) may be associated to a different network node (e.g., a gNodeB operating as Secondary Node).

Although there seems to be a general consensus during the RAN2-107bis/RAN2-108 discussions that PDCCH monitoring on the PSCell is to be stopped when the SCG is suspended to get the main benefit in terms of UE power saving, the exact UE behavior on suspension, as well as during resumption has not been discussed.

Due to time limitation to carry out the required work in release 16, and no initial agreements on baseline behavior/signaling (see Chairman notes, R2-2000009), the work on SCG suspension or dormancy like behavior was postponed for Rel-17 or future releases.

In this document, several mechanisms are described to enable SCG suspension and activation/resume, including the basic UE and network behavior and required signaling (between network and UE, as well as between network nodes e.g., MN and SN).

More particularly, several mechanisms are described, to enable power efficient utilization of dual connectivity, where the SCG/PSCell can be suspended when not needed and activated with minimum delay when the dual connectivity feature is needed again. Several mechanisms/alternatives for handling SCG suspension and resumption are proposed, mainly covering:
different conditions for triggering SCG suspension and resumption,
suspension that is triggered by the MN or the SN,
resumption that is triggered by the MN or the SN, and
configurations/behavior the UE has to apply on SCG suspension and resumption.

Using these mechanisms, the SCG can be suspended/resumed on a need basis (e.g., suspended when there is not enough data to take advantage of dual connectivity, resumed when there is enough data, etc.), in an effective and fast way, thereby optimizing the UE as well as network’s power consumption.

In the document, the term suspending an SCG can correspond to any of the following:
The UE starting to operate the PSCell in dormancy, e.g., switching the PSCell to a dormant BWP). On the network side, the network considers the PSCell in dormancy and at least stops transmitting PDCCH for that UE in the PSCell(s);
Th UE deactivating the PSCell like SCell deactivation; On the network side, the network considers the PSCell as deactivated and at least stops transmitting PDCCH for that UE in the PSCell;
The UE suspending its operation with the SCG (e.g., suspending bearers associated with the SCG, like SCG MN-/SN-terminated bearers), but keeping the SCG configuration stored (referred to as Stored SCG); On the network side there can be different alternatives such as the SN storing the SCG as the UE does, or the SN releasing the SCG context of the UE to be generated again upon resume (e.g., with the support from the MN that is the node storing the SCG context for that UE whose SCG is suspended). More details are provided later.

The document may also use the term suspended SCG, SCG suspended, or, when referring to the action of transitioning to suspended SCG, it may use suspending the SCG.

In the document, the term resuming an SCG can correspond to any of the following:
The UE transitioning the PSCell from dormancy like behavior to normal active cell behavior (e.g., by switching the PSCell to a non-dormant BWP), and at least starting to monitor PDCCH of one of the cells of the SCG; This transition could be triggered e.g., by network signaling;
The UE activating the PSCell and at least starting to monitor PDCCH of one of the cells of the SCG. This transition could be triggered, e.g., by network signaling;
The UE restoring the stored SCG configuration and start operating according to the SCG configuration that is resumed (e.g., resumption of SCG bearers);
The UE restoring the stored SCG configuration and receiving a message with an SCG configuration (e.g., delta signaling) to be applied on top of the stored SCG configuration that is restored.

The document may also use the term resumed SCG, SCG resume, or, when referring to the action of transitioning to active/resumed SCG, it may use resuming the SCG.

In most of the descriptions of the detailed embodiments below, the request to suspend/resume the SCG (whether it is MN triggered or SN triggered) is accepted/ACKed by the other node (SN, if it was MN triggered; MN, if it was SN triggered). However, the method also comprises the procedure where the requests are rejected e.g., if the MN wants to resume the SCG, but SN maybe not have the required radio resources at that point in time to accommodate the UE. In these rejected cases, according to the method, the UE may receive an indication from the network (e.g., an RRC Reconfiguration message with an MR-DC release indication) indicating that the SCG remains suspended or the SCG has to be released. Notice that according to the method, the UE can receive an indication to release a stored SCG due to other reasons the network may find suitable e.g., an expiry of a timer on the network side (wherein the timer is defined to determine for how long is it worth storing the SCG context instead of releasing it).

This document describes a UE that is MR-DC capable, i.e., a UE that can be configured with a Master Cell Group (MCG), associated to a network node operating as Master Node (MN), and a Secondary Cell Group (SCG), associated to a network node operating as Secondary Node (SN). According to various techniques described herein, the network node operating as MN can be a gNodeB (of NR technology) or an eNodeB (LTE node connected to EPC), or an ng-eNodeB (LTE node connected to 5GC). And, the network node operating as SN can be a gNodeB (of NR technology) or an eNodeB, or an ng-eNodeB. A possible combination can be both MN and SN being gNodeB(s) and in that case both MCG and SCG have configured NR cells. Another possible combination can be an MN being an eNodeB and SN being gNodeB(s) and in that case the MCG have configured LTE cells, while the SCG have configured NR cells, so the UE is configured with inter-RAT Dual Connectivity. Even if we have used LTE and NR as different RATs, this should be interpreted as examples, so the method is applicable for inter-RAT Dual Connectivity with any two different RATs. Or, in an intra-RAT manner.

The events/conditions that lead to the triggering of the suspension or resumption of the SCG according to various embodiments are discussed below. Also described is the signaling between the UE and the network (MN or SN), as well as between the MN and SN, to suspend/resume the SCG. UE/network behavior while SCG is suspended and also on transitioning from normal operation to suspended SCG and from suspended SCG back to normal operation is also described.

### Events/Conditions Leading to SCG Suspension and Resumption

In one set of embodiments, the network (e.g., a network node operating as MN, or a network node operating as SN) that determines that the SCG configured at UE operating in MR-DC is to be suspended. The network could decide to suspend the SCG at least due to one of the following reasons (or any combination of these reasons):
detecting an UL/DL inactivity concerning the SCG;
   that inactivity may be controlled by a timer associated to a data buffer;
      In one option that timer is started when a data buffer associated to the SCG is emptied (i.e., data is delivered via SCG), timer is stopped when data arrives in an empty SCG buffer, and upon timer expiry the network considers the detection of an UL/DL inactivity concerning the SCG and perform actions upon (e.g., suspension of the SCG at the UE). In that solution, the timer could be controlled at the entity controlling the SCG e.g., SN, so that the detection of inactivity concerning the SCG is determined at the SN. And, it would be the SN indicating to the MN that the SCG is to be suspended (SN-initiated suspension in this example), at least from the SN’s perspective. One advantage of controlling the timer at the entity controlling the SCG is that the buffer can be associated to all kinds of bearers that are associated to the SCG, e.g., both SN-/MN-terminated SCG bearers and split bearers.
      In another option, one timer is defined per bearer associated to the SCG/ SN. In this option, that timer is started when a data buffer associated to a particular SCG bearer is emptied (i.e., data is delivered via SCG), timer is stopped when data arrives in an empty buffer associated to an SCG bearer, and upon timer expiry the network considers the detection of an UL/DL inactivity concerning the SCG bearers; In this option, SCG inactive is determined when all timers associated to all SCG bearers are expired. One advantage of defining the timer per bearer associated with the SCG is that each node can determine the inactivity of its own bearers e.g., a MN can determine when an MN-terminated bearer is inactive, a SN can determine when an SN-terminated bearer is inactive; And, SCG is considered inactive when all SCG bearers are inactive. This option comprises each node indicating to each other the inactivity of an SCG bearer.
Detection of overload of the SN
   If the SN is overloaded and UE is not being scheduled as needed, one way is to do SN/PScell change, however, there may not be any available suitable candidate SN at that point. A good alternative in that case could thus be to pause the SN, and use the MN until a favorable load indication is received from the SN
Detection of low load of the MN
   If the MN becomes underloaded and the UE has a very good link to the MN, probably would be better to do all communication via the MN
Detection of low total UL/DL throughput for a certain duration (i.e., Active DC usage may not be justified).

With respect to resumption, in various embodiments the network may decide to resume the SCG (e.g., transition the SCG from stored SCG to normal operation with resumed SCG bearers, etc.). The network could decide to resume the SCG due to at least one of the following (or any combination of these):
detecting an UL/DL activity concerning the SCG (e.g., activity notification from the SN about an SN terminated and/or SCG bearer while the SCG is suspended);
Lower load indication from the SN while SCG was suspended
Overload of the MN while SCG was suspended
Increase in UE throughput or UL /DL buffered data.

### Signaling Aspects

The MN may decide to trigger the SCG suspension at a UE configured with MR-DC at least based on one or more of the triggering conditions described above. In a first alternative approach to the related signaling, referred to here as “alternative S1,” The MN sends a request to the SN to suspend the SCG associated with the UE, and once the SN has accepted that request (i.e., an Acknowledgement message received from the SN), the MN sends the command to the UE to suspend the SCG. In one option that leads to the UE sending an indication of a Suspend SCG complete (e.g., an RRC Reconfiguration complete message, or network considers ACK/NACKs as a way to acknowledge the successful reception at the UE). One advantage of this option is that scheduling of data for all SCG bearers is controlled at the SN, so that the SN has a good perspective of the traffic demands on the SCG but also its own load/resource situation for any bearer. In other words, this alternative could be suitable for a suspended SCG regarding MN-terminated, SN-terminated and split bearers.

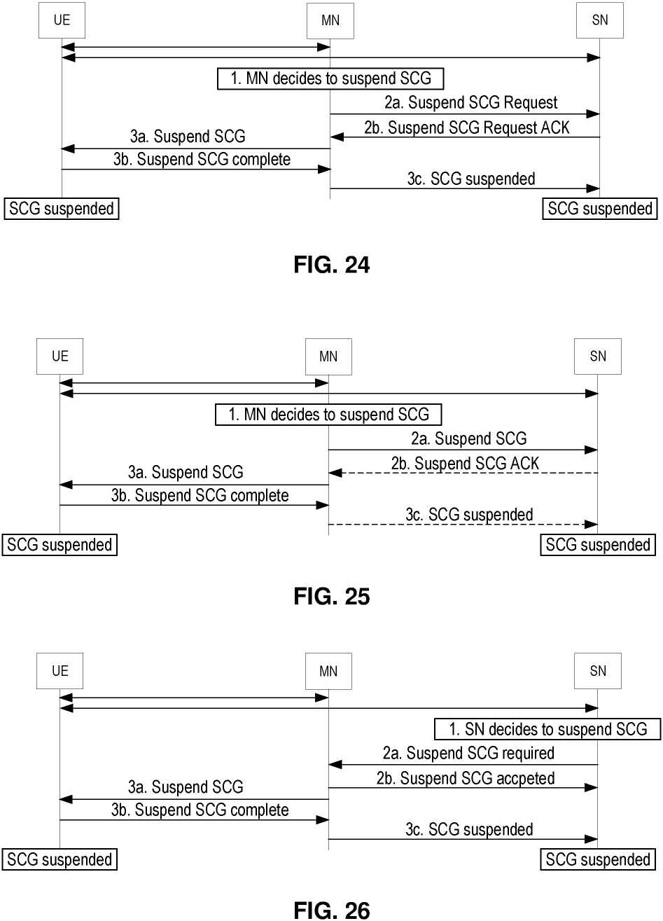

Alternative S1 is illustrated in FIG. 24, which shows MN-triggered SCG suspension, with SN involvement.

In a second alternative approach, referred to here as “alternative S2,” the MN makes the decision to suspend the SC and sends the command to the SN to suspend the SCG associated with the UE, either before/in-parallel/after sending the command to the UE to start operating the SCG in power saving mode. One advantage of this option is that the UE may get the command to suspend the SCG (3a:) more quickly than in than the previous alternative, especially if the ACK 2b: is not mandatory to be received before the transmission of 3a. That alternative can be suitable in case all SCG bearers are either MN-terminated SCG bearer or MN-terminated split ti The suspend SCG request (message 2a) in alternative S1 and suspend SCG (message 2a) in alternative S2 can be new messages or enhanced version (e.g., including a new IE/field/indication of an SCG suspension or SCG suspension request) of the following X2/Xn messages:
S-node modification request (Xn)
SgNB modification request (X2)
S-node release request (Xn)
SgNB release request (X2).

The suspend SCG request ACK (message 2b) in alternative S1 and suspend SCG ACK (message 2b) in alternative S2 can be new messages or enhanced version of the following X2/Xn messages:
S-node modification request acknowledge (Xn)
SgNB modification request acknowledge (X2)
S-node release request acknowledge (Xn)
SgNB release request acknowledge (X2)

The suspend SCG (message 3a) in alternative S1 and alternative S2 can be any of:
a RRC Reconfiguration message including an indication that the SCG is to be suspended;
   In one option, that indication is part of the SCG configuration;
   In one option, that indication is part of the MN/MCG related configuration e.g., in case it is the MN determining the suspension of the SCG this option may makes more sense, as these are configurations generated by the MN;
a RRC Release message including an indication that the SCG is to be suspended;
   In one option, that indication is part of the suspendConfig;
a MAC control element for indicating that the SCG is to be suspended;
   In one option, that MAC CE is transmitted via the MCG;
   In one option, that MAC CE is transmitted via the SCG;
   In one option, that MAC CE can either be transmitted via the MCG or the SCG;
downlink control information (DCI)
   In one option, that DCI is transmitted via the MCG;
   In one option, that DCI is transmitted via the SCG;
   In one option, that DCI can either be transmitted via the MCG or the SCG;

If RRC reconfiguration message is employed for message 3a, then message 3b is an RRC Reconfiguration Complete message.

If MAC CE or DCI is employed for message 3a, then there are several possibilities for message 3b:
message 3b is optional
messages 3b is the lower layer (e.g., MAC level) ACK that indicates the message has been properly received and applied by the UE,

The SCG suspended (3c) message in alternative S1 and alternative S2 can be new messages or enhanced version of the following X2/Xn messages:
S-node reconfiguration complete (Xn) if message 2a was S-node modification request
SgNB reconfiguration complete (X2)if message 2a was SgNB modification request
UE context release (X2/Xn)if message 2a was S-node/SgNB release request

MN-triggered SCG suspensions were described above. The SN may also decide to trigger the SCG suspension at a UE configured with MR-DC, at least based on one or more of the triggering conditions described above.

In one approach to the signaling, referred to here as “alternative S3,” the SN sends a request to the MN to get the permission to suspend the SCG associated with the UE, and once the MN has accepted that request, the SN sends the command to the UE. There are a number of “sub-alternatives,” illustrated in FIG. 26, FIG. 27, FIG. 28, and FIG. 29. In some cases, the SN sends the command to the UE via the MN (e.g., RRC signaling used and no SRB3 is available, so the SCG suspend command could be included in a container inside message 2b), and in other cases the SN sends the command to the UE directly (e.g., RRC signaling used and SRB3 available, or MAC CE or DCI signaling used). In case SRB3 is available, then there are two further alternatives. UE can send the complete message via SRB3 to the SN, and then suspends the SCG. Alternatively, UE suspends the SCG and sends the complete message to the MN, which forwards it to the SN. The suspension of the SCG directly by the SN (e.g., via SRB3 or MAC CE) may be beneficial in terms of signaling reductions and latency due to the reduced amount of inter-node signaling, which could work especially for the case only SN terminated bearers are associated to the SCG. Even though these are described as sub-alternatives, it is worth mentioning that they could all be supported and used depending on availability of SRB3, what kinds of SCG-related bearers are configured, etc.

Thus, FIG. 26 illustrates SN-triggered SCG suspension, with MN involvement, using RRC signaling, but no SRB3. FIG. 27 illustrates SN-triggered SCG suspension, with MN involvement, using RRC signaling, with SRB3 used for both the suspend SCG and the complete message. FIG. 28 illustrates SN-triggered SCG suspension, with MN involvement, using RRC signaling, with SRB3 used for suspend SCG and SRB1 used for the complete message. Finally, FIG. 29 illustrates SN-triggered SCG suspension, with MN involvement, using MAC CE/DCI.

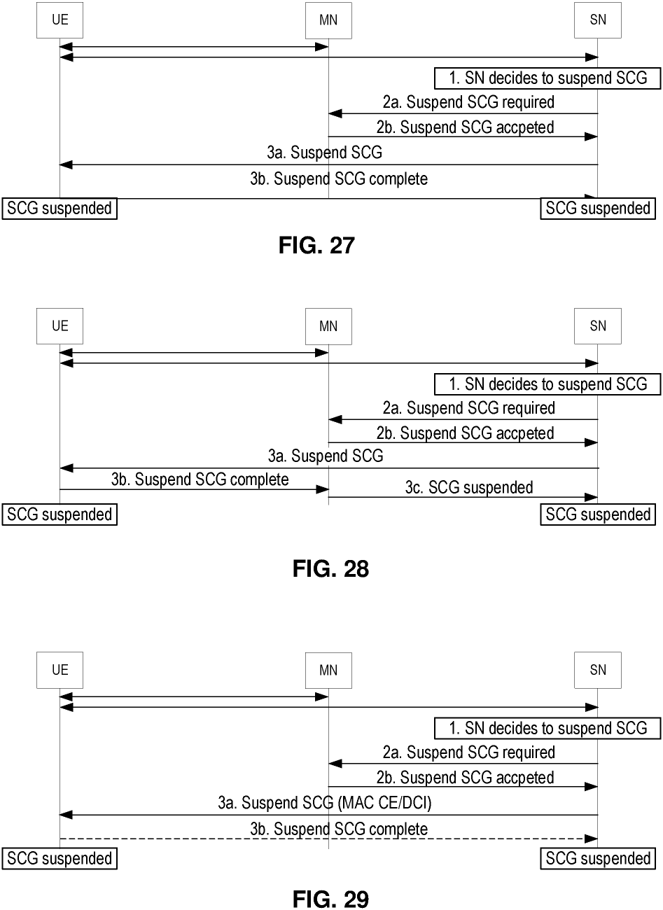

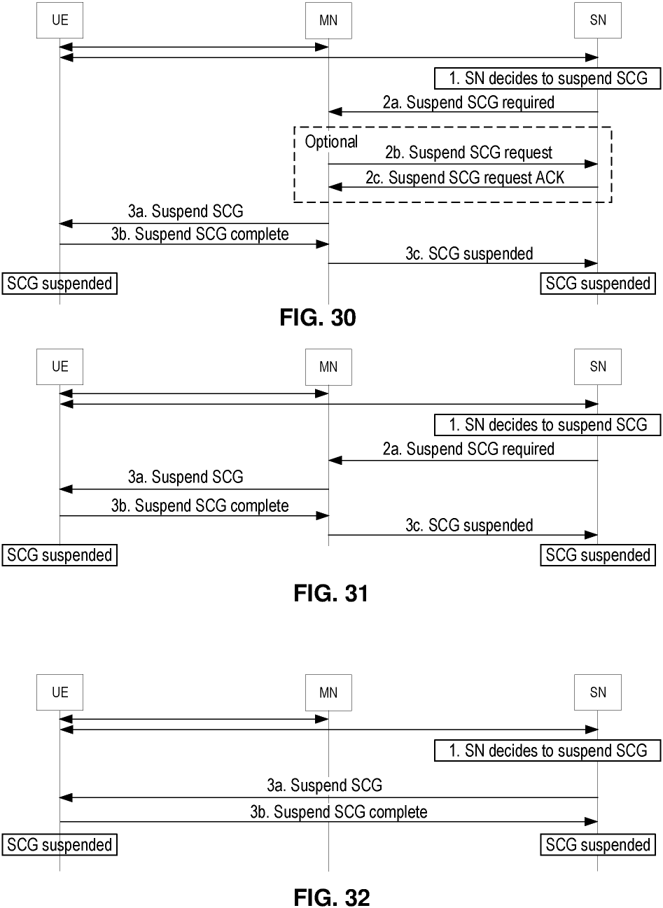

In all the above SN-triggered cases, instead of just accepting the request from the SN, the MN may re-negotiate the suspension procedure. For example, the SN may send a Suspend SCG required to the MN that indicates the SN wants to send the SCG into a stored-SCG suspension, the MN may respond with the Suspend SCG request message indicating that it wants the SN to apply a dormancy like behavior instead. The MN may also accept the stored-SCG suspension, but may want some of the SCG configuration to be changed before the SCG gets suspended. The MN may even respond with a message indicating that it wants the release of the SCG. FIG. 30 illustrates one such example, where the MN re-negotiates the SCG suspension.

In another alternative, referred to here as “alternative S4,” the SN makes the decision to suspend the SCG associated with the UE and informs the MN about its decision (i.e., no acceptance from the MN is required. In this option, the SN is the one determining the suspension of the SCG). As with alternative S3, there could be several subvariants of this alternative, depending on whether RRC (SRB3 or SRB1) or MAC CE/DCI based signaling is used. For the sake of brevity, only two examples are illustrated. FIG. 31 illustrates SN-triggered SCG suspension, without MN involvement, using RRC signaling, with no SRB3. FIG. 32 illustrates a similar scenario, but with SRB3.

The suspend SCG required (message 2a) in alternative S3 and alternative S4 can be new messages or enhanced version (e.g., including a new IE/field/indication of an SCG suspension or SCG suspension request) of the following X2/Xn messages:
S-node modification required (Xn)
SgNB modification required (X2)
Activity notification (Xn) (indicating inactivity)
SgNB activity notification (X2) (indicating inactivity)
S-node release required (Xn)
SgNB release required (X2).

The suspend SCG accepted (message 2b) in alternative S3 can be a new x2/xn message or an enhanced version of the S-node/SgNB release confirm Xn/X2 messages that includes an indication that the SCG is to be suspended.

The suspend SCG (message 3a) in alternative S3 and alternative S4 can be an:
RRC Reconfiguration message including an indication that the SCG is to be suspended;
   In one option, that indication is part of the SCG configuration;
   In one option, that indication is part of the MN/MCG related configuration e.g., in case it is the MN determining the suspension of the SCG this option may makes more sense, as these are configurations generated by the MN;
RRC Release message including an indication that the SCG is to be suspended;
   In one option, that indication is part of the suspendConfig;
MAC control element for indicating that the SCG is to be suspended;
   In one option, that MAC CE is transmitted via the MCG;
   In one option, that MAC CE is transmitted via the SCG;
   In one option, that MAC CE can either be transmitted via the MCG or the SCG;
DCI
   In one option, that DCI is transmitted via the MCG;
   In one option, that DCI is transmitted via the SCG;
   In one option, that DCI can either be transmitted via the MCG or the SCG.

If RRC reconfiguration message is employed for message 3a, then message 3b is an RRC Reconfiguration Complete message.

If MAC CE or DCI is employed for message 3a, then there are several possibilities for message 3b:
message 3b is optional
messages 3b is the lower layer (e.g., MAC level) ACK that indicates the message has been properly received and applied by the UE.

The SCG suspended (3c) message in alternative S3 and alternative S4 can be new messages or enhanced version of the following X2/Xn messages:
S-node reconfiguration complete (Xn) if message 2a was S-node modification required
SgNB reconfiguration complete (X2)- if message 2a was SgNB modification required
UE context release (X2/Xn)if message 2a was S-node/SgNB release required.

The different signaling examples/alternatives disclosed in this section for SCG suspension are not mutually exclusive, i.e., there can be alternatives where combinations of these options are defined such as an SCG suspension triggered by the SN and an SCG suspension triggered by the MN.

Described above were techniques for SCG suspension. Related techniques for resumption of a suspended SCG are described below.

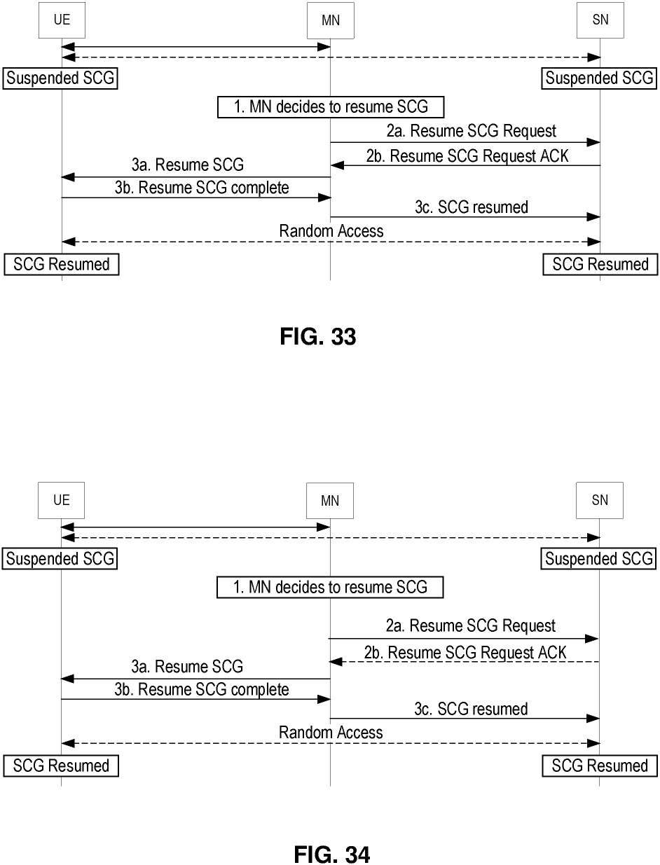

The MN may decide to trigger the resumption of a suspended SCG based on one or more of the triggering conditions described above. A first alternative approach to the signaling is referred to here as “alternative R1.” An example signaling flow according to this approach is shown in FIG. 33. According to this alternative R1, the MN sends a request to the SN to resume the SCG associated with the UE, and once the SN has accepted that request (i.e., an Acknowledgement message received from the SN), the MN sends the command to the UE. The message 2b: may contain an SCG configuration that indicates to the UE that the SCG is to be resume and an SCG configuration (e.g., an RRCReconfiguration in SCG format) to be applied on top of UE’s restored SCG configuration. One advantage of waiting for 2b: before resuming the SCG at the UE is that the MN can make sure that the SN can resume the UE in the SCG.

Another alternative, referred to here as “alternative R2,” is illustrated in FIG. 34. In this approach, the MN makes the decision to resume the SCG, and sends the command to the SN to suspend the SCG associated with the UE, either before/in-parallel/after sending the command to the UE to start operating the SCG in power saving mode. One advantage here is that the SCG resume procedure is faster than in alternative R1. The assumption in this option is that if the SN has accepted the suspension of the SCG, and it has not requested its release before the MN requests the resume, the SN is capable to cope with the procedure i.e., it should be fine to send 3a: before receiving 2b.

The resume SCG request (message 2a) in alternative R1 and resume SCG (message 2a) in alternative R2 can be new messages or enhanced version of the following X2/Xn messages (possibly including a new indication that this is for resuming the SCG):
S-node modification request (Xn)
SgNB modification request (X2)
S-node addition request (Xn)SgNB addition request (X2) In one option, the MN may include in the message the UE SCG context/configuration (that is also stored at the UE and that has been stored at the MN upon the suspension of the UE’s SCG). The SN may respond with an SCG configuration that is a delta signaling from the one provided by the MN (i.e., on top of the UE’s stored SCG configuration) that is to be applied on top of the stored SCG on SCG resume.
In another option, the MN may include in the message an identifier of the UE’s SCG context (that is also stored at the UE and that has been stored at the SN upon the suspension of the UE’s SCG). By providing that to the SN, the SN can identify the UE context, and respond with an SCG configuration that is a delta signaling on top of the UE’s stored SCG configuration that is to be applied upon SCG resume. The context identifier could be a UE X2/XN identifier, a C-RNTI that was assigned to the UE before the SCG was suspended.

The resume SCG request ACK (message 2b) in alternative R1 and resume SCG ACK (message 2b) in alternative R2 can be new messages or enhanced version of the following X2/Xn messages (possibly including a new indication that this is for resuming the SCG):
S-node modification request acknowledge (Xn)
SgNB modification request acknowledge (X2)
S-node addition request acknowledge (Xn)
SgNB addition request acknowledge (X2).

The resume SCG (message 3a) in alternative R1 and alternative R2 can be an:
RRC Reconfiguration message including an indication that the SCG is to be resumed;
   In one option, that indication is part of the SCG configuration;
   In one option, that indication is part of the MN/MCG related configuration e.g., in case it is the MN determining the resumption of the SCG this option may makes more sense, as these are configurations generated by the MN;
RRC Resume like message including an indication that the SCG is to be resumed;
MAC control element for indicating that the SCG is to be resumed;
   In one option, that MAC CE is transmitted via the MCG;
   In one option, that MAC CE is transmitted via the SCG (during pre-determined periods wherein the UE shall monitor the SCG PDCCH, tough with long DRX cycle);
   In one option, that MAC CE can either be transmitted via the MCG or the SCG;
DCI
   In one option, that DCI is transmitted via the MCG;
   In one option, that DCI is transmitted via the SCG (during pre-determined periods wherein the UE shall monitor the SCG PDCCH, tough with long DRX cycle);
   In one option, that DCI can either be transmitted via the MCG or the SCG (during pre-determined periods wherein the UE shall monitor the SCG PDCCH, e.g., a short onDuration within a long DRX cycle).

If RRC reconfiguration message is employed for message 3a, then message 3b is an RRC Reconfiguration Complete message. If the RRC resume like message is employed for message 3a, then message 3b is an RRC Resume Complete like message.

If MAC CE or DCI is employed for message 3a, then there are several possibilities for message 3b:
message 3b is optional
messages 3b is the lower layer (e.g., MAC level) ACK that indicates the message has been properly received and applied by the UE.

The SCG resumed (3c) message in alternative R1 and alternative R2 can be new messages or enhanced version of the following X2/Xn messages:
S-node reconfiguration complete (Xn) if message 2a was S-node modification request or S-node addition request
SgNB reconfiguration complete (X2)if message 2a was SgNB modification request or SgNB addition request.

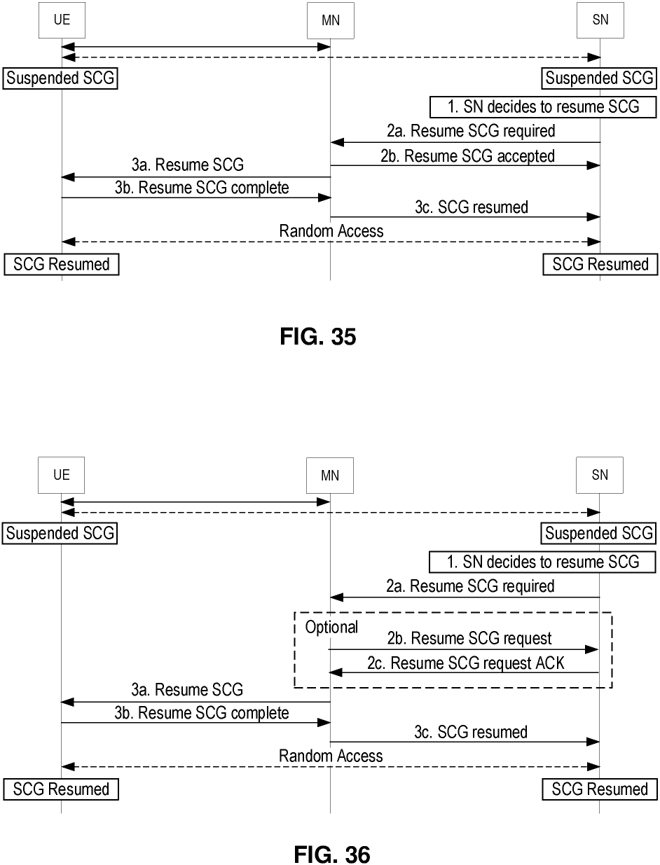

Alternatives R1 and R2 involve MN-triggered resumption. The SN may also decide to trigger the resumption of a suspended SCG based on one or more of the triggering conditions described above. In a first SN-triggered approach, referred to here as alternative R3 and illustrated in FIG. 35, the SN sends a request to the MN to get the permission to resume the SCG associated with the UE, and once the MN has accepted that request, the MN sends the command to the UE. The command in 3a: may contain additional SCG configuration that could have been provided in 2a: from the SN (e.g., delta configuration to be applied on top of UE’s restored/current SCG configuration). One advantage of this option is that the SN can monitor the incoming data of possibly configured SN terminated bearers and indicate the need to resume the SCG to the MN. Another advantage is that as the MN can send 3a: after 2a: thus, the UE can be resumed quite fast. Thanks to message 2b:, SN can get prepared for the SCG resumption, even before it receives the message 3c: confirming that the UE has received and successfully applied the SCG resume indication, including possibly applying the delta SCG configurations, if that was included in 2a (and forwarded to the UE in 3a).

FIG. 35 illustrates an example signaling according to alternative R3, with MN involvement and RRC signaling. FIG. 36 shows another example, with MN negotiation. Instead of just accepting the request from the SN, the MN may re-negotiate the resumption procedure. For example, the SN may send a resume SCG required to the MN that indicates the SN wants to reconfigure the SCG in a certain way upon resumption, the MN may respond with a different recommendation for the SCG configuration.

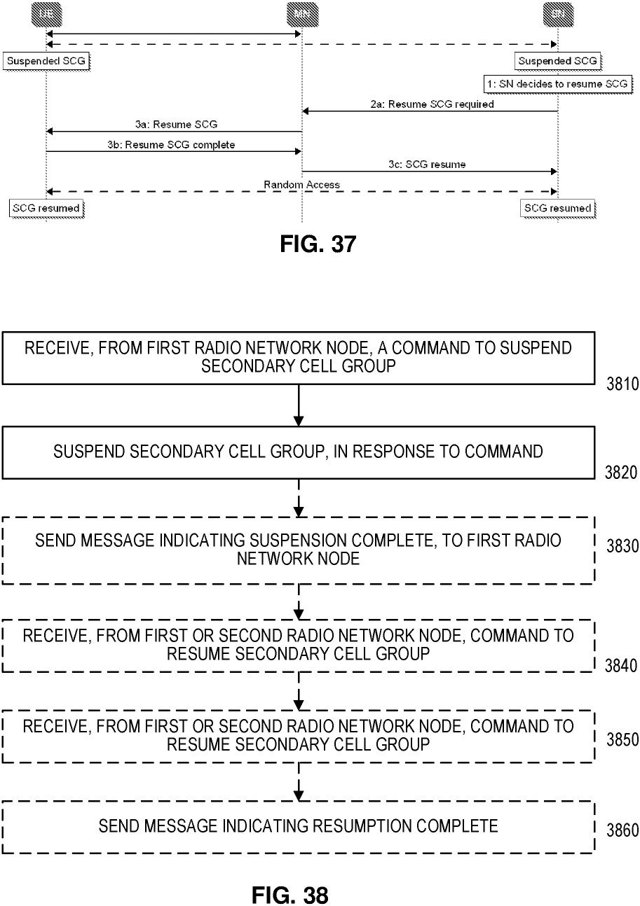

In another alternative approach, referred to here as “alternative R4,” the SN makes the decision to suspend the SCG associated with the UE and informs the MN about its decision (i.e., no acceptance from the MN is required). As with alternative 4, there could be several subvariants of this alternative, depending on whether RRC (SRB3 or SRB1) or MAC CE/DCI based signaling is used. For the sake of brevity, only one example is illustrated. FIG. 37 shows an example of SN-triggered SCG resumption, without MN involvement, using RRC signaling, with no SRB3. Note that other variations like those described above for alternative 3 are also possible - the difference being that there won’t be a message 2b like in those alternatives.

The resume SCG required (message 2a) in alternative R3 and alternative R4 can be new messages or enhanced version of the following X2/Xn messages:
S-node modification required (Xn)
SgNB modification required (X2)
Activity notification (Xn) (indicating activity)
SgNB activity notification (X2) (indicating activity).

The resume SCG accepted (message 2b) in alternative R3 can be a new x2/xn message or an enhanced version of the S-node/SgNB release confirm Xn/X2 messages.

The resume SCG (message 3a) in alternative S3 and alternative S4 can be an:
RRC Reconfiguration message including an indication that the SCG is to be resumed;
   In one option, that indication is part of the SCG configuration;
   In one option, that indication is part of the MN/MCG related configuration e.g., in case it is the MN determining the resumption of the SCG this option may makes more sense, as these are configurations generated by the MN;
RRC Resume like message including an indication that the SCG is to be resumed;
MAC control element for indicating that the SCG is to be resumed;
   In one option, that MAC CE is transmitted via the MCG;
   In one option, that MAC CE is transmitted via the SCG (during pre-determined periods wherein the UE shall monitor the SCG PDCCH, tough with long DRX cycle);
   In one option, that MAC CE can either be transmitted via the MCG or the SCG;
DCI
   In one option, that DCI is transmitted via the MCG;
   In one option, that DCI is transmitted via the SCG (during pre-determined periods wherein the UE shall monitor the SCG PDCCH, tough with long DRX cycle);
   In one option, that DCI can either be transmitted via the MCG or the SCG (during pre-determined periods wherein the UE shall monitor the SCG PDCCH, tough with long DRX cycle).

If RRC reconfiguration message is employed for message 3a, then message 3b is an RRC Reconfiguration Complete message.

If MAC CE or DCI is employed for message 3a, then there are several possibilities for message 3b:
message 3b is optional
messages 3b is the lower layer (e.g., MAC level) ACK that indicates the message has been properly received and applied by the UE.

The SCG resumed (3c) message in alternative S3 and alternative S4 can be new messages or enhanced version of the following X2/Xn messages:
S-node reconfiguration complete (Xn) if message 2a was S-node modification required
SgNB reconfiguration complete (X2)if message 2a was SgNB modification required.

The different alternatives for suspending and resuming an SCG described above can be combined. For example, the SCG suspension can be triggered by the MN while the resumption is triggered by the SN, or vice versa. Also, the signaling mechanism used for suspension (e.g., RRC, MAC CE, DCI) does not have to be the same as the signaling mechanism used for resumption. For example, suspension can be triggered by the SN and signaled to the UE via a MAC CE from the SN, while resumption can be triggered by the MN and signaled to the UE via an RRC message from the MN.

In the different signaling alternatives and messages described in the previous sections, even if existing RRC/x2/xn messages are employed, extra information may be needed for configuring the UE or the SN during the suspension/resumption of the SCG. Some examples are given below.

Suspend SCG Request:
The type of the suspension to be applied (e.g., dormancy like behavior for the PSCell, PSCell deactivation, stored SCG)
Whether the SN keeps the lower layer resources/configuration/context
   Keep everything
   Release everything
   Keep a subset of the lower layer resources (e.g., PSCell C-RNTI)
Whether the SN needs to keep the upper layer resources (e.g., PDCP, SDAP, etc)
Bearer Modification/release
   E.g., SN terminated bearers changed to MN terminated bearers, SN terminated split bearers changed to SN terminated MCG bearers, etc.

Suspend SCG Request ACK:
That may include configuration for the UE concerning the SCG that is to be used while the UE is operating in SCG suspend, if the UE does not completely stop actions regarding the SCG.

Suspend SCG (RRC Reconfiguration to UE to suspend the SCG):
The type of the suspension to be applied (e.g., dormancy like behavior for the PSCell, PSCell deactivation, stored SCG)
Bearer Modification/release
   E.g., SN terminated bearers changed to MN terminated bearers, SN terminated split bearers changed to SN terminated MCG bearers, UL buffer thresholds for split bearers changed, etc.

Suspend SCG Required:
The type of the suspension to be applied (e.g., dormancy like behavior for the PSCell, PSCell deactivation, stored SCG)
Whether the SN needs to keep the lower layer resources/configuration/context
   Keep everything
   Release everything
   Keep a subset of the lower layer resources (e.g., PSCell C-RNTI)
Whether the SN keeps the upper layer resources (e.g., PDCP, SDAP, etc)
Bearer Modification/release
   E.g., SN terminated bearers changed to MN terminated bearers, SN terminated split bearers changed to SN terminated MCG bearers, etc.

Resume SCG Request:
The type of the resumption to be applied
Updated SCG configuration
Updated bearer configuration
   E.g., MN terminated bearers changed to MN terminated bearers, MN terminated split bearers changed to MN terminated SCG bearers, etc.

Resume SCG (RRC Reconfiguration to UE to resume the SCG):
The type of the resumption to be applied
Updated SCG configuration/bearer configuration.

### UE Behavior and Configurations

The UE can be provided with configurations to apply upon suspension and upon resumption of the SCG. These configurations can be provided before suspension of the SCG, along with the command/message that suspends the SCG, or/and along with the command/message the resumes the SCG.

As discussed above, the SCG suspension can be realized in different ways, and the UE configuration for these are described below.

First are configurations relevant for PSCell-dormancy-like suspension.

The dormant PSCell configuration can be provided by RRC signaling, for example, using dormantBWP-Config that is in the servingCellConfig within the SCG cell group configuration, as the servingCellConfig is relevant for the PSCell as well as the SCG Cells.

Optionally, the dormantBWP-Config can be included in the spCellConfig that is included only for the PCell or PSCell. This approach can provide more flexibility in that the dormantBWP-Config for the PSCell can be defined differently than the dormantBWP-Config for an SCell (it can be a completely different IE, for example).

Example ASN.1 description of the configuration is given below:

SpCellConfig : : = SEQUENCE {
servCellIndex ServCellIndex OPTIONAL, --
Cond SCG
reconfigurationWithSync ReconfigurationWithSync
OPTIONAL, -- Cond ReconfWithSync
rlf-TimersAndConstants SetupRelease { RLF-
TimersAndConstants } OPTIONAL, -- Need M
rlmInSyncOutOfSyncThreshold ENUMERATED {n1}
OPTIONAL, -- Need S
spCellConfigDedicated ServingCellConfig
OPTIONAL, -- Need M
···,
dormantBWP-Config-PSCell-r17 SetupRelease {DormantBWP-
Config-PSCell-r17} OPTIONAL -- Need M
}

Additional information can be included in the PSCell dormancy configuration.

In the PSCell dormancy configuration (e.g., in the dormantBWP-Config-PSCell), the UE can be configured with one or more of the following regarding the behavior of the SCG SCells when the PSCell is sent to dormancy:
All SCells are deactivated
SCells that are configured with dormancy are sent to dormancy, while the rest are deactivated
A bitmap, corresponding to the SCG SCell, indicating the behavior to apply to them upon PSCell dormancy (e.g., 0 = deactivate the corresponding SCell, 1= send the SCell to dormancy).

Alternatively, the behavior of the SCG SCells on PSCell dormancy can be part of the SCell configuration. For example, a new field may be introduced in the SCellConfig IE, as follows:

sCellStateOnPSCell-Dormancy-r17 ENUMERATED {deactivated,
dormant} OPTIONAL

One or more of the above aspects can also be overridden/reconfigured in the command to suspend the SCG (i.e., the dormantBWP configuration received with the PSCell configuration can be used as a default behavior, and some of the configurations can be modified on a need basis in the command to send the PSCell to dormancy). For example, just the SCell handling on PSCell dormancy can be modified in the command to suspend the SCG.

Second are configurations applicable when resuming the SCG from PSCell dormancy. Similarly, the UE can be configured in the PSCell dormancy configuration (e.g., in the dormantBWP-Config-PSCell) with one or more of the following regarding the behavior of the SCG SCells when the PSCell is resumed after dormancy:
All SCells are activated
All SCells stay in whatever state they are at the moment (i.e., dormancy or deactivated)
SCells are reverted to the state they were before the suspension of the SCG
All SCells that support dormancy but were deactivated, will be sent to dormancy, while those already in dormancy will stay there
   » All the deactivated SCells that do not support dormancy remain in deactivated
   » All the deactivated SCells that do not support dormancy are activated
All SCells that support dormancy but were deactivated, will be sent to dormancy, while those already in dormancy will be activated
   » All the deactivated SCells that do not support dormancy remain in deactivated
   » All the deactivated SCells that do not support dormancy are activated
All SCells are put in deactivated (i.e., those that were in dormancy will be deactivated)
A bitmap, corresponding to the SCG SCell, indicating the behavior to apply to them upon PSCell dormancy (e.g., 0 = deactivate the SCell; 1= send the SCell to dormancy, 2=activate the SCell).

Alternatively, the behavior of the SCG SCells on PSCell resumption after dormancy can be part of the SCell configuration. For example, a new field may be introduced in the SCellConfig IE, as follows:

sCellStateOnPSCell-ResumptionFromDormancy-r17 ENUMERATED
{deactivated, dormant, activated} OPTIONAL

One or more of the above aspects can also be overridden/reconfigured in the command to resume the SCG. For example, the SCell handling can be modified in the command to resume the SCG.

Next are configurations applicable when deactivating the PSCell. When a PSCell is deactivated, all SCG SCells are also deactivated (i.e., no explicit configuration may be necessary regarding the state of the SCG SCells during PSCell deactivation).

Fourth are configurations applicable when activating the PSCell. When a deactivated PSCell gets activated, there are several options:
All SCells are activated
All SCells stay deactivated
SCells are reverted to the state they were before the suspension of the SCG
All the deactivated SCells that do not support dormancy remain in deactivated
All the deactivated SCells that do not support dormancy are activated
A bitmap, corresponding to the SCG SCells, indicating the behavior to apply to them upon PSCell activation (e.g., 0 = deactivate the SCell; 1= send the SCell to dormancy, 2=activate the SCell).

Alternatively, the behavior of the SCG SCells on PSCell activation can be part of the SCell configuration. For example, a new field may be introduced in the SCellConfig IE, as follows:

sCellStateOnPSCell-ResumptionAfterDeactivation-r17
ENUMERATED {deactivated, dormant, activated} OPTIONAL

Next are configurations relevant for stored-SCG-like suspension. In the stored-SCG like suspension, it can be assumed that the UE operates like in a standalone (non-DC) mode, at least from the lower layer configuration perspective (i.e., RLC, MAC, PHY). Thus, the SCG SCell handling described above are not relevant here.

In one alternative, on SCG suspension, the UE can be considered to release part of the SCG configuration (e.g., cell group configuration) from the UE context (but keep it stored in UE memory), and just keeps the higher layer configuration (e.g., radio bearer/PDCP/SDAP configuration). Similarly, on SCG resumption, the UE can retrieve the stored SCG context from memory apply it (e.g., the cell group configuration associated with the SCG), also applying any additional SCG related configuration that may have been included in the command that resumes the SCG.

Another issue is bearer handling, which is applicable to all types of SCG suspension. When it comes to the bearer handling, several options are possible. In one alternative, the UE does not have any specific behavior on bearer handling when the SCG gets suspends (i.e., all the required changes, like ensuring SCG transmission will not be performed, is made via RRC reconfiguration that included bearer type changes before or in the same command that suspends the SCG). Another alternative is to indicate to the UE which (SCG) bearers are to be suspended upon reception of the command to suspend the SCG.

In another alternative, the UE has a specific way of handling the bearers when SCG gets suspended and when it gets resumed (e.g., possibly defined by a configuration); one advantage to have a pre-defined behavior is that the switching or transition to suspended SCG can be done with lower layer signaling, like MAC CE and DCI.

One example of pre-defined bearer handling behavior is shown in the table below:

TABLE 1

| | | |
|---|---|---|
| Bearer Type | | UE Behavior to apply when SCG is suspended |
| MN terminated | | |
| | MCG bearer | Unaffected |
| | SCG bearer | Suspend SCG bearers |
| | Split bearer | Store current primary path and UL data split threshold |
| | | Switch Primary path to MCG, if not already |
| | | Set UL data split threshold to infinity |
| SN terminated | | |
| | MCG bearer | Unaffected |
| | | Or, in another option, these are also suspended i.e., SN terminated bearers having SN termination are part of what is suspended at the UE. |
| | SCG bearer | Suspend SCG bearers |
| | Split bearer | Store current primary path and UL data split threshold |
| | | Set primary path to MCG, if not already |
| | | Set UL data split threshold to infinity |

When it comes to the bearer handling upon SCG resumption, several options are possible. In one alternative, the UE does not have any specific behavior on bearer handling when it comes to resumption after suspension (i.e., all the required changes, like ensuring SCG transmission will be resume, is made via RRC reconfiguration before or in the same command that resumes the SCG). In another alternative, the UE may be configured with a specific way of handling the bearers when SCG gets resumed. An example is shown in Table 2, below:

TABLE 2

| | | |
|---|---|---|
| Bearer Type | | Behavior to apply when SCG is resumed |
| MN terminated | | |
| | MCG bearer | Unaffected |
| | SCG bearer | Resume SCG bearers |
| | Split bearer | Restore the primary path and UL data split threshold values stored upon SCG suspension |
| SN terminated | | |
| | MCG bearer | Unaffected |
| | | Or, in another option, if these were suspended on SCG suspension, they will be resumed |
| | SCG bearer | Resume SCG bearers |
| | Split bearer | Restore the primary path and UL data split threshold values stored upon SCG suspension |

When RRC is used to suspend the SCG, there are several alternatives. A new flag/IE that indicates to the UE to suspend the SCG can be included in the reconfiguration message. This new flag/IE can be defined in the RRCReconfiguration as below, in a case where different states are defined for the suspension of the SCG (dormant, deactivated, stored):

RRCReconfiguration-v17xy-IEs ::= SEQUENCE
{
suspendSCG-r17 ENUMERATED {dormant, deactivated, stored}
OPTIONAL,
nonCriticalExtension SEQUENCE {} OPTIONAL }

For example, in the above if dormant is indicated, the UE switches to the dormant BWP indicated in the PSCell dormancy configuration as discussed in section 5.1.3.1.1.

If it is the MN that signals the SCG suspension to the UE (or if it is the SN that does so, and does so directly using SRB3) the RRC reconfiguration message received at the UE contains that field at the top level of the reconfiguration message. If it is the SN that that triggers the SCG suspension, but does it via the MN (example, no SRB3 available), the SN sends an RRCReconfiguration message that contains the suspendSCG, and the MN embeds the SN’s RRC message (i.e., SCG RRC) within an MN RRC reconfiguration message (e.g., in the mrdc-SecondaryCellGroupConfig field) and passes it to the UE.

For the sake of PSCell dormancy, another possibility is to use the SCG configuration (cellGroupConfig) that contains the firstActiveDownlinkBWP-Id, and set that to indicate to the PSCell to switch to the dormant BWP associated with the SCG. The field description for the firstActiveDownlinkBWP-Id could be updated as below to reflect that possibility:

### Begin Field Description

### firstActiveDownlinkBWP-Id

If configured for an SpCell, this field contains the ID of the DL BWP to be activated upon performing the RRC (re-)configuration. If configured for an SpCell, and this field contains the ID of a dormant DL BWP, the UE performs the switch to the DL BWP and performs the associated procedures on PSCell dormancy. If the field is absent, the RRC (re-)configuration does not impose a BWP switch.

If configured for an SCell, this field contains the ID of the downlink bandwidth part to be used upon activation of an SCell. The initial bandwidth part is referred to by BWP-Id = 0.

Upon PCell change and PSCell addition/change, the network sets the firstActiveDownlinkBWP-Id and firstActiveUplinkBWP-Id to the same value.

### End Field Description

Different MAC CEs may be defined for the different types of SCG suspension (i.e., one MAC CE for Stored-SCG like suspension, a second one for PSCell dormancy, a third one for PSCell deactivation). Upon the reception of a MAC CE that suspends the SCG, the UE may apply a preconfigured configuration for the UE as discussed in 5.1.3.1 (e.g., apply configuration discussed in 5.1.3.1 if a PSCell dormancy MAC CE is received).

When MAC CE is used to send the PSCell to dormancy, there are also several alternatives. For example:
One indication, for example, that can take the value of deactivated or dormant, which indicate the behavior of all the SCG SCells:
   if set to deactivated, all SCells are deactivated
   if set to dormant, all SCells that are configured with dormant BWP are switched to dormancy, while the rest are deactivated
A bitmap indication, corresponding to each SCell and with a value {deactivated,dormant}.

Different DCIs may be defined for the different types of SCG suspension (i.e., one DCI for Stored-SCG like suspension, a second one for PSCell dormancy, a third one for PSCell deactivation). Upon the reception of a DCI that suspends the SCG, the UE may apply a preconfigured configuration for the UE as discussed above.

When a DCI is used to send the PSCell to dormancy, there are also several alternatives. For example:
One indication to switch to the PSCell to the dormant BWP configured for it
One indication to specify the behavior of the SCG SCells (e.g., all SCells deactivated, all SCells that support dormancy put to dormancy, etc).

In some embodiments, the UE behavior on SCG suspension could simply be the application of the explicit/default configurations discussed above. Such behavior and additional aspects are elaborated upon here.

When the UE receives the command to suspend the SCG, it performs one or more of the following:
Apply the bearer reconfiguration, if any, received along with the command to suspend the SCG (e.g., SCG bearers converted to MCG bearers)
If the suspension is of type stored-SCG:
   Suspends the SCG operation e.g., suspend the SCG bearers; but keep the SCG configuration in memory (e.g., in a UE variable)
else (i.e., If the suspension is due to PSCell dormancy or PSCell deactivation):
   if the suspension type is PSCell dormancy, switch the DL BWP for the PSCell to the dormant BWP configured for it, and apply the handling of the SCG SCells as specified in the dormant BWP configuration and/or SCell configuration and/or in the command to suspend the SCG and/or as pre-defined in the specifications (as described in section 5.1.3.1.1)
   if the suspension type is PSCell deactivation, deactivate the PSCell and all SCG SCells;
   If configured (e.g., as described in section 5.1.3.1.4), modify the handling of the data transmission of some of the bearers (both DRBs and SRBs) accordingly, e.g.
      Suspend SCG transmission for all DRBs and SRBs
      Suspend all MN/SN terminated SCG bearers
      Adjust the primary path and UL data threshold for split bearers so that UL data and scheduling requests are not sent via the SCG on behalf of split bearers.

In some embodiments, upon receiving the command to transition to suspend the SCG, the UE delays the actions regarding the suspension/stored SCG for a pre-defined amount time, e.g., 60 ms from the moment the message was received or optionally when lower layers indicate that the receipt of the message has been successfully acknowledged, whichever is earlier (this is to ensure a sync between the UE and the network, i.e., the UE and network will consider the SCG suspended at the same time).

In some embodiments, at least one of the following actions (or combination of these) are also performed:
reset the SCG’s MAC and release the default MAC SCG configuration, if any;
re-establish RLC entities for SRB3, if configured;
store (e.g., in the UE AS SCG context, or in the UE AS SN related context) SN related context information such as S-KgNB (or S-KeNB) and encryption and integrity protection keys associated with the secondary key (S-KgNB or S-KeNB), the C-RNTI used in the source PSCell, the ROHC state, the stored QoS flow to DRB mapping rules, the cellIdentity and the physical cell identity of the source PSCell, and all other SCG-/SN-related parameters configured;
indicates PDCP suspension to lower layers of all DRBs that are suspended;
indicate the suspension of the SCG (and/or the suspension of the affected bearers) to upper layers.

In some embodiments, the UE behavior on SCG resumption could be the application of the explicit/default configurations discussed above. Such behavior and additional aspects are elaborated on here.

When the UE receives the command to resume a suspended SCG, it performs one or more of the following:
If SCG was stored (i.e., suspension was of type stored-SCG):
   Apply the stored SCG configuration and execute associated procedures
else (i.e., If the suspension was due to PSCell dormancy or PSCell deactivation):
   if the suspension type was PSCell dormancy, switch the DL BWP for the PSCell to the BWP configured (e.g., in the PSCell dormant BWP configuration) to be used on resuming from dormancy or to the BWP indicated in the command to resume the SCG; and apply the handling of the SCG SCells as specified in the SCell configuration and/or in the command to resume the SCG and/or as pre-defined in the specifications (as described in section 5.1.3.1.1)
   if the suspension type was PSCell deactivation, activate the PSCell and apply the handling of the SCG SCells as specified in the SCell configuration and/or in the command to resume the SCG and/or as pre-defined in the specifications (as described in section 5.1.3.1.2)
   Apply the bearer reconfiguration, if any, received along with the command to resume the SCG (e.g., some MCG bearers converted to SCG bearers)
   If configured (e.g., as described in section 5.1.3.1.4), modify the handling of the data transmission of some of the bearers (both DRBs and SRBs) accordingly, e.g.
      Resume SCG transmission for all DRBs and SRBs
      Resume all MN/SN terminated SCG bearers
      Restore the primary path and UL data threshold for split bearers so that UL data and scheduling requests can be sent over SCG.

In some embodiments, at least one of the following actions (or combination of these) are also performed:
restore (e.g., from the UE AS SCG context, or from the UE AS SN related context) SN related context information such as S-KgNB (or S-KeNB) and encryption and integrity protection keys associated with the secondary key (S-KgNB or S-KeNB), the ROHC state, the stored QoS flow to DRB mapping rules and all other SCG-/SN-related parameters configured;
   In one solution, upon resumption of the SCG, the UE shall keep using same C-RNTI for the SCG as used before, unless that is explicitly reconfigured upon SCG resume;
re-establish PDCP entities for the bearers being resumed;
if the message from the network indicating the resumption of the SCG includes an SCG fullConfig indication (or a release and add indication), perform the full configuration procedure for the SCG i.e., release at least parts of the stored SCG configuration and apply the SCG configuration in the received message;
if the message from the network indicating the resumption of the SCG does not include an indication to restore SCG SCells, the UE releases the SCG SCell(s) from the SCG-/SN UE SCG context, if stored;
restore secondaryCellGroupConfig, mrdc-SecondaryCellGroup, if stored, and pdcp-Config from the SCG UE context;
if the message from the network indicating the resumption of the SCG includes includes a radio bearer configuration associated with the SCG, apply the radio bearer configuration on top of the bearer configuration stored in the SCG context;
if the message from the network indicating the resumption of the SCG includes a secondary group configuration (e.g., secondaryCellGroup), perform the cell group configuration for the received secondary group configuration;
if the message from the network indicating the resumption of the SCG includes the mrdc-SecondaryCellGroup, if the received mrdc-SecondaryCellGroup is set to nr-SCG, perform the RRC reconfiguration for the RRCReconfiguration message included in nr-SCG;
discard the stored SCG UE context;
discard only parts of the SCG context that may not be used if later the SN/SCG is suspended again;
resume all SCG related bearers;
resume all SN terminated bearers;
consider the SCG to be activated, active, out of dormancy state;
indicate to upper layers that the suspended SCG has been resumed;
prepare a complete message, possibly including an SCG complete message within, and submit the message to lower layers for transmission.

In view of the detailed examples and discussion presented above, it will be appreciated that FIG. 38 is a process flow diagram illustrating an example method, as carried out by a UE, corresponding to several of the detailed techniques described above. Accordingly, it should be understood that despite minor differences in terminology or presentation, all of the variations of behavior and operation described above in connection with a UE are applicable to the illustrated method.

The illustrated method, which is implemented by a UE operating in dual connectivity (DC) with a master node (MN) and a secondary node (SN), is for suspending a secondary cell group (SCG). As seen at block 3180, the method includes receiving from first radio network node (RNN), a command to suspend the SCG. This first RNN may be acting as the MN, in some embodiments, or as the SN, in others. As seen at block 3820, the method further comprises suspending the SCG, in response to receiving the command.

Suspending the SCG may comprise, for example, may comprise discontinuing monitoring of a physical downlink control channel (PDCCH) in cells of the SCG while continuing to report channel state information (CSI) for a primary second cell (PSCell) of the SCG. Likewise, suspending the SCG may comprise any one of: switching a primary secondary cell (PSCell) of the SCG to a dormant bandwidth part (BWP); deactivating the PSCell; and suspending bearers associated with the SCG but keeping an SCG configuration stored. Suspending the SCG may comprise any others of the detailed aspects of suspending a SCG discussed above.

In some embodiments, the method may further include sending a message indicating suspension of the SCG is complete, to the first RNN, as shown at block 3830.

In some embodiments, the method may further comprise subsequently receiving a command to resume operation with the SCG, as shown at block 3840. The method may then comprise, in response to the command to resume operation, resuming operation with the SCG, as shown at block 3850. In some embodiments, the UE may send a message indicating resumption of the SCG is complete, as shown at block 3860.

Note that the command to resume the SCG may be received from the same node as the command to suspend it, or from a different node. Thus, for example, the command to suspend the SCG may be received from a first one of the MN and SN and the command to resume the SCG may be received from the other of the MN and SN.

Resuming the SCG may comprise restarting monitoring of a physical downlink control channel (PDCC) in at least one cell of the SCG. Likewise, resuming the SCG may comprise any one or more of: switching a primary secondary cell (PSCell) of the SCG to a non-dormant bandwidth part (BWP); and restoring a stored SCG configuration and resuming operation using one or more SCG bearers according to the restored SCG configuration.

The messages used in the illustrated method may be of any of various types. Thus, for example, the command to resume the SCG may be any one of: a radio resource control (RRC) message; a medium access control (MAC) control element; and downlink control information (DCI). Likewise, the command to suspend the SCG may be any one of: a radio resource control (RRC) message; a medium access control (MAC) control element; and downlink control information (DCI). The command to resume the SCG may or may not be of the same type as the command to suspend the SCG, in various embodiments.

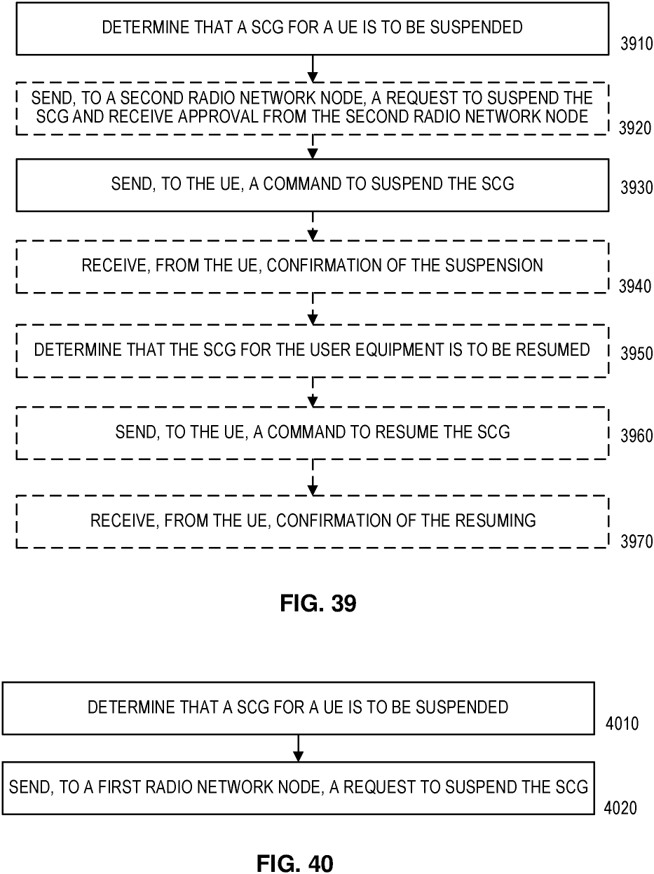

FIG. 39 is a process flow diagram illustrating an example method, as carried out by a radio network node (RNN), corresponding to several of the detailed techniques described above. Accordingly, it should be understood that despite minor differences in terminology or presentation, all of the variations of behavior and operation described above in connection with an MN or SN or other RNN are applicable to the illustrated method.

The method shown in FIG. 39 is for a first radio network node (RNN) serving a user equipment (UE) operating in dual connectivity (DC) with a master node (MN) and a secondary node (SN), and is for suspending the UE’s operation with a secondary cell group (SCG). Note that the term “first RNN” does not imply any particular priority or order for the RNN, with respect to another; in various embodiments, the first RNN may be an MN or an SN.

The method of FIG. 39 includes, as shown at block 3910, the step of determining that the SCG is to be suspended. This “determining” should be understood broadly - it may comprise the first RNN deciding for itself that the SCG for the UE should be suspended, or it may comprise being told by another RNN that the SCG should be suspended, or it may comprise approving a request from another RNN that the SCG be suspended, in various embodiments.

As shown at block 3930, the method further includes sending, to the UE, a command to suspend the SCG. In some embodiments, the method may comprise receiving, from the UE, a confirmation of the suspension, as shown at block 3940.

In some embodiments, as noted above, the first RNN may determine by itself that the SCG should be suspended for the UE. In some embodiments, for instance, determining that the SCG is to be suspended may comprise deciding to suspend the SCG in response to any one or more of the following triggering events or conditions: detecting uplink and/or downlink inactivity concerning the SCG; detecting an overload of the SN; detecting a low load of the MN; and detecting a low total uplink and/or downlink throughput for the DC. In some embodiments, the first RNN is the SN and the method further comprises sending a request to suspend the SCG to the MN and receiving, in response to the request, approval to suspend the SCG. This is shown at block 3920 in FIG. 39.

In other embodiments, the first RNN is a first one of the MN and the SN and determining that the SCG is to be suspended comprises receiving a request to suspend the SCG from the other one of the MN and SN.

In some embodiments, the first RNN may subsequently determine that the SCG is to be resumed. This is shown at block 3950 of FIG. 39. The method, in these cases, may then comprise sending, to the UE, a command to resume the SCG, as shown at block 3960. In some embodiments, the method may further comprise receiving, from the UE, confirmation of the resuming, as shown at block 3970.

FIG. 40 illustrates another example method as implemented in a second RNN, in this case addressing a scenario where the node deciding that the SCG should be suspended is different from the node sending the command to the UE. Thus, as shown at block 4010, the method comprises determining that the SCG is to be suspended. Then, as shown at block 4020, the method comprises sending, to a first RNN, a request to suspend the SCG. The first RNN may then send the suspend command to the UE according to any of the several techniques described above. Note that in this method, the second RNN might be either the MN or the SN, in various embodiments.

As in the method shown in FIG. 39, in the method of FIG. 40, determining that the SCG is to be suspended may comprise deciding to suspend the SCG in response to any one or more of the following triggering events or conditions, for example: detecting uplink and/or downlink inactivity concerning the SCG; detecting an overload of the SN; detecting a low load of the MN; and detecting a low total uplink and/or downlink throughput for the DC.

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

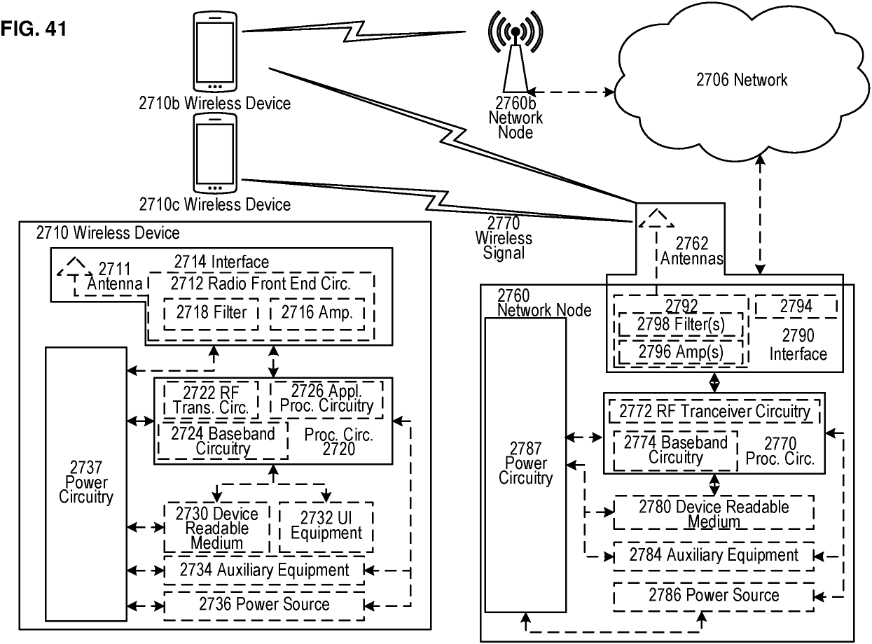

For example, FIG. 41 shows an exemplary wireless network in which various embodiments disclosed herein can be implemented. For simplicity, the wireless network of FIG. 41 only depicts network 2706, network nodes 2760 and 2760b, and WDs 2710, 2710b, and 2710c. In practice, a wireless network can further include any additional elements suitable to support communication between wireless devices or between a wireless device and another communication device, such as a landline telephone, a service provider, or any other network node or end device. Of the illustrated components, network node 2760 and wireless device (WD) 2710 are depicted with additional detail. The wireless network can provide communication and other types of services to one or more wireless devices to facilitate the wireless devices’ access to and/or use of the services provided by, or via, the wireless network.

The wireless network can comprise and/or interface with any type of communication, telecommunication, data, cellular, and/or radio network or other similar type of system. In some embodiments, the wireless network can be configured to operate according to specific standards or other types of predefined rules or procedures. Thus, particular embodiments of the wireless network can implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 2706 can comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 2760 and WD 2710 comprise various components described in more detail below. These components work together in order to provide network node and/or wireless device functionality, such as providing wireless connections in a wireless network. In different embodiments, the wireless network can comprise any number of wired or wireless networks, network nodes, base stations, controllers, wireless devices, relay stations, and/or any other components or systems that can facilitate or participate in the communication of data and/or signals whether via wired or wireless connections.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations can be categorized based on the amount of coverage they provide (or, stated differently, their transmit power level) and can then also be referred to as femto base stations, pico base stations, micro base stations, or macro base stations. A base station can be a relay node or a relay donor node controlling a relay. A network node can also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station can also be referred to as nodes in a distributed antenna system (DAS).

Further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node can be a virtual network node as described in more detail below. More generally, however, network nodes can represent any suitable device (or group of devices) capable, configured, arranged, and/or operable to enable and/or provide a wireless device with access to the wireless network or to provide some service to a wireless device that has accessed the wireless network.

In FIG. 41, network node 2760 includes processing circuitry 2770, device readable medium 2780, interface 2790, auxiliary equipment 2784, power source 2786, power circuitry 2787, and antenna 2762. Although network node 2760 illustrated in the example wireless network of FIG. 41 can represent a device that includes the illustrated combination of hardware components, other embodiments can comprise network nodes with different combinations of components. It is to be understood that a network node comprises any suitable combination of hardware and/or software needed to perform the tasks, features, functions and methods and/or procedures disclosed herein. Moreover, while the components of network node 2760 are depicted as single boxes located within a larger box, or nested within multiple boxes, in practice, a network node can comprise multiple different physical components that make up a single illustrated component (e.g., device readable medium 2780 can comprise multiple separate hard drives as well as multiple RAM modules).

Similarly, network node 2760 can be composed of multiple physically separate components (e.g., a NodeB component and an RNC component, or a BTS component and a BSC component, etc.), which can each have their own respective components. In certain scenarios in which network node 2760 comprises multiple separate components (e.g., BTS and BSC components), one or more of the separate components can be shared among several network nodes. For example, a single RNC can control multiple NodeB’s. In such a scenario, each unique NodeB and RNC pair, can in some instances be considered a single separate network node. In some embodiments, network node 2760 can be configured to support multiple radio access technologies (RATs). In such embodiments, some components can be duplicated (e.g., separate device readable medium 2780 for the different RATs) and some components can be reused (e.g., the same antenna 2762 can be shared by the RATs). Network node 2760 can also include multiple sets of the various illustrated components for different wireless technologies integrated into network node 2760, such as, for example, GSM, WCDMA, LTE, NR, WiFi, or Bluetooth wireless technologies. These wireless technologies can be integrated into the same or different chip or set of chips and other components within network node 2760.

Processing circuitry 2770 can be configured to perform any determining, calculating, or similar operations (e.g., certain obtaining operations) described herein as being provided by a network node. These operations performed by processing circuitry 2770 can include processing information obtained by processing circuitry 2770 by, for example, converting the obtained information into other information, comparing the obtained information or converted information to information stored in the network node, and/or performing one or more operations based on the obtained information or converted information, and as a result of said processing making a determination.

Processing circuitry 2770 can comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide various functionality of network node 2760, either alone or in conjunction with other network node 2760 components (e.g., device readable medium 2780). Such functionality can include any of the various wireless features, functions, or benefits discussed herein.

For example, processing circuitry 2770 can execute instructions stored in device readable medium 2780 or in memory within processing circuitry 2770. In some embodiments, processing circuitry 2770 can include a system on a chip (SOC). As a more specific example, instructions (also referred to as a computer program product) stored in medium 2780 can include instructions that, when executed by processing circuitry 2770, can configure network node 2760 to perform operations corresponding to various exemplary methods (e.g., procedures) described herein.

In some embodiments, processing circuitry 2770 can include one or more of radio frequency (RF) transceiver circuitry 2772 and baseband processing circuitry 2774. In some embodiments, radio frequency (RF) transceiver circuitry 2772 and baseband processing circuitry 2774 can be on separate chips (or sets of chips), boards, or units, such as radio units and digital units. In alternative embodiments, part or all of RF transceiver circuitry 2772 and baseband processing circuitry 2774 can be on the same chip or set of chips, boards, or units

In certain embodiments, some or all of the functionality described herein as being provided by a network node, base station, eNB or other such network device can be performed by processing circuitry 2770 executing instructions stored on device readable medium 2780 or memory within processing circuitry 2770. In alternative embodiments, some or all of the functionality can be provided by processing circuitry 2770 without executing instructions stored on a separate or discrete device readable medium, such as in a hard-wired manner. In any of those embodiments, whether executing instructions stored on a device readable storage medium or not, processing circuitry 2770 can be configured to perform the described functionality. The benefits provided by such functionality are not limited to processing circuitry 2770 alone or to other components of network node 2760 but are enjoyed by network node 2760 as a whole, and/or by end users and the wireless network generally.

Device readable medium 2780 can comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that can be used by processing circuitry 2770. Device readable medium 2780 can store any suitable instructions, data or information, including a computer program, software, an application including one or more of logic, rules, code, tables, etc. and/or other instructions capable of being executed by processing circuitry 2770 and, utilized by network node 2760. Device readable medium 2780 can be used to store any calculations made by processing circuitry 2770 and/or any data received via interface 2790. In some embodiments, processing circuitry 2770 and device readable medium 2780 can be considered to be integrated.

Interface 2790 is used in the wired or wireless communication of signaling and/or data between network node 2760, network 2706, and/or WDs 2710. As illustrated, interface 2790 comprises port(s)/terminal(s) 2794 to send and receive data, for example to and from network 2706 over a wired connection. Interface 2790 also includes radio front end circuitry 2792 that can be coupled to, or in certain embodiments a part of, antenna 2762. Radio front end circuitry 2792 comprises filters 2798 and amplifiers 2796. Radio front end circuitry 2792 can be connected to antenna 2762 and processing circuitry 2770. Radio front end circuitry can be configured to condition signals communicated between antenna 2762 and processing circuitry 2770. Radio front end circuitry 2792 can receive digital data that is to be sent out to other network nodes or WDs via a wireless connection. Radio front end circuitry 2792 can convert the digital data into a radio signal having the appropriate channel and bandwidth parameters using a combination of filters 2798 and/or amplifiers 2796. The radio signal can then be transmitted via antenna 2762. Similarly, when receiving data, antenna 2762 can collect radio signals which are then converted into digital data by radio front end circuitry 2792. The digital data can be passed to processing circuitry 2770. In other embodiments, the interface can comprise different components and/or different combinations of components.

In certain alternative embodiments, network node 2760 may not include separate radio front end circuitry 2792, instead, processing circuitry 2770 can comprise radio front end circuitry and can be connected to antenna 2762 without separate radio front end circuitry 2792. Similarly, in some embodiments, all or some of RF transceiver circuitry 2772 can be considered a part of interface 2790. In still other embodiments, interface 2790 can include one or more ports or terminals 2794, radio front end circuitry 2792, and RF transceiver circuitry 2772, as part of a radio unit (not shown), and interface 2790 can communicate with baseband processing circuitry 2774, which is part of a digital unit (not shown).

Antenna 2762 can include one or more antennas, or antenna arrays, configured to send and/or receive wireless signals. Antenna 2762 can be coupled to radio front end circuitry 2790 and can be any type of antenna capable of transmitting and receiving data and/or signals wirelessly. In some embodiments, antenna 2762 can comprise one or more omni-directional, sector or panel antennas operable to transmit/receive radio signals between, for example, 2 GHz and 66 GHz. An omni-directional antenna can be used to transmit/receive radio signals in any direction, a sector antenna can be used to transmit/receive radio signals from devices within a particular area, and a panel antenna can be a line of sight antenna used to transmit/receive radio signals in a relatively straight line. In some instances, the use of more than one antenna can be referred to as MIMO. In certain embodiments, antenna 2762 can be separate from network node 2760 and can be connectable to network node 2760 through an interface or port.

Antenna 2762, interface 2790, and/or processing circuitry 2770 can be configured to perform any receiving operations and/or certain obtaining operations described herein as being performed by a network node. Any information, data and/or signals can be received from a wireless device, another network node and/or any other network equipment. Similarly, antenna 2762, interface 2790, and/or processing circuitry 2770 can be configured to perform any transmitting operations described herein as being performed by a network node. Any information, data and/or signals can be transmitted to a wireless device, another network node and/or any other network equipment.

Power circuitry 2787 can comprise, or be coupled to, power management circuitry and can be configured to supply the components of network node 2760 with power for performing the functionality described herein. Power circuitry 2787 can receive power from power source 2786. Power source 2786 and/or power circuitry 2787 can be configured to provide power to the various components of network node 2760 in a form suitable for the respective components (e.g., at a voltage and current level needed for each respective component). Power source 2786 can either be included in, or external to, power circuitry 2787 and/or network node 2760. For example, network node 2760 can be connectable to an external power source (e.g., an electricity outlet) via an input circuitry or interface such as an electrical cable, whereby the external power source supplies power to power circuitry 2787. As a further example, power source 2786 can comprise a source of power in the form of a battery or battery pack which is connected to, or integrated in, power circuitry 2787. The battery can provide backup power should the external power source fail. Other types of power sources, such as photovoltaic devices, can also be used.

Alternative embodiments of network node 2760 can include additional components beyond those shown in FIG. 41 that can be responsible for providing certain aspects of the network node’s functionality, including any of the functionality described herein and/or any functionality necessary to support the subject matter described herein. For example, network node 2760 can include user interface equipment to allow and/or facilitate input of information into network node 2760 and to allow and/or facilitate output of information from network node 2760. This can allow and/or facilitate a user to perform diagnostic, maintenance, repair, and other administrative functions for network node 2760.

In some embodiments, a wireless device (WD, e.g., WD 2710) can be configured to transmit and/or receive information without direct human interaction. For instance, a WD can be designed to transmit information to a network on a predetermined schedule, when triggered by an internal or external event, or in response to requests from the network. Examples of a WD include, but are not limited to, smart phones, mobile phones, cell phones, voice over IP (VoIP) phones, wireless local loop phones, desktop computers, personal digital assistants (PDAs), wireless cameras, gaming consoles or devices, music storage devices, playback appliances, wearable devices, wireless endpoints, mobile stations, tablets, laptops, laptop-embedded equipment (LEE), laptop-mounted equipment (LME), smart devices, wireless customer-premise equipment (CPE), mobile-type communication (MTC) devices, Internet-of-Things (IoT) devices, vehicle-mounted wireless terminal devices, etc.

A WD can support device-to-device (D2D) communication, for example by implementing a 3GPP standard for sidelink communication, vehicle-to-vehicle (V2V), vehicle-to-infrastructure (V2I), vehicle-to-everything (V2X) and can in this case be referred to as a D2D communication device. As yet another specific example, in an Internet of Things (IoT) scenario, a WD can represent a machine or other device that performs monitoring and/or measurements and transmits the results of such monitoring and/or measurements to another WD and/or a network node. The WD can in this case be a machine-to-machine (M2M) device, which can in a 3GPP context be referred to as an MTC device. As one particular example, the WD can be a UE implementing the 3GPP narrow band internet of things (NB-IoT) standard. Particular examples of such machines or devices are sensors, metering devices such as power meters, industrial machinery, or home or personal appliances (e.g., refrigerators, televisions, etc.) personal wearables (e.g., watches, fitness trackers, etc.). In other scenarios, a WD can represent a vehicle or other equipment that is capable of monitoring and/or reporting on its operational status or other functions associated with its operation. A WD as described above can represent the endpoint of a wireless connection, in which case the device can be referred to as a wireless terminal. Furthermore, a WD as described above can be mobile, in which case it can also be referred to as a mobile device or a mobile terminal.

As illustrated, wireless device 2710 includes antenna 2711, interface 2714, processing circuitry 2720, device readable medium 2730, user interface equipment 2732, auxiliary equipment 2734, power source 2736 and power circuitry 2737. WD 2710 can include multiple sets of one or more of the illustrated components for different wireless technologies supported by WD 2710, such as, for example, GSM, WCDMA, LTE, NR, WiFi, WiMAX, or Bluetooth wireless technologies, just to mention a few. These wireless technologies can be integrated into the same or different chips or set of chips as other components within WD 2710.

Antenna 2711 can include one or more antennas or antenna arrays, configured to send and/or receive wireless signals, and is connected to interface 2714. In certain alternative embodiments, antenna 2711 can be separate from WD 2710 and be connectable to WD 2710 through an interface or port. Antenna 2711, interface 2714, and/or processing circuitry 2720 can be configured to perform any receiving or transmitting operations described herein as being performed by a WD. Any information, data and/or signals can be received from a network node and/or another WD. In some embodiments, radio front end circuitry and/or antenna 2711 can be considered an interface.

As illustrated, interface 2714 comprises radio front end circuitry 2712 and antenna 2711. Radio front end circuitry 2712 comprise one or more filters 2718 and amplifiers 2716. Radio front end circuitry 2714 is connected to antenna 2711 and processing circuitry 2720 and can be configured to condition signals communicated between antenna 2711 and processing circuitry 2720. Radio front end circuitry 2712 can be coupled to or a part of antenna 2711. In some embodiments, WD 2710 may not include separate radio front end circuitry 2712; rather, processing circuitry 2720 can comprise radio front end circuitry and can be connected to antenna 2711. Similarly, in some embodiments, some or all of RF transceiver circuitry 2722 can be considered a part of interface 2714. Radio front end circuitry 2712 can receive digital data that is to be sent out to other network nodes or WDs via a wireless connection. Radio front end circuitry 2712 can convert the digital data into a radio signal having the appropriate channel and bandwidth parameters using a combination of filters 2718 and/or amplifiers 2716. The radio signal can then be transmitted via antenna 2711. Similarly, when receiving data, antenna 2711 can collect radio signals which are then converted into digital data by radio front end circuitry 2712. The digital data can be passed to processing circuitry 2720. In other embodiments, the interface can comprise different components and/or different combinations of components.

Processing circuitry 2720 can comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide WD 2710 functionality either alone or in combination with other WD 2710 components, such as device readable medium 2730. Such functionality can include any of the various wireless features or benefits discussed herein.

For example, processing circuitry 2720 can execute instructions stored in device readable medium 2730 or in memory within processing circuitry 2720 to provide the functionality disclosed herein. More specifically, instructions (also referred to as a computer program product) stored in medium 2730 can include instructions that, when executed by processor 2720, can configure wireless device 2710 to perform operations corresponding to various exemplary methods (e.g., procedures) described herein.

As illustrated, processing circuitry 2720 includes one or more of RF transceiver circuitry 2722, baseband processing circuitry 2724, and application processing circuitry 2726. In other embodiments, the processing circuitry can comprise different components and/or different combinations of components. In certain embodiments processing circuitry 2720 of WD 2710 can comprise a SOC. In some embodiments, RF transceiver circuitry 2722, baseband processing circuitry 2724, and application processing circuitry 2726 can be on separate chips or sets of chips. In alternative embodiments, part or all of baseband processing circuitry 2724 and application processing circuitry 2726 can be combined into one chip or set of chips, and RF transceiver circuitry 2722 can be on a separate chip or set of chips. In still alternative embodiments, part or all of RF transceiver circuitry 2722 and baseband processing circuitry 2724 can be on the same chip or set of chips, and application processing circuitry 2726 can be on a separate chip or set of chips. In yet other alternative embodiments, part or all of RF transceiver circuitry 2722, baseband processing circuitry 2724, and application processing circuitry 2726 can be combined in the same chip or set of chips. In some embodiments, RF transceiver circuitry 2722 can be a part of interface 2714. RF transceiver circuitry 2722 can condition RF signals for processing circuitry 2720.

In certain embodiments, some or all of the functionality described herein as being performed by a WD can be provided by processing circuitry 2720 executing instructions stored on device readable medium 2730, which in certain embodiments can be a computer-readable storage medium. In alternative embodiments, some or all of the functionality can be provided by processing circuitry 2720 without executing instructions stored on a separate or discrete device readable storage medium, such as in a hard-wired manner. In any of those particular embodiments, whether executing instructions stored on a device readable storage medium or not, processing circuitry 2720 can be configured to perform the described functionality. The benefits provided by such functionality are not limited to processing circuitry 2720 alone or to other components of WD 2710, but are enjoyed by WD 2710 as a whole, and/or by end users and the wireless network generally.

Processing circuitry 2720 can be configured to perform any determining, calculating, or similar operations (e.g., certain obtaining operations) described herein as being performed by a WD. These operations, as performed by processing circuitry 2720, can include processing information obtained by processing circuitry 2720 by, for example, converting the obtained information into other information, comparing the obtained information or converted information to information stored by WD 2710, and/or performing one or more operations based on the obtained information or converted information, and as a result of said processing making a determination.

Device readable medium 2730 can be operable to store a computer program, software, an application including one or more of logic, rules, code, tables, etc. and/or other instructions capable of being executed by processing circuitry 2720. Device readable medium 2730 can include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that can be used by processing circuitry 2720. In some embodiments, processing circuitry 2720 and device readable medium 2730 can be considered to be integrated.

User interface equipment 2732 can include components that allow and/or facilitate a human user to interact with WD 2710. Such interaction can be of many forms, such as visual, audial, tactile, etc. User interface equipment 2732 can be operable to produce output to the user and to allow and/or facilitate the user to provide input to WD 2710. The type of interaction can vary depending on the type of user interface equipment 2732 installed in WD 2710. For example, if WD 2710 is a smart phone, the interaction can be via a touch screen; if WD 2710 is a smart meter, the interaction can be through a screen that provides usage (e.g., the number of gallons used) or a speaker that provides an audible alert (e.g., if smoke is detected). User interface equipment 2732 can include input interfaces, devices and circuits, and output interfaces, devices and circuits. User interface equipment 2732 can be configured to allow and/or facilitate input of information into WD 2710 and is connected to processing circuitry 2720 to allow and/or facilitate processing circuitry 2720 to process the input information. User interface equipment 2732 can include, for example, a microphone, a proximity or other sensor, keys/buttons, a touch display, one or more cameras, a USB port, or other input circuitry. User interface equipment 2732 is also configured to allow and/or facilitate output of information from WD 2710, and to allow and/or facilitate processing circuitry 2720 to output information from WD 2710. User interface equipment 2732 can include, for example, a speaker, a display, vibrating circuitry, a USB port, a headphone interface, or other output circuitry. Using one or more input and output interfaces, devices, and circuits, of user interface equipment 2732, WD 2710 can communicate with end users and/or the wireless network and allow and/or facilitate them to benefit from the functionality described herein.

Auxiliary equipment 2734 is operable to provide more specific functionality which may not be generally performed by WDs. This can comprise specialized sensors for doing measurements for various purposes, interfaces for additional types of communication such as wired communications etc. The inclusion and type of components of auxiliary equipment 2734 can vary depending on the embodiment and/or scenario.

Power source 2736 can, in some embodiments, be in the form of a battery or battery pack. Other types of power sources, such as an external power source (e.g., an electricity outlet), photovoltaic devices or power cells, can also be used. WD 2710 can further comprise power circuitry 2737 for delivering power from power source 2736 to the various parts of WD 2710 which need power from power source 2736 to carry out any functionality described or indicated herein. Power circuitry 2737 can in certain embodiments comprise power management circuitry. Power circuitry 2737 can additionally or alternatively be operable to receive power from an external power source; in which case WD 2710 can be connectable to the external power source (such as an electricity outlet) via input circuitry or an interface such as an electrical power cable. Power circuitry 2737 can also in certain embodiments be operable to deliver power from an external power source to power source 2736. This can be, for example, for the charging of power source 2736. Power circuitry 2737 can perform any converting or other modification to the power from power source 2736 to make it suitable for supply to the respective components of WD 2710.

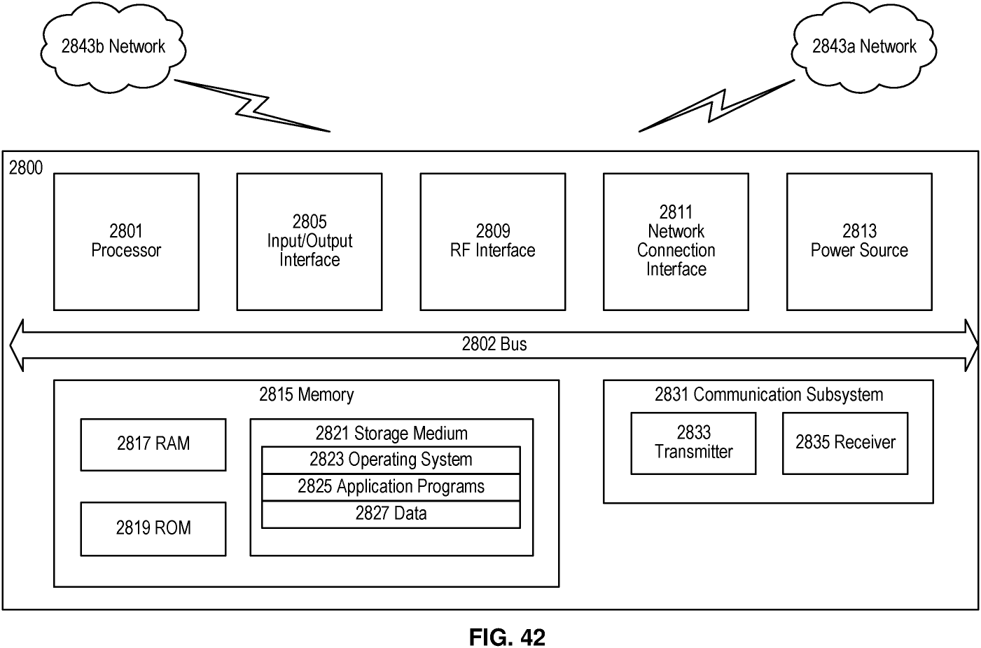

FIG. 42 illustrates one embodiment of a UE in accordance with various aspects described herein. As used herein, a user equipment or UE may not necessarily have a user in the sense of a human user who owns and/or operates the relevant device. Instead, a UE can represent a device that is intended for sale to, or operation by, a human user but which may not, or which may not initially, be associated with a specific human user (e.g., a smart sprinkler controller). Alternatively, a UE can represent a device that is not intended for sale to, or operation by, an end user but which can be associated with or operated for the benefit of a user (e.g., a smart power meter). UE 28200 can be any UE identified by the 3rd Generation Partnership Project (3GPP), including a NB-IoT UE, a machine type communication (MTC) UE, and/or an enhanced MTC (eMTC) UE. UE 2800, as illustrated in FIG. 42, is one example of a WD configured for communication in accordance with one or more communication standards promulgated by the 3rd Generation Partnership Project (3GPP), such as 3GPP’s GSM, UMTS, LTE, and/or 5G standards. As mentioned previously, the term WD and UE can be used interchangeable. Accordingly, although FIG. 42 is a UE, the components discussed herein are equally applicable to a WD, and vice-versa.

In FIG. 42, UE 2800 includes processing circuitry 2801 that is operatively coupled to input/output interface 2805, radio frequency (RF) interface 2809, network connection interface 2811, memory 2815 including random access memory (RAM) 2817, read-only memory (ROM) 2819, and storage medium 2821 or the like, communication subsystem 2831, power source 2833, and/or any other component, or any combination thereof. Storage medium 2821 includes operating system 2823, application program 2825, and data 2827. In other embodiments, storage medium 2821 can include other similar types of information. Certain UEs can utilize all of the components shown in FIG. 42, or only a subset of the components. The level of integration between the components can vary from one UE to another UE. Further, certain UEs can contain multiple instances of a component, such as multiple processors, memories, transceivers, transmitters, receivers, etc.

In FIG. 42, processing circuitry 2801 can be configured to process computer instructions and data. Processing circuitry 2801 can be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 2801 can include two central processing units (CPUs). Data can be information in a form suitable for use by a computer.

In the depicted embodiment, input/output interface 2805 can be configured to provide a communication interface to an input device, output device, or input and output device. UE 2800 can be configured to use an output device via input/output interface 2805. An output device can use the same type of interface port as an input device. For example, a USB port can be used to provide input to and output from UE 2800. The output device can be a speaker, a sound card, a video card, a display, a monitor, a printer, an actuator, an emitter, a smartcard, another output device, or any combination thereof. UE 2800 can be configured to use an input device via input/output interface 2805 to allow and/or facilitate a user to capture information into UE 2800. The input device can include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display can include a capacitive or resistive touch sensor to sense input from a user. A sensor can be, for instance, an accelerometer, a gyroscope, a tilt sensor, a force sensor, a magnetometer, an optical sensor, a proximity sensor, another like sensor, or any combination thereof. For example, the input device can be an accelerometer, a magnetometer, a digital camera, a microphone, and an optical sensor.

In FIG. 42, RF interface 2809 can be configured to provide a communication interface to RF components such as a transmitter, a receiver, and an antenna. Network connection interface 2811 can be configured to provide a communication interface to network 2843a. Network 2843a can encompass wired and/or wireless networks such as a local-area network (LAN), a wide-area network (WAN), a computer network, a wireless network, a telecommunications network, another like network or any combination thereof. For example, network 2843a can comprise a Wi-Fi network. Network connection interface 2811 can be configured to include a receiver and a transmitter interface used to communicate with one or more other devices over a communication network according to one or more communication protocols, such as Ethernet, TCP/IP, SONET, ATM, or the like. Network connection interface 2811 can implement receiver and transmitter functionality appropriate to the communication network links (e.g., optical, electrical, and the like). The transmitter and receiver functions can share circuit components, software or firmware, or alternatively can be implemented separately.

RAM 2817 can be configured to interface via bus 2802 to processing circuitry 2801 to provide storage or caching of data or computer instructions during the execution of software programs such as the operating system, application programs, and device drivers. ROM 2819 can be configured to provide computer instructions or data to processing circuitry 2801. For example, ROM 2819 can be configured to store invariant low-level system code or data for basic system functions such as basic input and output (I/O), startup, or reception of keystrokes from a keyboard that are stored in a non-volatile memory. Storage medium 2821 can be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives.

In one example, storage medium 2821 can be configured to include operating system 2823; application program 2825 such as a web browser application, a widget or gadget engine or another application; and data file 2827. Storage medium 2821 can store, for use by UE 2800, any of a variety of various operating systems or combinations of operating systems. For example, application program 2825 can include executable program instructions (also referred to as a computer program product) that, when executed by processor 2801, can configure UE 2800 to perform operations corresponding to various exemplary methods (e.g., procedures) described herein.

Storage medium 2821 can be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 2821 can allow and/or facilitate UE 2800 to access computer-executable instructions, application programs or the like, stored on transitory or non-transitory memory media, to off-load data, or to upload data. An article of manufacture, such as one utilizing a communication system can be tangibly embodied in storage medium 2821, which can comprise a device readable medium.

In FIG. 42, processing circuitry 2801 can be configured to communicate with network 2843b using communication subsystem 2831. Network 2843a and network 2843b can be the same network or networks or different network or networks. Communication subsystem 2831 can be configured to include one or more transceivers used to communicate with network 2843b. For example, communication subsystem 2831 can be configured to include one or more transceivers used to communicate with one or more remote transceivers of another device capable of wireless communication such as another WD, UE, or base station of a radio access network (RAN) according to one or more communication protocols, such as IEEE 802.28, CDMA, WCDMA, GSM, LTE, UTRAN, WiMax, or the like. Each transceiver can include transmitter 2833 and/or receiver 2835 to implement transmitter or receiver functionality, respectively, appropriate to the RAN links (e.g., frequency allocations and the like). Further, transmitter 2833 and receiver 2835 of each transceiver can share circuit components, software or firmware, or alternatively can be implemented separately.

In the illustrated embodiment, the communication functions of communication subsystem 2831 can include data communication, voice communication, multimedia communication, short-range communications such as Bluetooth, near-field communication, location-based communication such as the use of the global positioning system (GPS) to determine a location, another like communication function, or any combination thereof. For example, communication subsystem 2831 can include cellular communication, Wi-Fi communication, Bluetooth communication, and GPS communication. Network 2843b can encompass wired and/or wireless networks such as a local-area network (LAN), a wide-area network (WAN), a computer network, a wireless network, a telecommunications network, another like network or any combination thereof. For example, network 2843b can be a cellular network, a Wi-Fi network, and/or a near-field network. Power source 2813 can be configured to provide alternating current (AC) or direct current (DC) power to components of UE 2800.

The features, benefits and/or functions described herein can be implemented in one of the components of UE 2800 or partitioned across multiple components of UE 2800. Further, the features, benefits, and/or functions described herein can be implemented in any combination of hardware, software or firmware. In one example, communication subsystem 2831 can be configured to include any of the components described herein. Further, processing circuitry 2801 can be configured to communicate with any of such components over bus 2802. In another example, any of such components can be represented by program instructions stored in memory that when executed by processing circuitry 2801 perform the corresponding functions described herein. In another example, the functionality of any of such components can be partitioned between processing circuitry 2801 and communication subsystem 2831. In another example, the non-computationally intensive functions of any of such components can be implemented in software or firmware and the computationally intensive functions can be implemented in hardware.

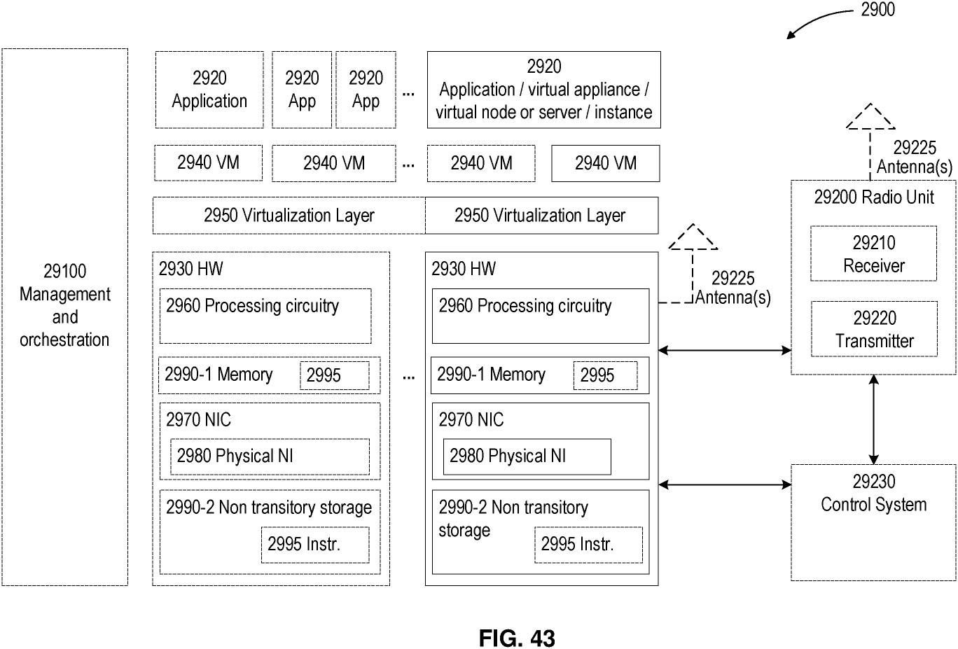

FIG. 43 is a schematic block diagram illustrating a virtualization environment 2900 in which functions implemented by some embodiments can be virtualized. In the present context, virtualizing means creating virtual versions of apparatuses or devices which can include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein can be implemented as virtual components executed by one or more virtual machines implemented in one or more virtual environments 2900 hosted by one or more of hardware nodes 2930. Further, in embodiments in which the virtual node is not a radio access node or does not require radio connectivity (e.g., a core network node), then the network node can be entirely virtualized.

The functions can be implemented by one or more applications 2920 (which can alternatively be called software instances, virtual appliances, network functions, virtual nodes, virtual network functions, etc.) operative to implement some of the features, functions, and/or benefits of some of the embodiments disclosed herein. Applications 2920 are run in virtualization environment 2900 which provides hardware 2930 comprising processing circuitry 2960 and memory 2990. Memory 2990 contains instructions 2995 executable by processing circuitry 2960 whereby application 2920 is operative to provide one or more of the features, benefits, and/or functions disclosed herein.

Virtualization environment 2900 can include general-purpose or special-purpose network hardware devices (or nodes) 2930 comprising a set of one or more processors or processing circuitry 2960, which can be commercial off-the-shelf (COTS) processors, dedicated Application Specific Integrated Circuits (ASICs), or any other type of processing circuitry including digital or analog hardware components or special purpose processors. Each hardware device can comprise memory 2990-1 which can be non-persistent memory for temporarily storing instructions 2995 or software executed by processing circuitry 2960. For example, instructions 2995 can include program instructions (also referred to as a computer program product) that, when executed by processing circuitry 2960, can configure hardware node 2920 to perform operations corresponding to various exemplary methods (e.g., procedures) described herein. Such operations can also be attributed to virtual node(s) 2920 that is/are hosted by hardware node 2930.

Each hardware device can comprise one or more network interface controllers (NICs) 2970, also known as network interface cards, which include physical network interface 2980. Each hardware device can also include non-transitory, persistent, machine-readable storage media 2990-2 having stored therein software 2995 and/or instructions executable by processing circuitry 2960. Software 2995 can include any type of software including software for instantiating one or more virtualization layers 2950 (also referred to as hypervisors), software to execute virtual machines 2940 as well as software allowing it to execute functions, features and/or benefits described in relation with some embodiments described herein.

Virtual machines 2940, comprise virtual processing, virtual memory, virtual networking or interface and virtual storage, and can be run by a corresponding virtualization layer 2950 or hypervisor. Different embodiments of the instance of virtual appliance 2920 can be implemented on one or more of virtual machines 2940, and the implementations can be made in different ways.

During operation, processing circuitry 2960 executes software 2995 to instantiate the hypervisor or virtualization layer 2950, which can sometimes be referred to as a virtual machine monitor (VMM). Virtualization layer 2950 can present a virtual operating platform that appears like networking hardware to virtual machine 2940.

As shown in FIG. 43, hardware 2930 can be a standalone network node with generic or specific components. Hardware 2930 can comprise antenna 29225 and can implement some functions via virtualization. Alternatively, hardware 2930 can be part of a larger cluster of hardware (e.g., such as in a data center or customer premise equipment (CPE)) where many hardware nodes work together and are managed via management and orchestration (MANO) 29100, which, among others, oversees lifecycle management of applications 2920.

Virtualization of the hardware is in some contexts referred to as network function virtualization (NFV). NFV can be used to consolidate many network equipment types onto industry standard high-volume server hardware, physical switches, and physical storage, which can be located in data centers, and customer premise equipment.

In the context of NFV, virtual machine 2940 can be a software implementation of a physical machine that runs programs as if they were executing on a physical, non-virtualized machine. Each of virtual machines 2940, and that part of hardware 2930 that executes that virtual machine, be it hardware dedicated to that virtual machine and/or hardware shared by that virtual machine with others of the virtual machines 2940, forms a separate virtual network elements (VNE).

Still in the context of NFV, Virtual Network Function (VNF) is responsible for handling specific network functions that run in one or more virtual machines 2940 on top of hardware networking infrastructure 2930 and corresponds to application 2920 in FIG. 43.

In some embodiments, one or more radio units 29200 that each include one or more transmitters 29220 and one or more receivers 29210 can be coupled to one or more antennas 29225. Radio units 29200 can communicate directly with hardware nodes 2930 via one or more appropriate network interfaces and can be used in combination with the virtual components to provide a virtual node with radio capabilities, such as a radio access node or a base station. Nodes arranged in this manner can also communicate with one or more UEs, such as described elsewhere herein.

In some embodiments, some signaling can be performed via control system 29230, which can alternatively be used for communication between the hardware nodes 2930 and radio units 29200.

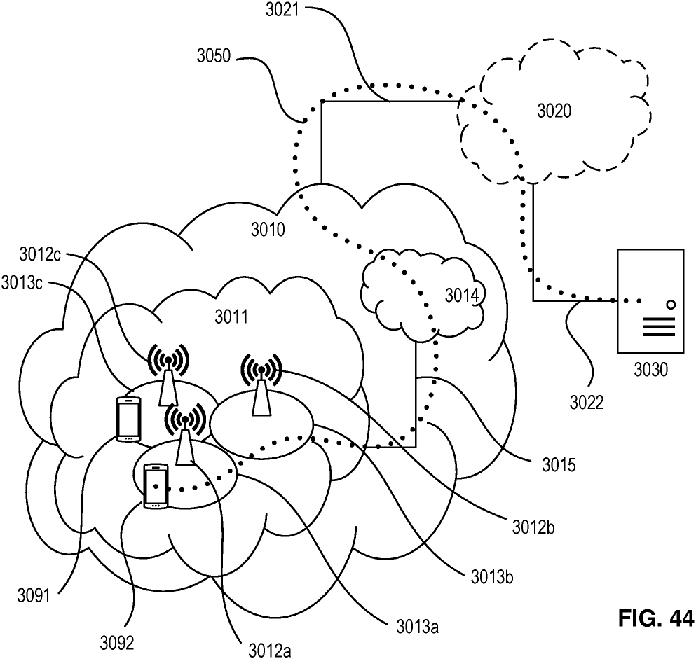

With reference to FIG. 44, in accordance with an embodiment, a communication system includes telecommunication network 3010, such as a 3GPP-type cellular network, which comprises access network 3011, such as a radio access network, and core network 3014. Access network 3011 comprises a plurality of base stations 3012a, 3012b, 3012c, such as NBs, eNBs, gNBs or other types of wireless access points, each defining a corresponding coverage area 3013a, 3013b, 3013c. Each base station 3012a, 3012b, 3012c is connectable to core network 3014 over a wired or wireless connection 3015. A first UE 3091 located in coverage area 3013c can be configured to wirelessly connect to, or be paged by, the corresponding base station 3012c. A second UE 3092 in coverage area 3013a is wirelessly connectable to the corresponding base station 3012a. While a plurality of UEs 3091, 3092 are illustrated in this example, the disclosed embodiments are equally applicable to a situation where a sole UE is in the coverage area or where a sole UE is connecting to the

Telecommunication network 3010 is itself connected to host computer 3030, which can be embodied in the hardware and/or software of a standalone server, a cloud-implemented server, a distributed server or as processing resources in a server farm. Host computer 3030 can be under the ownership or control of a service provider or can be operated by the service provider or on behalf of the service provider. Connections 3021 and 3022 between telecommunication network 3010 and host computer 3030 can extend directly from core network 3014 to host computer 3030 or can go via an optional intermediate network 3020. Intermediate network 3020 can be one of, or a combination of more than one of, a public, private or hosted network; intermediate network 3020, if any, can be a backbone network or the Internet; in particular, intermediate network 3020 can comprise two or more sub-networks (not shown).

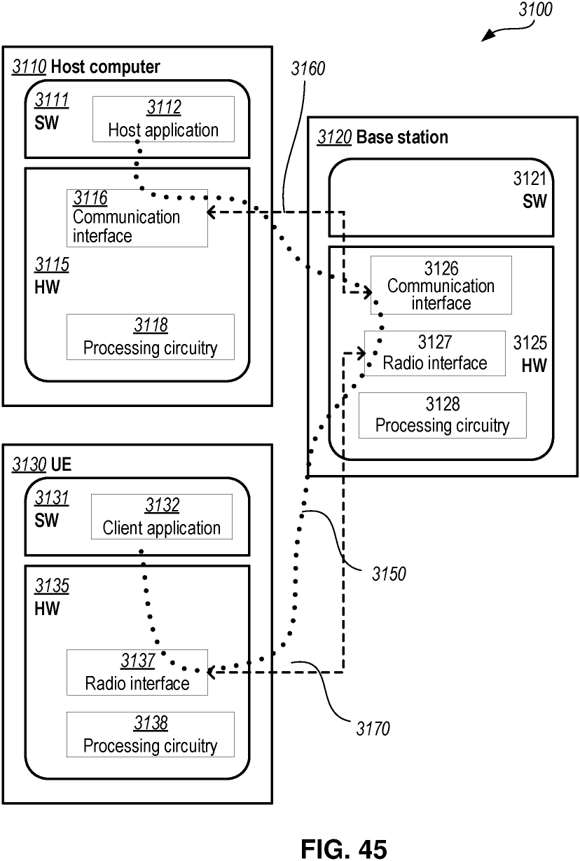

The communication system of FIG. 44 as a whole enables connectivity between the connected UEs 3091, 3092 and host computer 3030. The connectivity can be described as an over-the-top (OTT) connection 3050. Host computer 3030 and the connected UEs 3091, 3092 are configured to communicate data and/or signaling via OTT connection 3050, using access network 3011, core network 3014, any intermediate network 3020 and possible further infrastructure (not shown) as intermediaries. OTT connection 3050 can be transparent in the sense that the participating communication devices through which OTT connection 3050 passes are unaware of routing of uplink and downlink communications. For example, base station 3012 may not or need not be informed about the past routing of an incoming downlink communication with data originating from host computer 3030 to be forwarded (e.g., handed over) to a connected UE 3091. Similarly, base station 3012 need not be aware of the future routing of an outgoing uplink communication originating from the UE 3091 towards the host computer 3030. Example implementations, in accordance with an embodiment, of the UE, base station and host computer discussed in the preceding paragraphs will now be described with reference to FIG. 45. In communication system 3100, host computer 3110 comprises hardware 3115 including communication interface 3116 configured to set up and maintain a wired or wireless connection with an interface of a different communication device of communication system 3100. Host computer 3110 further comprises processing circuitry 3118, which can have storage and/or processing capabilities. In particular, processing circuitry 3118 can comprise one or more programmable processors, application-specific integrated circuits, field programmable gate arrays or combinations of these (not shown) adapted to execute instructions. Host computer 3110 further comprises software 3111, which is stored in or accessible by host computer 3110 and executable by processing circuitry 3118. Software 3111 includes host application 3112. Host application 3112 can be operable to provide a service to a remote user, such as UE 3130 connecting via OTT connection 3150 terminating at UE 3130 and host computer 3110. In providing the service to the remote user, host application 3112 can provide user data which is transmitted using OTT connection 3150.

Communication system 3100 can also include base station 3120 provided in a telecommunication system and comprising hardware 3125 enabling it to communicate with host computer 3110 and with UE 3130. Hardware 3125 can include communication interface 3126 for setting up and maintaining a wired or wireless connection with an interface of a different communication device of communication system 3100, as well as radio interface 3127 for setting up and maintaining at least wireless connection 3170 with UE 3130 located in a coverage area (not shown in FIG. 45) served by base station 3120. Communication interface 3126 can be configured to facilitate connection 3160 to host computer 3110. Connection 3160 can be direct, or it can pass through a core network (not shown in FIG. 45) of the telecommunication system and/or through one or more intermediate networks outside the telecommunication system. In the embodiment shown, hardware 3125 of base station 3120 can also include processing circuitry 3128, which can comprise one or more programmable processors, application-specific integrated circuits, field programmable gate arrays or combinations of these (not shown) adapted to execute instructions.

Base station 3120 also includes software 3121 stored internally or accessible via an external connection. For example, software 3121 can include program instructions (also referred to as a computer program product) that, when executed by processing circuitry 3128, can configure base station 3120 to perform operations corresponding to various exemplary methods (e.g., procedures) described herein.

Communication system 3100 can also include UE 3130 already referred to, whose hardware 3135 can include radio interface 3137 configured to set up and maintain wireless connection 3170 with a base station serving a coverage area in which UE 3130 is currently located. Hardware 3135 of UE 3130 can also include processing circuitry 3138, which can comprise one or more programmable processors, application-specific integrated circuits, field programmable gate arrays or combinations of these (not shown) adapted to execute instructions.

UE 3130 also includes software 3128, which is stored in or accessible by UE 3130 and executable by processing circuitry 3138. Software 3128 includes client application 3132. Client application 3132 can be operable to provide a service to a human or non-human user via UE 3130, with the support of host computer 3110. In host computer 3110, an executing host application 3112 can communicate with the executing client application 3132 via OTT connection 3150 terminating at UE 3130 and host computer 3110. In providing the service to the user, client application 3132 can receive request data from host application 3112 and provide user data in response to the request data. OTT connection 3150 can transfer both the request data and the user data. Client application 3132 can interact with the user to generate the user data that it provides. Software 3128 can also include program instructions (also referred to as a computer program product) that, when executed by processing circuitry 3138, can configure UE 3130 to perform operations corresponding to various exemplary methods (e.g., procedures) described herein.

As an example, host computer 3110, base station 3120 and UE 3130 illustrated in FIG. 45 can be similar or identical to host computer 2730, one of base stations 2712a, 2712b, 2712c and one of UEs 2791, 2792 of FIG. 41, respectively. This is to say, the inner workings of these entities can be as shown in FIG. 45 and independently, the surrounding network topology can be that of FIG. 41.

In FIG. 45, OTT connection 3150 has been drawn abstractly to illustrate the communication between host computer 3110 and UE 3130 via base station 3120, without explicit reference to any intermediary devices and the precise routing of messages via these devices. Network infrastructure can determine the routing, which it can be configured to hide from UE 3130 or from the service provider operating host computer 3110, or both. While OTT connection 3150 is active, the network infrastructure can further take decisions by which it dynamically changes the routing (e.g., on the basis of load balancing consideration or reconfiguration of the network).

Wireless connection 3170 between UE 3130 and base station 3120 is in accordance with the teachings of the embodiments described throughout this disclosure. One or more of the various embodiments improve the performance of OTT services provided to UE 3130 using OTT connection 3150, in which wireless connection 3170 forms the last segment. More precisely, the exemplary embodiments disclosed herein can improve flexibility for the network to monitor end-to-end quality-of-service (QoS) of data flows, including their corresponding radio bearers, associated with data sessions between a user equipment (UE) and another entity, such as an OTT data application or service external to the 5G network. These and other advantages can facilitate more timely design, implementation, and deployment of 5G/NR solutions. Furthermore, such embodiments can facilitate flexible and timely control of data session QoS, which can lead to improvements in capacity, throughput, latency, etc. that are envisioned by 5G/NR and important for the growth of OTT services.

A measurement procedure can be provided for the purpose of monitoring data rate, latency and other network operational aspects on which the one or more embodiments improve. There can further be an optional network functionality for reconfiguring OTT connection 3150 between host computer 3110 and UE 3130, in response to variations in the measurement results. The measurement procedure and/or the network functionality for reconfiguring OTT connection 3150 can be implemented in software 3111 and hardware 3115 of host computer 3110 or in software 3128 and hardware 3135 of UE 3130, or both. In embodiments, sensors (not shown) can be deployed in or in association with communication devices through which OTT connection 3150 passes; the sensors can participate in the measurement procedure by supplying values of the monitored quantities exemplified above, or supplying values of other physical quantities from which software 3111, 3128 can compute or estimate the monitored quantities. The reconfiguring of OTT connection 3150 can include message format, retransmission settings, preferred routing etc.; the reconfiguring need not affect base station 3120, and it can be unknown or imperceptible to base station 3120. Such procedures and functionalities can be known and practiced in the art. In certain embodiments, measurements can involve proprietary UE signaling facilitating host computer 3110′s measurements of throughput, propagation times, latency and the like. The measurements can be implemented in that software 3111 and 3128 causes messages to be transmitted, in particular empty or ‘dummy’ messages, using OTT connection 3150 while it monitors propagation times, errors, etc.

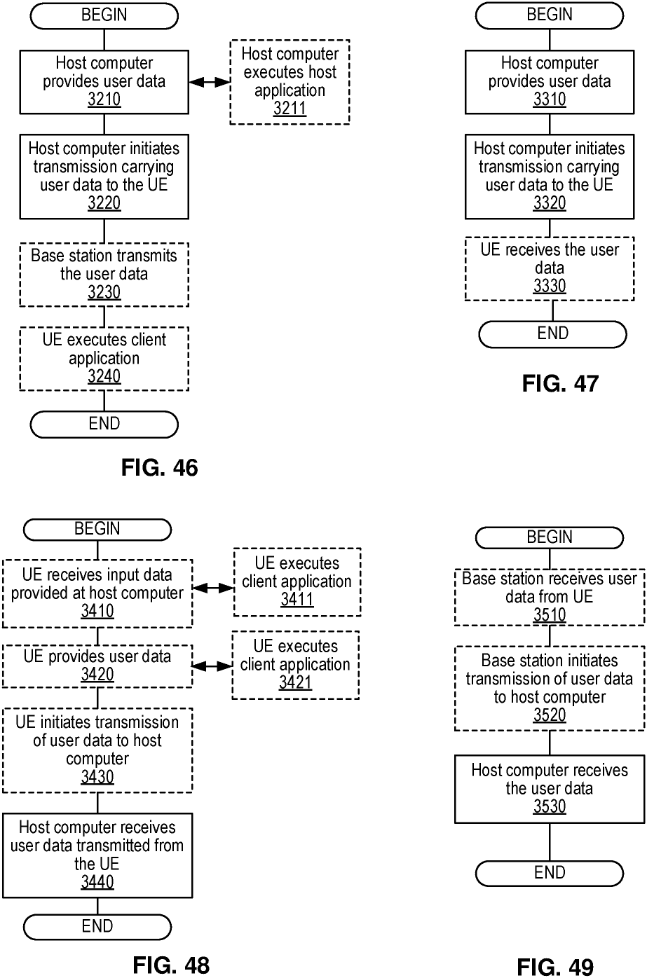

FIG. 46 is a flowchart illustrating an exemplary method (e.g., procedure) implemented in a communication system, in accordance with various embodiments. The communication system includes a host computer, a base station and a UE which, in some exemplary embodiments, can be those described with reference to other figures herein. For simplicity of the present disclosure, only drawing references to FIG. 46 will be included in this section. In step 3210, the host computer provides user data. In substep 3211 (which can be optional) of step 3210, the host computer provides the user data by executing a host application. In step 3220, the host computer initiates a transmission carrying the user data to the UE. In step 3230 (which can be optional), the base station transmits to the UE the user data which was carried in the transmission that the host computer initiated, in accordance with the teachings of the embodiments described throughout this disclosure. In step 3240 (which can also be optional), the UE executes a client application associated with the host application executed by the host computer.

FIG. 47 is a flowchart illustrating an exemplary method (e.g., procedure) implemented in a communication system, in accordance with various embodiments. The communication system includes a host computer, a base station and a UE which can be those described with reference to other figures herein. For simplicity of the present disclosure, only drawing references to FIG. 47 will be included in this section. In step 3310 of the method, the host computer provides user data. In an optional substep (not shown) the host computer provides the user data by executing a host application. In step 3320, the host computer initiates a transmission carrying the user data to the UE. The transmission can pass via the base station, in accordance with the teachings of the embodiments described throughout this disclosure. In step 3330 (which can be optional), the UE receives the user data carried in the transmission.

FIG. 48 is a flowchart illustrating an exemplary method (e.g., procedure) implemented in a communication system, in accordance with various embodiments. The communication system includes a host computer, a base station and a UE which can be those described with reference to other figures herein. For simplicity of the present disclosure, only drawing references to FIG. 48 will be included in this section. In step 3410 (which can be optional), the UE receives input data provided by the host computer. Additionally or alternatively, in step 3420, the UE provides user data. In substep 3421 (which can be optional) of step 3420, the UE provides the user data by executing a client application. In substep 3411 (which can be optional) of step 3410, the UE executes a client application which provides the user data in reaction to the received input data provided by the host computer. In providing the user data, the executed client application can further consider user input received from the user. Regardless of the specific manner in which the user data was provided, the UE initiates, in substep 3430 (which can be optional), transmission of the user data to the host computer. In step 3440 of the method, the host computer receives the user data transmitted from the UE, in accordance with the teachings of the embodiments described throughout this disclosure.

FIG. 49 is a flowchart illustrating an exemplary method (e.g., procedure) implemented in a communication system, in accordance with various embodiments. The communication system includes a host computer, a base station and a UE which can be those described with reference to other figures herein. For simplicity of the present disclosure, only drawing references to FIG. 49 will be included in this section. In step 3510 (which can be optional), in accordance with the teachings of the embodiments described throughout this disclosure, the base station receives user data from the UE. In step 3520 (which can be optional), the base station initiates transmission of the received user data to the host computer. In step 3530 (which can be optional), the host computer receives the user data carried in the transmission initiated by the base station.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

The techniques and apparatus described herein include, but are not limited to, the following enumerated examples:

A1. A method, for a user equipment (UE) operating in dual connectivity (DC) with a master node (MN) and a secondary node (SN), for suspending a secondary cell group (SCG), the method comprising:
receiving from first radio network node (RNN), a command to suspend the SCG; and
in response to receiving the command, suspending the SCG.

A2. The method of example embodiment A1, wherein the first RNN is acting as the MN.

A3. The method of example embodiment A1, wherein the first RNN is acting as the SN.

A4. The method of any of example embodiments A1-A3, wherein suspending the SCG comprises discontinuing monitoring of a physical downlink control channel (PDCCH) in cells of the SCG while continuing to report channel state information (CSI) for a primary second cell (PSCell) of the SCG.

A5. The method of any of example embodiments A1-A4, wherein suspending the SCG comprises any one or more of the following:
switching a primary secondary cell (PSCell) of the SCG to a dormant bandwidth part (BWP);
deactivating the PSCell; and
suspending bearers associated with the SCG but keeping an SCG configuration stored.

A6. The method of any of example embodiments A1-A5, the method further comprising:
receiving a command to resume operation with the SCG; and
in response to the command to resume operation, resuming operation with the SCG.

A7. The method of example embodiment A6, wherein the command to suspend the SCG is received from a first one of the MN and SN and the command to resume the SCG is received from the other of the MN and SN.

A8. The method of example embodiment A6 or A7, wherein resuming the SCG comprises restarting monitoring of a physical downlink control channel (PDCC) in at least one cell of the SCG.

A9. The method of any of example embodiments A6-A8, wherein resuming the SCG comprises any one or more of:
switching a primary secondary cell (PSCell) of the SCG to a non-dormant bandwidth part (BWP); and
restoring a stored SCG configuration and resuming operation using one or more SCG bearers according to the restored SCG configuration.

A10. The method of any of example embodiments A6-A9, wherein the command to resume the SCG is any one of:
a radio resource control (RRC) message;
a medium access control (MAC) control element; and
downlink control information (DCI).

A11. The method of any of example embodiments A1-A10, wherein the command to suspend the SCG is any one of:
a radio resource control (RRC) message;
a medium access control (MAC) control element; and
downlink control information (DCI).

B1. A method, for a first radio network node (RNN) serving a user equipment (UE) operating in dual connectivity (DC) with a master node (MN) and a secondary node (SN), for suspending the UE’s operation with a secondary cell group (SCG), the method comprising:
determining that the SCG is to be suspended; and
sending, to the UE, a command to suspend the SCG.

B2. The method of example embodiment B1, wherein the first RNN is acting as the MN.

B3. The method of example embodiment B1, wherein the first RNN is acting as the SN.

B4. The method of any of example embodiments B1-B3, wherein determining that the SCG is to be suspended comprises deciding to suspend the SCG in response to any one or more of the following triggering events or conditions:
detecting uplink and/or downlink inactivity concerning the SCG;
detecting an overload of the SN;
detecting a low load of the MN; and
detecting a low total uplink and/or downlink throughput for the DC.

B5. The method of any of example embodiments B1-B4, wherein the first RNN is the SN and wherein the method further comprises sending a request to suspend the SCG to the MN and receiving, in response to the request, approval to suspend the SCG.

B6. The method of any of example embodiments B1-B3, wherein the first RNN is a first one of the MN and the SN and determining that the SCG is to be suspended comprises receiving a request to suspend the SCG from the other one of the MN and SN.

B7. The method of any of example embodiments B1-B6, further comprising:
determining that the SCG is to be resumed; and
sending, to the UE, a command to resume the SCG.

B8. A method, for a second radio network node (RNN) serving a user equipment (UE) operating in dual connectivity (DC) with a master node (MN) and a secondary node (SN), for suspending the UE’s operation with a secondary cell group (SCG), the method comprising:
determining that the SCG is to be suspended; and
sending, to a first RNN, a request to suspend the SCG.

B9. The method of example embodiment B8, wherein the second RNN is acting as the MN.

B10. The method of example embodiment B8, wherein the second RNN is acting as the SN.

B11. The method of any of example embodiments B8-B10, wherein determining that the SCG is to be suspended comprises deciding to suspend the SCG in response to any one or more of the following triggering events or conditions:
detecting uplink and/or downlink inactivity concerning the SCG;
detecting an overload of the SN;
detecting a low load of the MN; and
detecting a low total uplink and/or downlink throughput for the DC.

C1. A user equipment (UE) arranged to perform measurements based on conditions related to data traffic, the UE comprising:
radio transceiver circuitry configured to communicate with a radio network node (RNN) in the wireless network; and
processing circuitry operatively coupled to the radio transceiver circuitry, whereby the processing circuitry and the radio transceiver circuitry are configured to perform operations corresponding to the methods of any of embodiments A1-A11.

C2. A user equipment (UE) arranged to perform measurements based on conditions related to data traffic, the UE being further arranged to perform operations corresponding to the methods of any of embodiments A1-A11.

C3. A non-transitory, computer-readable medium storing computer-executable instructions that, when executed by processing circuitry of a user equipment (UE) arranged to perform measurements based on conditions related to data traffic, configure the UE to perform operations corresponding to the methods of any of embodiments A1-A11.

C4. A computer program product comprising computer-executable instructions that, when executed by processing circuitry of a user equipment (UE) arranged to perform measurements based on conditions related to data traffic, configure the UE to perform operations corresponding to the methods of any of embodiments A1-A11.

D1. A radio network node (RNN) arranged to configure measurements by a user equipment (UE) based on conditions related to data traffic, the RNN comprising:
communication interface circuitry configured to communicate with one or more UEs; and
processing circuitry operatively coupled to the communication interface circuitry, whereby the processing circuitry and the communication interface circuitry are configured to perform operations corresponding to the methods of any of embodiments B1-B11.

D2. A radio network node (RNN) arranged to configure measurements by a user equipment (UE) based on conditions related to data traffic, the RNN being further arranged to perform operations corresponding to the methods of any of embodiments B1- B11.

D3. A non-transitory, computer-readable medium storing computer-executable instructions that, when executed by processing circuitry of a radio network node (RNN) arranged to configure measurements by a user equipment (UE) based on conditions related to data traffic, configure the RNN to perform operations corresponding to the methods of any of embodiments B1-B11.

D4. A computer program product comprising computer-executable instructions that, when executed by processing circuitry of a radio network node (RNN) arranged to configure measurements by a user equipment (UE) based on conditions related to data traffic, configure the RNN to perform operations corresponding to the methods of any of embodiments B1-B11.

ABBREVIATIONS

| | |
|---|---|
| 5GC | 5^{th} Generation Core network |
| CDM | Code Division Multiplex |
| CQI | Channel Quality Information |
| CRC | Cyclic Redundancy Check |
| CSI-RS | Channel State Information Reference Signal |
| DC | Dual Connectivity |
| DCI | Downlink Control Information |
| DFT | Discrete Fourier Transform |
| DM-RS | Demodulation Reference Signal |
| DRX | Discontinuous Reception |
| EIRP | Effective Isotropic Radiated Power |
| EPC | Evolved Packet Core network |
| FDM | Frequency Division Multiplex |
| HARQ | Hybrid Automatic Repeat Request |
| MAC | Medium Access Control |
| MAC CE | MAC Control Element |
| MCG | Master cell group |
| MN | Master Node |
| MR-DC | Multi-Radio Dual Connectivity |
| OFDM | Orthogonal Frequency Division Multiplex |
| PAPR | Peak to Average Power Ratio |
| PBCH | Primary Broadcast Channel |
| PRACH | Physical Random Access Channel |
| PRB | Physical Resource Block |
| PUCCH | Physical Uplink Control Channel |
| PUSCH | Physical Uplink Shared Channel |
| RRC | Radio Resource Control |
| SCG | Secondary cell group |
| SRS | Sounding Reference Signal |
| SS-block | Synchronisation Signal Block |
| UCI | Uplink Control Information |

What is claimed is:

1-22. (canceled)

23. A method, in a user equipment (UE) operating in dual connectivity (DC) with a master node (MN) and a secondary node (SN), for suspending a secondary cell group (SCG), the method comprising:
receiving, from a first radio network node (RNN), a command to suspend the SCG; and,
in response to receiving the command, suspending the SCG, wherein suspending the SCG comprises any one or more of the following:
switching a primary secondary cell (PSCell) of the SCG to a dormant bandwidth part (BWP);
deactivating the PSCell; and
suspending bearers associated with the SCG but keeping an SCG configuration stored.

24. The method of claim 23, wherein the first RNN is acting as the MN.

25. The method of claim 23, wherein the first RNN is acting as the SN.

26. The method of claim 23, wherein suspending the SCG comprises discontinuing monitoring of a physical downlink control channel (PDCCH) in cells of the SCG while continuing to report channel state information (CSI) for a primary second cell (PSCell) of the SCG.

27. The method of claim 23, the method further comprising:
receiving a command to resume operation with the SCG; and
in response to the command to resume operation, resuming operation with the SCG.

28. The method of claim 27, wherein the command to suspend the SCG is received from a first one of the MN and SN and the command to resume the SCG is received from the other of the MN and SN.

29. The method of claim 27, wherein resuming the SCG comprises restarting monitoring of a physical downlink control channel (PDCCH) in at least one cell of the SCG.

30. The method of claim 27, wherein resuming the SCG comprises any one or more of:
switching a primary secondary cell (PSCell) of the SCG to a non-dormant bandwidth part (BWP); and
restoring a stored SCG configuration and resuming operation using one or more SCG bearers according to the restored SCG configuration.

31. The method of claim 27, wherein the command to resume the SCG is any one of:
a radio resource control (RRC) message;
a medium access control (MAC) control element; and
downlink control information (DCI).

32. The method of claim 23, wherein the command to suspend the SCG is any one of:
a radio resource control (RRC) message;
a medium access control (MAC) control element; and
downlink control information (DCI).

33. A method, in a first radio network node (RNN) serving a user equipment (UE) operating in dual connectivity (DC) with a master node (MN) and a secondary node (SN), for suspending the UE’s operation with a secondary cell group (SCG), the method comprising:
determining that the SCG is to be suspended; and
sending, to the UE, a command to suspend the SCG,
wherein determining that the SCG is to be suspended comprises any one or more of the following triggering events or conditions:
detecting uplink and/or downlink inactivity concerning the SCG;
detecting an overload of the SN;
detecting a low load of the MN; and
detecting a low total uplink and/or downlink throughput for the DC;
receiving, at the first RNN, which is a first one of the MN and the SN, a request to suspend the SCG from the other one of the MN and SN.

34. The method of claim 33, wherein the first RNN is acting as the MN.

35. The method of claim 33, wherein the first RNN is acting as the SN.

36. The method of claim 33, wherein the first RNN is the SN and wherein the method further comprises sending a request to suspend the SCG to the MN and receiving, in response to the request, approval to suspend the SCG.

37. The method of claim 33, further comprising:
determining that the SCG is to be resumed; and
sending, to the UE, a command to resume the SCG.

38. A method, in a second radio network node (RNN) serving a user equipment (UE) operating in dual connectivity (DC) with a master node (MN) and a secondary node (SN), for suspending the UE’s operation with a secondary cell group (SCG), the method comprising:
determining that the SCG is to be suspended; and
sending, to a first RNN, a request to suspend the SCG;
wherein determining that the SCG is to be suspended comprises deciding to suspend the SCG in response to any one or more of the following triggering events or conditions:
detecting uplink and/or downlink inactivity concerning the SCG;
detecting an overload of the SN;
detecting a low load of the MN; and
detecting a low total uplink and/or downlink throughput for the DC.

39. The method of claim 38, wherein the second RNN is acting as the MN.

40. The method of claim 38, wherein the second RNN is acting as the SN.

41. A user equipment (UE) for operating in dual connectivity (DC) with a master node (MN) and a secondary node (SN), the UE comprising:
radio transceiver circuitry configured to communicate with a radio network node (RNN) in the wireless network; and
processing circuitry operatively coupled to the radio transceiver circuitry, whereby the processing circuitry and the radio transceiver circuitry are configured to:
receive, from a first radio network node (RNN), a command to suspend the SCG; and,
in response to receiving the command, suspend the SCG, wherein suspending the SCG comprises any one or more of the following:
switching a primary secondary cell (PSCell) of the SCG to a dormant bandwidth part (BWP);
deactivating the PSCell; and
suspending bearers associated with the SCG but keeping an SCG configuration stored.

42. A radio network node for serving a user equipment (UE) operating in dual connectivity (DC) with a master node (MN) and a secondary node (SN), the radio network node comprising:
communication interface circuitry configured to communicate with one or more UEs; and
processing circuitry operatively coupled to the communication interface circuitry, whereby the processing circuitry and the communication interface circuitry are configured to:
determine that the SCG is to be suspended; and
send, to the UE, a command to suspend the SCG,
wherein determining that the SCG is to be suspended comprises any one or more of the following triggering events or conditions:
detecting uplink and/or downlink inactivity concerning the SCG;
detecting an overload of the SN;
detecting a low load of the MN; and
detecting a low total uplink and/or downlink throughput for the DC;
receiving, at the first RNN, which is a first one of the MN and the SN, a request to suspend the SCG from the other one of the MN and SN.
